(19) United States
(12) Patent Application Publication
(10) Pub. No.: US 2024/0329480 A1
(43) Pub. Date: Oct. 3, 2024

(54) Dynamic Glass Element Using Reversible Metal Electrodeposition Electrolytes with Tunable PH with High Opacity and Excellent Resting Stability and Electrolytes Useful Therefore

(71) Applicant: THE BOARD OF REGENTS OF THE NEVADA SYSTEM OF HIGHER EDUCATION, on behalf of THE UNIVERSITY OF NEVADA, RENO, NV (US)

(72) Inventors: Christopher J. Barile, Reno, NV (US); Desmond Madu, Reno, NV (US); Shakirul M. Islam, Reno, NV (US)

(21) Appl. No.: 18/282,837

(22) PCT Filed: Apr. 5, 2022
(86) PCT No.: PCT/US2022/023467

§ 371 Date: Sep. 19, 2023

Related U.S. Application Data
(60) Provisional application No. 63/175,861, filed on Apr. 16, 2021.

(51) Int. Cl. G02F 1/1506; C25D 3/22; C25D 5/00; C25D 17/10; C25D 21/12; G02F 1/1523; G02F 1/155

(52) U.S. Cl. CPC G02F 1/1506; C25D 3/22; C25D 5/627; C25D 17/10; C25D 21/12; G02F 1/1523; G02F 1/155; G02F 2001/1555

(57) ABSTRACT

The present invention is directed to a new class of pH tunable electrolytes and related compositions that facilitate the reversible electrodeposition of zinc, bismuth and copper metals on transparent conducting electrodes. These electrolytes are relevant to and are used to provide dynamic windows and other technologies that contain an optoelectronically switchable material.

### RELATED APPLICATIONS

The present applications claims the benefit of priority of U.S. provisional application Ser. No. 63/175,861, entitled “Dynamic Windows Using Reversible Metal Electrodeposition in Neutral Electrolytes with High Opacity and Excellent Resting Stability and Electrolytes Useful Therefore”, filed Apr. 16, 2021, the entire contents of which is incorporated by reference herein.

### FIELD OF THE INVENTION

The present invention is directed to a new class of electrolytes that facilitates the reversible electrodeposition of metals on transparent conducting electrodes. These electrolytes are applicable to dynamic windows and other technologies that contain an optoelectronically switchable material, such as flat-panel displays, smart windows, polymer based electronics, thin film photovoltaics, display windows, glass doors of freezers, architectural windows, X-ray diffraction and scanning electron microscopy analysis, among others.

### BACKGROUND AND OVERVIEW OF THE INVENTION

Dynamic windows, which electronically switch between clear and dark states, could play a vital role in energy-efficient buildings by reducing lighting, heating, and cooling demands and providing more efficient energy use in other applications such as in flat-panel displays, smart windows, polymer based electronics, thin film photovoltaics, display windows, glass doors of freezers, architectural windows, X-ray diffraction and scanning electron microscopy analysis, among others.

Dynamic windows possess electronically tunable transmission that enable control of light and heat flow into buildings and other spaces. Buildings are responsible for ˜40% of total energy demand in the USA and the UK. Dynamic windows are promising technologies because they save up to ˜10% of energy consumption in buildings by reducing lighting, heating, and cooling costs without compromising aesthetics. Moreover, dynamic windows coupled with transparent solar cells could be used to generate large quantities of energy in high-rise buildings where rooftop space is often smaller than the window footprint. In addition to buildings, dynamic windows could also be used in automobiles, sunglasses, mirrors, displays, and transparent batteries.

Over the last three decades, researchers have explored various types of electrochromic materials for dynamic window applications. The most common electrochromic materials are transition metal oxides, which switch color upon changing oxidation state. For example, tungsten oxide (WO₃) is colorless in its +6 oxidation state and transitions to an opaque blue state when it is electrochemically reduced to the +5 oxidation state. Despite much research studying transition metal oxides and other electrochromic materials including polymers, small molecules, and nanoparticles, there is not yet a single technology that fulfills the color neutrality, switching speed, low cost, and durability required for the widespread adoption of dynamic windows. Compared with electrochromic materials, reversible metal electrodeposition (RME) for dynamic window applications is an underexplored approach that has recently shown great promise. Indium tin oxide (ITO) is an optoelectronic material that is applied widely in both research and industry.

RME-based devices have several advantages over traditional electrochromic devices. First, metals have high extinction coefficients, which means that uniform metal films are opaque at thicknesses of 20-30 nm. In contrast, electrochromic materials need to be 100-1000 nm thick to block the same amount of light, which can result in slower switching speeds and higher costs. Second, electrochromic materials are typically deposited using expensive vacuum techniques, while RME devices are mostly solution processed. Third, while the most extensively used electrochromic material, WO₃, is blue in its opaque state, most electrodeposited metal thin films are black, and this color neutrality is desired for the majority of applications.

RME is an emerging technology in this field which operates based on the deposition and oxidation of metal ions on a transparent conducting electrode. RME windows are composed of three important parts which includes a transparent conducting working electrode such as tin-doped indium oxide (ITO), a counter electrode, and a gel or liquid electrolyte containing salts of colorless metal ions. When a reducing potential is applied to the working electrode, the metal ions in the electrolyte are reduced upon the surface of the ITO to their metal forms and thus turn the device dark. The counter provides the other half of the redox reaction as it goes through oxidation. When an oxidation potential is later applied, the metal is stripped off the ITO as it is turned back into its ionic form, and it becomes more transparent. The counter during this process goes through reduction to maintain the charge balance. This method has been shown to be potentially faster and more efficient that other methods such as polymer-dispersed liquid crystals and electrochromic materials. Metals have several intrinsic properties which make them ideal for dynamic windows. Metals are usually highly opaque in the elemental form. This results in the ability to block large amount of light using film only a few tens nanometers thick. This combined with other properties such as being chemically noble and color neutral have allowed many metals to be viable choices to be used in RME dynamic windows.

Most previous RME dynamic windows operate via the electrodeposition of a mixture of Bi and Cu. Although these devices exhibit fast switching speeds and excellent color neutrality, one disadvantage is the limited solubility of Bi ions in aqueous electrolytes due to the formation of insoluble Bi(OH)₃. As a result, Bi—Cu electrolytes are typically acidic such that the Bi(OH)₃ is solubilized. The acid in these electrolytes, however, slowly etches the transparent conducting electrodes and as a result, the devices switch increasingly slowly over time even in the absence of continual cycling. In other words, devices with acidic electrolytes possess poor resting stability, which is one of the biggest challenges hampering the durability of RME dynamic windows.

Most aqueous RME electrolytes contain metal ions with positive standard reduction potentials vs. NHE such as Bi³⁺, Cu²⁺, and Ag⁺. Due to their positive reduction potentials, these metal ions can be thermodynamically electrodeposited before H₂ is evolved from H₂O. In contrast, the standard reduction potential of Zn²⁺/Zn is −0.76 V vs. NHE. From a thermodynamic standpoint, this negative reduction potential means that H₂ generation will occur before Zn electrodeposition. However, neutral pH electrolytes and Zn metal's sluggish ability to evolve H₂ can kinetically impede this unwanted side reaction. Furthermore, ZnO, which also can form during electrodeposition, prevents H₂ production. The Zn aqueous battery literature shows that organic acids or surfactants in the electrolyte can adsorb on electrodes and further increase the overpotential for H₂ generation.

Zn is a cheap metal which has been previously studied in 0.25 M ZnCl₂, 0.25 M ZnBr₂ and 0.5 M NaCH₃COO, non-neutral systems which have been shown to have a high Coulombic efficiency of 99% with a high contrast of greater than 70%. The Zn electrolyte has also shown to be able to reach privacy transmission (<1%) in 9.6 seconds and reach 90% of its starting transmission within 14.5 seconds. Zn also has inherent qualities that elevate this metal as compared to other metals such as bismuth, copper, and lead. One of these qualities is that zinc produces a black window in its opaque state, whereas copper is red in its metal state which make zinc more commercially viable. Zinc is also nontoxic, while lead is well known for toxicity. Zn is more soluble than bismuth which requires a less acidic environment in order to solubilize the metal and which also allows for a more pH neutral window. This helps to prevent acid from reacting with the ITO working conducting electrode and causing etching of the window which occur at low pHs. However, Zn is less noble than these other metals, as its standard reduction potential is −0.76V vs NHE. This is especially concerning because of its negative potential, where water should be reduced into hydrogen before the Zn ions can become Zn metal. The Zn aqueous battery literature shows that organic acids or surfactants in the electrolyte can adsorb on electrodes and further increase the overpotential for H₂ generation. This principle stems from the fact that in aqueous electrolytes, the evolution of hydrogen must be avoided. Based upon past research, the more noble the metal electrodeposited, the less thermodynamically favorable it is to generate hydrogen during device operation, a result which is clearly favored. For this reason, non-noble metals, such as Zinc (Zn) are not commonly explored for metal-based dynamic windows. However, a side product of Zn reduction, Zn oxide, is formed on the surface of the working electrode. Since ZnO is less conductive than Zn, this layer provides a protective effect onto the ITO, preventing charge transfer to the aqueous solution. This combined with Zn being a poor catalyst for hydrogen evolution allows for Zn reduction and oxidation to proceed without major issue. However, due to their insulated properties, ZnO and other side products tend to accumulate over repeat cycling, which, in time, will amount to enough side products to prevent the desire Zn cycling.

Pursuant to the present invention, dynamic windows based on reversible Zn electrodeposition with a pH neutral electrolyte, preferably as a gel are provided. As a result of the neutral pH, the dynamic window functions for at least four weeks without any significant degradation, far exceeding the resting stability of previous RME devices using acidic electrolytes. Furthermore, 100 cm² dynamic window switch with a ˜80% contrast ratio within less than 20 s.

In embodiments, the present invention broadens the paradigm for the use of practical metals which can be used in reversible metal electrodeposition electrolytes for dynamic windows by demonstrating fully functional Zn electrolytes. Despite the fact that Zn is a non-noble metal with a standard reduction potential of −0.76 V vs. NHE as discussed above, the inventors herein demonstrate that the hydrogen evolution reaction and other deleterious side reactions can be kinetically passivated and controlled using properly designed reversible Zn electrodeposition electrolytes. These Zn electrolytes possess high Coulombic efficiency and support the formation of a highly opaque metal film. In addition to zinc salts, electrolyte solutions optionally comprise effective concentrations of cations such as alkali metal ions (Li+, Na+, K+, Rb+, Cs+) along with Mg2+ and Ca2+ to promote or increase the ionic conductivity of the electrolyte. These cations are included in electrolyte compositions at concentrations ranging from about 0.1M to 5.0M.

In embodiments, in electrolyte solutions which comprise zinc salts, about 0.01-50 mM, often 0.1-10 mM, often 0.5-1 mM, more often 1 mM of Cu(CH₃COO)₂ is optionally added to the zinc electrolyte in order to inhibit the formation and/or facilitate the release of ZnO and Zn(OH)₂ from electrodeposited cathodes. In embodiments, sulfate anion SO₄²⁻ at concentrations ranging from about 0.01M to 5M, often 0.5M to 1M supports high current density and good optical contrast and reversibility of Zn electrodeposition.

In addition to probing the fundamental electrochemical properties of these electrolytes, their successful design allows us to construct practical two-electrode dynamic windows that possess high optical contrast. By harnessing a non-noble metal, this work diversifies the chemical space of reversible metal electrodeposition on transparent conductors.

Previous research shows that Bi and Cu electrolytes on ITO on glass and related transparent electrodes facilitate fast, reversible, and color neutral metal electrodeposition over thousands of cycles. Most metal-based electrolytes, that are studied are acidic because metal ions are Lewis acids, and these solutions tend to not be soluble at more alkaline conditions. Bi—Cu also forms insoluble Bi(OH)₃ at neutral or alkaline conditions as seen in Equation 1:

Bi³⁺_{(aq)}+3H₂O⇄Bi(OH)₃₍ₛ₎+3 H⁺_{(aq)} (1)

However, there are two main problems with acidic electrolytes in metal-based dynamic windows utilizing ITO. The first major issue is that acidic solutions slowly degrade the ITO. ITO has good conductivity and a sheet resistance of ˜10 Ω/sq, but as the ITO is soaked in the acidic electrolyte, the sheet resistance starts to increase and will eventually become non-conductive. The second issue is that acidic solutions are more prone to evolving H₂ gas than neutral or alkaline solutions. According to the Nernst Equation, at pH 2 the thermodynamic potential for H₂ evolution is at −0.33 V vs. Ag/AgCl at pH 2, while it would be −0.62 V vs. Ag/AgCl at pH 7. This greatly increases the electrochemical window allowing for the voltage limit to be expanded.

To increase the pH of the solution, a method is needed to solubilize the Bi³⁺ ions. Chelating agents are ligands that bond metal ions, effectively “trapping” them. This would force the Bi³⁺ ions to stay in a soluble state even at higher pHs until a current is applied, and Bi metal is electrodeposited. Accordingly, the present invention has shown that the inclusion of chelating agents in electrolyte solutions which contain bismuth and copper salts can be used to provide Bi—Cu electrolyte solutions effective in dynamic windows.

### BRIEF SUMMARY OF THE INVENTION

As discussed herein above, reversible metal electrodeposition is an emerging and promising method for designing dynamic windows with controllable transmission. Zn has shown to be a viable option for metal-based dynamic windows due to its fast switching kinetics and reversibility despite its very negative deposition voltage. Bi—Cu combinations have also shown to be viable options in this same regard. Pursuant to the present invention, the inventors have provided electrode/electrolyte systems based upon Zn, Bi, Cu and Bi—Cu combinations. These systems can be utilized commercially to provide dynamic windows to allow electrodeposition of metal onto transparent electrode conducting surfaces at an effective negative voltage as described herein resulting in an opaque surface which can be reversed to the original electrode transparency by providing an effective positive charge. The resulting systems based upon Zn, Bi, Cu or Bi—Cu combination electrolytes are readily applicable to commercial settings and can be used with substantial reliability on a number of presently available transparent electrodes. Through the systematic addition or removal of components of the electrolytes from the surface of the working conducting electrode, a link between the electrolyte's anions and the effectiveness of the reversible metal electrodeposition of Zn, Bi, Cu and Bi—Cu with favorable switching (switch speed) can be achieved. Through this link, the inventors have been able interpret the effect the anions would have on the windows' reversibility and the electrolyte's side product formation. Although the formation of side products of hydrogen, Zn oxide and hydroxide has shown to hinder the reversibility of Zn RME windows, the present inventive is shown to reduce these side products and improve efficiency (especially with respect to switching speed and long term reliability of this approach to dynamic windows. Often dynamic windows according to the present invention can be presented which provide clear conducting electrodes at approximately 80% or more light transmissibility (600 nm) in a non-deposited state and <1% light transmissibility (600 nm) after metal deposition of Zn, Bi, Cu or Bi—Cu in a period which is less than 20 seconds.

Dynamic windows, which electronically switch between clear and dark states, are proposed to play a vital role in energy-efficient buildings and other applications by reducing lighting, heating, and cooling demands. Pursuant to the present invention, the inventors have studied reversible Zn, Bi, Cu and Bi—Cu electrodeposition on transparent conducting electrodes as described herein and propose a mechanism that explains the deposition and dissolution processes and utilizes that mechanism to provide practical, efficient and reliable dynamic window systems. The mechanism which has been discovered in experiments which are set forth in further detail herein enables the construction of 100 cm² or larger two-electrode devices that transition from clear (80% transmission at 600 nm) to highly opaque (<0.1% transmission at 600 nm) in less than one minute, often less than 20 seconds. This is unexpected from the teachings of the art of which the inventors are aware.

The dynamic windows of the present invention utilize an electrolyte solution of Zn, Bi, Cu or Bi—Cu in a pH tunable electrolyte solution (which may be adjusted with acid or base to a target pH) as described in greater detail herein, which enables them to switch quickly and without degradation over the course of at least four weeks and often for several months or more. The high opacity, reversibility and stability of the Zn, Bi, Cu or Bi—Cu devices represent significant improvements over existing switchable thin films based on the reversible electrodeposition of Bi and Cu which are known in the art.

Accordingly, the present invention is directed to a new class of electrolytes and related compositions in liquid or gel form in combination with a working conducting electrode and a counter electrode that facilitate the reversible electrodeposition of non-noble metals on transparent conducting electrodes. These electrolytes are relevant to and are used to provide dynamic windows and other technologies that contain an optoelectronically switchable material.

In an embodiment, the present invention is directed to a dynamic glass element or window (1) comprising a transparent working conductive electrode or cathode (2), a counter electrode or anode (4) and an aqueous electrolyte composition as a solution or gel (3) located between the cathode and the anode, wherein the electrolyte composition comprises an aqueous solution of a salt selected from the group consisting of at least one zinc salt, at least one bismuth salt, at least one copper salt or a combination of at least one bismuth salt and at least one copper salt at a pH ranging from about 3-11, wherein the zinc salt is included in the electrolyte composition at a concentration of 0.01M to 5.0M, the bismuth salt, the copper salt or the combination of the bismuth salt and copper salt are each included in said electrolyte composition at a molar concentration ranging from 5 to 25 mM, wherein said electrolyte composition deposits zinc, bismuth, copper or bismuth and copper onto the surface of said cathode upon application of a voltage ranging from −2.0 to −0.1 volts such that said cathode transitions from clear (at least 80% light transmission at 600 nm) to highly opaque (<0.1% light transmission at 600 nm) in less than 5 minutes. In embodiments, the opaque cathode switches back to transparent by applying a voltage ranging from +0.1 to 2.0 volts

In an embodiment, the present invention is directed to a dynamic glass element or window (1) comprising a transparent working conductive electrode or cathode (2), a counter electrode or anode (4) and an aqueous electrolyte composition which is a solution and/or gel (3) located between the cathode and the anode. In embodiments, the dynamic glass element comprises a frame or support which encloses the dynamic glass element. In embodiments, the cathode is supported by a glass backing (5). In embodiments, the cathode (4) and glass backing (5) form part or all of the frame. In embodiments, the electrolyte solution or gel comprises an aqueous solution of a salt selected from the group consisting of at least one zinc salt, at least one bismuth salt, at least one copper salt or a combination of at least one bismuth salt and at least one copper salt at a pH ranging from about 3-11, often 4-8, wherein the zinc salt(s) is included in the electrolyte composition at a concentration of 0.01M to 5.0M, preferably 0.5M to 5.0M, the bismuth salt(s), the copper salt(s) or the combination of the bismuth salt(s) and copper salt(s) are each included in said electrolyte composition at a molar concentration ranging from 5 to 25 mM, often 10-20 mM. In embodiments, when said electrolyte composition comprises said zinc salt(s), said bismuth salt(s) and/or said copper salt(s) said composition optionally includes at least one chelating agent at a molar concentration ranging from 0.1 mM to 150-200 mM or more (up to 5.0M in the case of zinc) of said electrolyte solution. In embodiments, upon application to said cathode of a voltage ranging from −2.0 to +2.0 as described herein, said electrolyte solution or gel can transition the cathode in 100 cm² two-electrode devices from clear (80% transmission at 600 nm) to highly opaque (<0.1% transmission at 600 nm) in less than 5 minutes, often less than one minute, and often less than 20 seconds.

In embodiments, the electrolyte composition which comprises the zinc salt, is often completely soluble in the electrolyte solution and excludes a chelating agent. In other embodiments, the zinc salt containing electrolyte solution comprises a chelating agent(s). In embodiments, the bismuth(s) salt and/or the copper salt(s) includes a chelating agent or the bismuth and/or copper salts are alternatively presented as a bismuth or copper chelate at a molar concentration ranging from 5 to 25 mM. In such instances where a metal chelate is included in the electrolyte composition, a separate chelating agent may be excluded from the electrolyte solution. In embodiments, the zinc salt may be presented as a zinc chelate, often at a concentration ranging from 0.1M to 5.0M. In embodiments, the anode, cathode and electrolyte composition are enclosed in a frame or border. In embodiments, the frame can be metallic and function as the counter electrode (4) which may include an inert material as insulation or the frame can be an inert material such as a plastic, rubber or other appropriate material.

In embodiments, the conductive electrode (cathode) is formed from a material selected from the group consisting of tin-doped indium oxide (ITO), fluorine-doped tin oxide (FTO), indium zinc oxide (IZO), aluminum-doped zinc oxide (AZO), indium tin zirconium oxide (ITZO), indium gallium oxide (IGO), indium gallium zinc oxide (IGZO), tin oxide (SnO), zinc tin oxide (ZTO) or zinc oxide doped with Ga (gallium), B (boron), Y (yttrium), Sc (scandium), Si (silicon) or Ge (germanium). Often, aluminum-doped zinc oxide (AZO) is used for the cathode and more preferably, tin-doped indium oxide (ITO) or fluorine-doped in oxide (FTO) is used. Typically, these metal oxide materials are coated onto a glass layer of the dynamic glass element or dynamic window.

In embodiments, when zinc is electrodeposited onto the working conductive electrode (cathode), the counter electrode (anode) is a zinc foil, a zinc metal mesh, a woven zinc wire, a zinc grid or a substrate (such as a grid core made of stainless steel, copper (Cu), silver (Ag) or gold (Au)) which is coated with zinc via a lithographic, electrodeposition, continuous galvanizing or a related coating process or a zinc alloy (zinc aluminum, brass, or other zinc alloy including zinc silver or zinc gold). The cathode provides Zn²⁺ or other (Bi³⁺, Cu²⁺) cations into solution as metal is removed from solution during the electrodeposition process on the cathode. This is presented in the equation which is set forth in FIG. 2A. In embodiments, when bismuth and/or copper is electrodeposited onto the working conductive electrode the counter electrode is a bismuth, copper or bismuth-copper foil, metal mesh, woven wire or a grid or substrate or alloy as described above for zinc. Often, the counter electrode (anode) is a foil or mesh, most often a mesh.

In embodiments, the electrolyte composition is in the form of a gel comprising a gelling agent in an effective amount to gel said composition. Any industrial gelling agent which is consistent with the electrochemistry of the dynamic glass element or window may be used. Preferred gelling agents include, for example, hydroxyethylcellulose, hydroxypropylcellulose, polyvinylalcohol, cross-linked polymers and hydrogels, including crosslinked hydrogels such as (poly) hydroxyethylmethacrylate, (poly)hydroxypropylmethacrylate and polyacrylamide, among others. In embodiments, a leveling agent such as polyvinylalcohol (PVA), thiourea, cetyltrimethyl ammonium bromide, sodium dodecyl sulfate, and/or chloride ion ranging from about 0.05 to 15% by weight, often 0.1 to 10% by weight is added to the electrolyte solution in order to provide a level deposition of the metal onto the surface of the conductive working electrode for enhancement of electrodeposition of metal. In embodiments, the use of PVA is preferred and may serve as both as the gelling agent and the leveling agent.

In embodiments, the present invention broadens the paradigm for the use of practical metals which can be used in reversible metal electrodeposition electrolytes for dynamic windows by demonstrating fully functional Zn electrolytes. Despite the fact that Zn is a non-noble metal with a standard reduction potential of −0.76 V vs. NHE as discussed above, the inventors herein demonstrate that the hydrogen evolution reaction and other deleterious side reactions can be kinetically passivated and controlled using properly designed reversible Zn electrodeposition electrolytes. These Zn electrolytes possess high Coulombic efficiency and support the formation of a highly opaque metal film.

Electrolyte compositions optionally comprise effective concentrations of ionic conductivity cations such as alkali metal ions (Li+, Na+, K+, Rb+, Cs+) along with Mg2+ and Ca2+ to promote or increase the ionic conductivity of the electrolyte. These cations are included in electrolyte compositions at concentrations ranging from about 0.1 mM to 5.0M, often 0.1M to 5.0M.

In embodiments, in electrolyte solutions which comprise zinc salts, about 0.01-50 mM, often 0.1-10 mM, often 0.5-1 mM, more often 1 mM of Cu(CH₃COO)₂ is optionally added to the zinc electrolyte in order to inhibit the formation and/or facilitate the release of ZnO and Zn(OH)₂ from electrodeposited cathodes. In embodiments, sulfate anion SO₄²⁻ at concentrations ranging from about 0.01M to 5M, often 0.5M to 1M supports high current density and good optical contrast and reversibility of Zn electrodeposition.

In embodiments, the voltage applied to the working conductive electrode for electrodeposition (to form an opaque surface on the conductive electrode) is a negative voltage, often ranging from −0.1 to −2.0, often −0.1 V to −1.7 V. For removal of the coating on the surface of the conductive electrode, a positive voltage often ranging from +0.1 to +2.0, often +0.1 V to +1.7 V is used. Current densities for the electrodes typically range from +−0.01 to 10 mA/cm². The voltage is applied through a dynamic voltage source to the window and more specifically to the conductive electrode (cathode) at a voltage input between −2.0V to +2.0V, and is often switchable between at least two predetermined voltages—one a preset negative voltage and one a preset positive voltage to electrodeposit/opacify or render the working conducting cathode transparent by removing metal from the cathode. The potential difference in voltage between the working conductive electrode (cathode) and the counter electrode (anode) is what drives the electrodeposition (metal onto the conductive electrode) or switching (metal off of the conductive electrode and onto the counter electrode). A variable DC power supply with a switch or an alternative power source may be used to provide the appropriate voltages. Embodiments, this power source is programmable.

The size of the working conductive electrode onto which the metal(s) is deposited will depend upon the application for which the dynamic window is used. Although the dimensions of the working and counter electrodes will vary as a function of the use to which the dynamic window is employed, for best aesthetics, the metal oxides (ITO, etc.) of the working electrode are layered onto glass and the counter electrode is formed of wires of a fine mesh or foil to be more aesthetic and useful. The counter electrode meshes are made from wires often with widths of 50 microns or less (ranging from about 0.05 microns up to about 50 microns, often about 1 to 50 microns, 5-50 microns, 10-25 microns or 15-35 microns would be more useful). The counter electrode may also comprise the frame or a support of the dynamic window, or other structures as depicted in FIG. 2A.

In embodiments, a chelating agent is included in the electrolyte solution as an optional component in an effective amount or concentration often ranging from a molar concentration from about 0.1 mM to 150-200 mM (up to 5.0M in the case of zinc electrodeposition) of the electrolyte composition depending upon the concentration of the metal salt in the electrolyte solution and the desired pH of the electrolyte solution used in the present invention, within a range of about 3-11, often 4-8, depending on the salts included in the electrolyte solution and their impact on electrodeposition, switching and the stability and longevity of the components of the dynamic window with a more neutral pH often preferred. Exemplary chelating agents for inclusion in electrolyte solutions of the present include one or more of the following chelators:
Ethylenediamine-N,N,N′,N′tetracetatic acid (EDTA)
ethylenediamine-N,N,N′triacetic acid (ED3A)
ED3A-OH
ethylenediamine-N,N′diacetic acid (EDDA)
ethylenediamine-N-acetic acid (EDTA)
glycine
ethylenediamine-N,N′-disuccinic acid (EDDS)
ethylenediamine-N,N′-bis(2-hydroxyphenylacetic acid) (EDDHA)
nicotianamine
2,2′,2″,2′″-(1,4,7,10-Tetraazacyclododecane-1,4,7,10-tetrayl)tetraacetic acid) (DOTA)
1,4,7-Triazacyclononane-1,4,7-triacetic acid (NOTA)
(ethylene glycol-bis(β-aminoethyl ether)-N,N,N′,N′-tetraacetic acid) (EGTA)
1,2-bis(o-aminophenoxy)ethane-N,N,N′,N′-tetraacetic acid (BAPTA)
nitrilotriacetic acidIminodiacetic acid
diethylenetriaminepentaacetic acid (pentetic acid)
tetraethylenepentamine (TEPA)
Tris(2-aminoethyl)amine (tren)
Tris(2-pyridylmethyl)aminetris(hydroxymethyl)aminomethane (tris)
2-[Bis(2-hydroxyethyl)amino]-2-(hydroxymethyl)propane-1,3-diol (bis-tris)1,3-bis(tris(hydroxymethyl)methylamino)propane (BTP)
{[1,3-Dihydroxy-2-(hydroxymethyl)propan-2-yl]amino}acetic acid (tricine)
[Bis(2-hydroxyethyl)amino]acetic acid (bicine)
1,2-Diaminopropane-N,N,N′,N′-tetraacetic acid
1,3-Diamino-2-hydroxypropane-N,N,N′,N′-tetraacetic acid
Triethylenetetramine
Diethylenetriamine
   When used, preferred chelators for inclusion in electrolyte compositions include ED3A, EDDA or a mixture thereof. Most often, the chelator is ED3A-OH alone or as a mixture with another chelator.

Additional chelators which may be included in electrolyte solutions include those chelating agents, identified herein below which may be used to form metal chelates formed from metal cation and the chelating agent using standard methods known in the art. They are used in the same concentrations in electrolyte solutions (0.1 mM-150-200 mM up to 5.0M in the case of zinc electrodeposition) as the chelating agents identified above.

In embodiments, a metal chelate is used in electrolyte composition, rather than a chelating agent. The metal chelates are metal chelates of zinc, bismuth, copper or bismuth-copper (bismuth and copper). Preferred zinc chelates exhibit a binding constant of 10⁹ to 10¹⁶ for Zn²⁺ with the corresponding metal chelate (obtained by chelating the metal to the chelating agent). Preferred bismuth chelates exhibit a binding constant of 10²⁰ to 10²⁷ for Bi³⁺ with the corresponding chelating moiety. Preferred copper chelates exhibit a binding constant of 10¹¹ to 10¹⁸ for Cu²⁺ with the corresponding chelating agent (chelator).

In embodiments, the chelator agent that reacts with zinc, bismuth or copper chelate to provide Zn²⁺ chelators, Bi³⁺ chelators is a chelator compound as identified by the following:
(EDTA) Glycine, N,N′-1,2-ethanediylbis[N-(carboxymethyl)-
(EDDA) Glycine, N,N′-1,2-ethanediylbis-
(ED3A-OH) Glycine, N-[2-[bis(carboxymethyl)amino]ethyl]-N-(2-hydroxyethyl)-
(ED3A) Glycine, N-(carboxymethyl)-N-[2-[(carboxymethyl)amino]ethyl]-
Glycine, N,N′-(iminodi-2,1-ethanediyl)bis[N-(carboxymethyl)-
Glycine, N-[2-[bis(carboxymethyl)amino]ethyl]-N-[2-[(carboxymethyl)amino]ethyl]-
Glycine, N-[2-[bis(carboxymethyl)amino]ethyl]-N-ethyl-
Glycine, N,N′-(1-methyl-1,2-ethanediyl)bis[N-(carboxymethyl)-
Alanine, N-[2-[bis(carboxymethyl)amino]ethyl]-N-(carboxymethyl)-
β-Alanine, N-[2-[bis(carboxymethyl)amino]ethyl]-N-(carboxymethyl)-
Glycine, N-[2-[bis(carboxymethyl)amino]ethyl]-N-methyl-
Glycine, N,N′-[(methylimino)di-2,1-ethanediyl]bis[N-(carboxymethyl)-
Glycine, N,N′-1,2-ethanediylbis[N-(2-hydroxyethyl)-
Glycine, N-[2-[bis(2-hydroxyethyl)amino]ethyl]-N-(carboxymethyl)
Glycine, N-[2-[bis(carboxymethyl)amino]ethyl]-N-propyl-
Glycine, N,N′-1,3-propanediylbis[N-(carboxymethyl)-
β-Alanine, N-[2-[bis(carboxymethyl)amino]ethyl]-N-(2-carboxyethyl)-
β-Alanine, N,N′-1,2-ethanediylbis[N-(carboxymethyl)-
3,6,9,12-Tetraazatetradecanedioic acid, 3,12-bis(carboxymethyl)-
Glycine, N,N′-[(ethylimino)di-2,1-ethanediyl]bis[N-(carboxymethyl)-
β-Alanine, N-[2-[bis(2-carboxyethyl)amino]ethyl]-N-(carboxymethyl)-
3,6,9,12-Tetraazatetradecanedioic acid, 6,9-bis(carboxymethyl)-
Alanine, N,N′-1,2-ethanediylbis[N-(carboxymethyl)-
Glycine, N,N′-(1,2-dimethyl-1,2-ethanediyl)bis[N-(carboxymethyl)-
Glycine, N-(carboxymethyl)-N′-(2-mercaptoethyl)-N,N′-ethylenedi-
Glycine, N,N′-(1-ethyl-1,2-ethanediyl)bis[N-(carboxymethyl)-
Glycine, N-[2-[bis(carboxymethyl)amino]ethyl]-N-butyl-
Glycine, N,N′-[(carboxymethylimino)diethylene]bis[N-2-hydroxyethyl-
Glycine, N-[2-[bis(2-hydroxyethyl)amino]ethyl]-N′-(carboxymethyl)-N,N′-ethylenedi-
Glycine, N-(2-amino-2-oxoethyl)-N-[2-[bis(carboxymethyl)amino]ethyl]-
Serine, N-[2-[bis(carboxymethyl)amino]ethyl]-N-(carboxymethyl)-
Propanedioic acid, 2,2′-[1,2-ethanediylbis(methylimino)]bis-
Glycine, N-(carboxymethyl)-N′-(cyanomethyl)-N,N′-ethylenedi-
Glycine, N,N-bis[2-[bis(carboxymethyl)amino]ethyl]-
Glycine, N,N′-[[(2-hydroxyethyl)imino]di-2,1-ethanediyl]bis[N-(carboxymethyl)-
Glycine, N-(carboxymethyl)-N-[2-(diethylamino)ethyl]-
Glycine, N,N′-1,2-ethanediylbis[N-ethyl-
Glycine, N,N′-[1-(hydroxymethyl)-1,2-ethanediyl]bis[N-(carboxymethyl)-
Glycine, N,N-bis[2-[(carboxymethyl)amino]ethyl]-
Glycine, N-[2-[bis(carboxymethyl)amino]ethyl]-N-[2-[(carboxymethyl)(2-hydroxyethyl)amino]ethyl]-
Alanine, 3-[bis(carboxymethyl)amino]-N,N-bis(carboxymethyl)-
Glycine, N,N′-[[(2-aminoethyl)imino]di-2,1-ethanediyl]bis[N-(carboxymethyl)-
Glycine, N-(carboxymethyl)-N-[2-[[2-[(carboxymethyl)amino]ethyl]amino]ethyl]-
Glycine, N-[3-[[2-[bis(carboxymethyl)amino]ethyl]amino]propyl]-N-(carboxymethyl)-
Glycine, N-[2-[(2-aminoethyl)(carboxymethyl)amino]ethyl]-N-[2-[bis(carboxymethyl)amino]ethyl]-
Glycine, N,N′-(oxydi-2,1-ethanediyl)bis[N-(carboxymethyl)-
Glycine, N,N′-(1-propyl-1,2-ethanediyl)bis[N-(carboxymethyl)-
Glycine, N,N′-[1-(1-methylethyl)-1,2-ethanediyl]bis[N-(carboxymethyl)-
Glycine, N,N′-(1-hydroxy-1,2-ethanediyl)bis[N-(carboxymethyl)-
Glycine, N,N′-1,2-ethanediylbis[N-(2-aminoethyl)-
Glycine, N-(carboxymethyl)-N′-(2,3-dihydroxypropyl)-N,N′-ethylenedi-
Glycine, N,N′-[(2-hydroxyethylimino)diethylene]bis[N-2-hydroxyethyl-
Acetic acid, [2-[[2-[bis(2-hydroxyethyl)amino]ethyl](2-hydroxyethyl)amino]ethylimino]di-
Glycine, N-[2-[bis(2-hydroxyethyl)amino]ethyl]-N′-2-hydroxyethyl-N,N′-ethylenedi-
Glycine, N-[2-[(carboxymethyl)(2-hydroxyethyl)amino]ethyl]-N-methyl-
1,1-Ethanediol, 2,2′,2″,2′″-(1,2-ethanediyldinitrilo)tetrakis-
Glycine, N,N′-[(methylimino)di-2,1-ethanediyl]bis[N-ethyl-
β-Alanine, N-[2-[bis(carboxymethyl)amino]ethyl]-N-[2-[(carboxymethyl)amino]ethyl]-
Butanoic acid, 2-[[2-[bis(carboxymethyl)amino]ethyl](carboxymethyl)amino]-
Propanoic acid, 3-[[2-[bis(carboxymethyl)amino]ethyl](carboxymethyl)amino]-2-methyl-
Glycine, N,N′-1,4-butanediylbis[N-(carboxymethyl)-
Glycine, N,N′-1,5-pentanediylbis[N-(carboxymethyl)-
Glycine, N,N′-(2-hydroxy-1,3-propanediyl)bis[N-(carboxymethyl)-
Glycine, N-[2-[bis(carboxymethyl)amino]ethyl]-N-(carboxymethyl)-, 1-methyl ester
Glycine, N,N′-(1,1-dimethyl-1,2-ethanediyl)bis[N-(carboxymethyl)-
Glycine, N-[2-[bis(carboxymethyl)amino]ethyl]-N-[2-(methylthio)ethyl]-
L-Alanine, N,N′-1,2-ethanediylbis[N-(1-carboxyethyl)-
Acetic acid, [ethylenebis[(methylimino)ethylenenitrilo]]tetra-
Glycine, N-[3-[bis(carboxymethyl)amino]-2-hydroxypropyl]-N-(2-hydroxyethyl)-
Glycine, N-[3-[bis(carboxymethyl)amino]propyl]-N-(2-hydroxyethyl)-
Glycine, N,N′-[[[2-[(carboxymethyl)methylamino]ethyl]imino]di-2,1-ethanediyl]bis[N-methyl-
Butanoic acid, 3-[[2-[bis(carboxymethyl)amino]ethyl](carboxymethyl)amino]-
Aspartic acid, N-(carboxymethyl)-3-[(carboxymethyl)methylamino]-N-methyl-
Aspartic acid, N-[2-[bis(carboxymethyl)amino]ethyl]-
Aspartic acid, N-[2-[(2-carboxyethyl)(carboxymethyl)amino]ethyl]
Glycine, N,N′-ethylenebis[N-isopropyl-
Glycine, N,N′-1,2-ethanediylbis[N-methyl-
Glycine, N-(carboxymethyl)-N-[2-(dimethylamino)ethyl]-
Glycine, N-[3-[bis(carboxymethyl)amino]propyl]-N-methyl-
Alanine, N,N′-1,2-ethanediylbis[N-(2-carboxyethyl)-
β-Alanine, N,N′-1,2-ethanediylbis[N-(2-carboxyethyl)-
Glycine, N,N′-(1-butyl-1,2-ethanediyl)bis[N-(carboxymethyl)-
Butanoic acid, 2,2′-[1,2-ethanediylbis[(carboxymethyl)imino]]bis-
Glycine, N,N′-(2-hydroxy-1,3-propanediyl)bis[N-(2-hydroxyethyl)-
Glycine, N-(3-aminopropyl)-N-[3-[bis(carboxymethyl)amino]propyl]-
β-Alanine, N,N′-1,2-ethanediylbis[N-(2-hydroxyethyl)-
β-Alanine, N,N′-1,3-propanediylbis[N-(carboxymethyl)-
Acetic acid, (1,2-diethylethylenedinitrilo)tetra-
Glycine, N,N′-[[[2-[(carboxymethyl)amino]ethyl]imino]di-2,1-ethanediyl]bis[N-(carboxymethyl)-
L-Alanine, N-(1-carboxyethyl)-N-[2-[(1-carboxyethyl)amino]ethyl]-
Glycine, N,N′-(2-methyl-1,3-propanediyl)bis[N-(carboxymethyl)-
Glycine, N-[3-[bis(carboxymethyl)amino]-2-hydroxypropyl]-N-methyl-
Glycine, N-(carboxymethyl)-N-[2-(methylamino)ethyl]-
Glycine, N-[2-[(carboxymethyl)amino]ethyl]-N-methyl-
Glycine, N,N′-(iminodi-2,1-ethanediyl)bis-
Glycine, N-(2-aminoethyl)-N-(carboxymethyl)-
Glycine, N,N′-(1-methyl-1,2-ethanediyl)bis-
β-Alanine, N-[2-[(carboxymethyl)amino]ethyl]-
Glycine, N-[2-[(2-hydroxyethyl)amino]ethyl]-
Glycine, N-[2-[(carboxymethyl)amino]ethyl]-N-(2-hydroxyethyl)-
Glycine, N-(carboxymethyl)-N-[2-[(2-hydroxyethyl)amino]ethyl]-
Alanine, N,N′-1,2-ethanediylbis-
Glycine, N,N′-1,3-propanediylbis-
Glycine, N,N′-1,2-ethanediylbis[N-chloro-3,6,9,12-Tetraazatetradecanedioic acid
Glycine, N-[2-(ethylamino)ethyl]-
Glycine, N-[2-[(2-aminoethyl)amino]ethyl]-
Glycine, N,N′-(1,2-dimethyl-1,2-ethanediyl)bis-
Glycine, N-[2-[[2-(methylamino)ethyl]amino]ethyl]-
Glycine, N-[2-[(carboxymethyl)amino]ethyl]-N-(cyanomethyl)-
Propanedioic acid, 2-[[2-[(2-aminoethyl)amino]ethyl]amino]-
Glycine, N-[2-[(2-hydroxypropyl)amino]ethyl]-
Glycine, N-(carboxymethyl)-N-(cyanomethyl)-
Glycine, N-[2-(methylamino)ethyl]-
Glycine, N-[2-(dimethylamino)ethyl]-
Glycine, N-[2-[[2-(ethylamino)ethyl]amino]ethyl]-
Glycine, N-(2-aminoethyl)-N-(2-hydroxyethyl)-
β-Alanine, N-(2-aminoethyl)-N-(carboxymethyl)-
Glycine, N-[2-(propylamino)ethyl]-
Glycine, N-(carboxymethyl)-N-(2-hydroxyethyl)-
Glycine, N-(carboxymethyl)-
β-Alanine, N,N′-1,2-ethanediylbis-
Alanine, N-[2-[(2-aminoethyl)amino]ethyl]-
Glycine, N-(2-aminoethyl)-N-[3-[(carboxymethyl)amino]propyl]-
Glycine, N-[2-[[2-(carboxymethoxy)ethyl]amino]ethyl]-3,6,9,12-Tetraazatridecanoic acid
Glycine, N-[2-[[2-[(2-aminoethyl)amino]ethyl]amino]ethyl]-
Glycine, N-[2-(dimethylamino)ethyl]-N-(2-hydroxyethyl)-
Glycine, N-[2-[(2-hydroxyethyl)methylamino]ethyl]-N-methyl-
Glycine, N-(carboxymethyl)-N-ethyl-
Glycine, N,N′-1,4-butanediylbis-
Glycine, N,N′-(oxydi-2,1-ethanediyl)bis-
Propionic acid, 3-amino-2-[(carboxymethyl)amino]-
Ethyl, 2-[bis(carboxymethyl)amino]-
Alanine, 3-[(carboxymethyl)amino]-
Glycine, N-[2-[(2-methoxyethyl)methylamino]ethyl]-
Glycine, N-(2-aminoethyl)-N-ethyl-
β-Alanine, N-(carboxymethyl)-N-[2-(dimethylamino)ethyl]-
Glycine, N-[2-(ethylmethylamino)ethyl]-N-(2-hydroxyethyl)-
Glycine, N-(carboxymethyl)-N-[2-[(carboxymethyl)amino]propyl]-
Glycine, N-(2-aminoethyl)-N′-(carboxymethyl)-N,N′-ethylenedi-
Glycine, N-(carboxymethyl)-N-[3-[(carboxymethyl)amino]propyl]-
β-Alanine, N-(2-carboxyethyl)-N-[2-[(carboxymethyl)amino]ethyl]
Glycine, N-[2-[[2-[(2-aminoethyl)amino]ethyl]amino]ethyl]-N-(carboxymethyl)-
β-Alanine, N-[2-[(2-carboxyethyl)amino]ethyl]-N-(carboxymethyl)
Alanine, N-(1-carboxyethyl)-N-[2-[(1-carboxyethyl)amino]ethyl]-
Glycine, N,N-bis[2-[(carboxymethyl)methylamino]ethyl]-
Alanine, N-(carboxymethyl)-3-[(carboxymethyl)methylamino]-N-methyl-
Alanine, N-(2-carboxyethyl)-3-[(2-carboxyethyl)amino]-
Glycine, N-[2-[bis(carboxymethyl)amino]ethyl]-N-(2-oxoethyl)-
β-Alanine, N-(2-carboxyethyl)-N-[2-[(2-hydroxyethyl)amino]ethyl]
β-Alanine, N-[2-[(2-carboxyethyl)amino]ethyl]-N-(2-hydroxyethyl)-

Preferred chelators which are used to form metal chelates for use in the present invention include ED3A (Glycine, N-(carboxymethyl)-N-[2-[(carboxymethyl)amino]ethyl]-), EDDA (Glycine, N,N′-1,2-ethanediylbis-) or a mixture thereof. Most often, the chelator is ED3A-OH (Glycine, N-[2-[bis(carboxymethyl)amino]ethyl]-N-(2-hydroxyethyl)-). Chemical structures associated with the chelators used to form Zn, Bi and Cu chelators used in electrolyte solution of the present invention are presented in FIG. 1 hereof. Alternatively, these chelator agents may be included as individual components in electrolyte compositions at the same concentrations as other chelating agents, described herein above.

In embodiments, the present invention is directed to dynamic glass elements or windows, which electronically switch between clear and dark states and play a vital role in energy-efficient buildings by reducing lighting, heating, and cooling demands. Pursuant to the present invention the inventors have studied reversible Zn, Bi, Cu and Bi—Cu electrodeposition on tin-doped indium oxide, fluorine tin oxide and other electrodes and propose a mechanism that explains the deposition and dissolution processes. See FIGS. 2A and 2B. This mechanistic understanding enables the skilled practitioner to construct 100 cm² two-electrode devices that transition from clear (80% transmission at 600 nm) to highly opaque (<0.1% transmission at 600 nm) often in less than a minute and often less than 20 s utilizing zinc, bismuth, copper and mixtures of bismuth and copper salts in electrolyte compositions as described herein. Additionally, the dynamic glass elements or windows of the present invention utilize a tunable pH controlled electrolyte solution at a pH ranging from 3-11 and often 4-8, which enables the windows to switch without degradation over the course of at least four weeks and several months, six months and/or a year or more. In embodiments, the dynamic glass elements exhibit substantial stability for periods of at least six months, a year or more. The high opacity and stability of the Zn-, Bi- Cu- and BiCu-based devices represent significant improvements over existing switchable thin films based on the traditional reversible electrodeposition of more Bi and Cu of the prior art.

In embodiments, the present invention is directed to a series of aqueous electrolytes that support reversible Zn—, Bi—, Cu— and Bi—Cu electrodeposition on transparent metal oxide electrodes including tin-doped indium oxide and fluorine doped tin oxide electrodes as disclosed herein. In further embodiments of the present invention, by systematically altering the composition of the electrolytes, the inventors of the present invention have developed relationships between the chemical identity of halides, carboxylates, and haloacetates in the electrolytes and the electrochemical and optical properties of reversible Zn electrodeposition. In embodiments, this strategy enables the design of electrolytes with 99% Coulombic efficiency that support reversible optical contrast on electrodes. As described in the examples, X-ray diffraction and scanning electron microscopy analyses establish connections between the composition and morphology of the electrodeposits and the composition of the electrolytes.

In embodiments, although electrode degradation and H₂ evolution are thermodynamically favorable under the operating voltages of the electrolytes due to the negative standard reduction potential of Zn/Zn²⁺, the inventors find that these reactions are kinetically passivated by the Zn and ZnO electrodeposits. For example, an understanding of these electrochemical properties allows the construction of 25 cm² dynamic windows that switch with 64% or more optical contrast at 600 nm within a minute and in embodiments, less than 30 seconds to the original transparent electrode condition. In embodiments, because of the use of non-noble Zn which is readily soluble in electrolyte solution and the use of Bi, Cu and Bi—Cu in combination with chelators or metal chelates as opposed to the metals commonly used in prior art electrolytes, the invention expands the chemical scope of electrolytes in dynamic windows based on reversible metal electrodeposition, which will advance the state of the art with respect to future advances in electrolyte design.

Further embodiments of the present invention may be readily gleaned from a review of the FIGURES and detailed description of the invention as described herein below.

### BRIEF DESCRIPTION OF THE FIGURES

FIG. 1 shows a number of chemical chelators which are used as precursors to form Zn²⁺, Bi³⁺ and Cu²⁺ metal chelates which may be employed in electrolyte solutions according to the present invention. These chelator compounds may also be used as chelator compounds which are added to electrolyte solutions in combination with the Zn, Bi and Cu metal salts in embodiments of the present invention.

FIGS. 2A and 2B show schematics of a dynamic glass element or window that can be used in the present invention. 2A) shows a general schematic of a dynamic window according to the present invention. Elements of the dynamic glass element or window 1 include a cathode (working conducting) electrode 2 which is generally a transparent metal oxide such as tin-doped indium (indium tin oxide or ITO) or fluorine doped tin oxide (FTO) on glass which switches from its natural transparent color to opaque and vice-versa as a consequence of electrodeposition of metal onto the surface of the electrode (opaque) and switching back to transparent by removal of the metal from the surface of the electrode according to the reaction described in the FIGURE; 3 electrolyte solution as a liquid or gel which contains metal salts (metal+ ions) as well as other optional components such as a leveling agent and/or chelating agents as disclosed herein which provides metal ions for deposition; and 4 an anode which is the counter electrode and source for metal ions according to the electrochemical reaction as well as metal during switching, which may also serve as a frame for the window and 5 a glass backing for the window to provide structural integrity. During electrodeposition, metal ions are deposited onto the cathode to provide an opaque surface (as metal and related oxidized metal species) and during switching the anode receives metal from the electrolyte solution to allow the cathode (counter electrode) to be transformed (switched) back to its original transparent state. Here, the counter electrode 3 is fashioned as a frame for the window. FIG. 2B) shows a schematic of a dynamic window that facilitates reversible Zn electrodeposition on an ITO on glass working electrode and a Zn mesh counter electrode. 2B shows the device architecture of metal-based (Zn—, Bi—, Cu— or Bi—Cu) dynamic windows in which ITO or other metal oxide is used as the working conducting working electrode and a Zn mesh serves as the counter electrode. In between these two electrodes, there is a gel-modified aqueous electrolyte, which contains Zn²⁺ ions for reversible metal electrodeposition and K⁺ ions for increasing the ionic conductivity of the electrolyte. The application of −1 V with respect to the working electrode switches the dynamic window from clear to dark. At a negative potential, Zn²⁺ ions are reduced to metallic Zn and electrodeposited on the ITO surface. At the same time, to counter this reaction, Zn metal from the counter electrode is oxidized to Zn²⁺. Upon flipping the polarity of the potential, the opposite reactions occur, and the dynamic window switches back to its original clear state. The equations associated with zinc deposition and zinc switching is presented in the examples section set forth herein below.

FIG. 3 shows (a) the transmission of a 25 cm² dynamic window with an ITO on glass working electrode, a Zn mesh counter electrode, and a Zn acetate gel electrolyte as a function of wavelength after 0 s (black), 10 s (red), 15 s (blue), and 30 s (teal) of window tinting at −1 V and (b) Transmission of the same window at 600 nm during 30 s of metal electrodeposition at −1 V and 60 s of metal stripping at 1 V.

FIG. 4 shows (a) the transmission of a 25 cm² dynamic window with an ITO on glass working electrode, a Zn counter electrode, and a Zn acetate gel electrolyte during switching. The device was switched once a week for four consecutive weeks. The window was darkened at −0.5 V for 60 s and lightened at 1 V for 120 s. (b) Contrast ratio at 600 nm of an analogous dynamic window with a Zn—Cu electrolyte over the course of 2,500 cycles.

FIG. 5 shows photographs of a 100 cm² dynamic window after (a) 0 s, (b) 10 s, and (c) 30 s of metal electrodeposition using an ITO on glass working electrode and a Zn grid counter electrode. (d) Transmission at 600 nm through the edge (green) and the center (red) of the window during switching at −1 V for 30 s followed by 1 V for 60 s.

FIG. 6 shows (a, b) the transmission at 600 nm during cyclic voltammetry scanning from 2 V to −1 V to 2 V of a 25 cm² dynamic window with an ITO on glass working electrode and a Zn metal frame as the counter and reference electrodes with a 0.5 M Zn acetate gel electrolyte. The scan rate was (a) 5 mV/s or (b) 50 mV/s. The corresponding CVs are shown in FIG. S5. (c) Schematic of the working electrode during the deposition (left) and dissolution (right) portions of the CV at the two scan rates.

FIG. 7 shows (a) Cyclic voltammogram at a scan rate of 5 mV/s of a 25 cm² dynamic window with an ITO on glass working electrode and a Zn metal frame as the counter and reference electrodes with a 0.5 M Zn acetate gel electrolyte and (b) Percentage of ZnO (black), Zn (red), and Zn(OH)₂ (blue) on the working electrode as determined by XRD analysis after performing voltammetry at 5 mV/s from (I) 2 V to −0.46 V, (II) 2 V to −1 V, (III) 2 V to −1 V to 0.5 V, and (IV) 2 V to −1 V to 1.45 V.

FIG. 8 shows cyclic voltammograms at a scan rate of 25 mV s⁻¹ of Pt-modified ITO working electrodes in electrolytes containing 0.5 M ZnCl₂ and 0.5 M NaCH₃COO (sodium acetate, panel A, black line), NaCClH₂COO (sodium chloroacetate, ClAc, panel A, red line), NaCCl₃COO (sodium trichloroacetate, Cl₃Ac, panel a, blue line), NaFCH₂COO (sodium fluoroacetate, panel B, black line), or NaClF₂COO (sodium chlorodifluoroacetate, panel B, red line).

FIG. 9 shows coulombic efficiency and optical reversibility for Zn electrolytes containing different acetates (A) along with the transmission at 600 nm of the working electrode during the second cycle of CVs in these electrolytes (B). The corresponding CVs are displayed in FIG. 8.

FIG. 10 shows cyclic voltammograms at a scan rate of 25 mV s of Pt-modified ITO working electrodes in electrolytes containing 0.5 M ZnCl₂ and 0.5 M sodium formate (black line), sodium propionate (red line), or sodium butyrate (blue line).

FIG. 11 shows coulombic efficiency and optical reversibility for Zn electrolytes containing different chain lengths of carboxylates (A) along with the transmission at 600 nm of the working electrode during the second cycle of CVs in these electrolytes (B). The corresponding CVs are displayed in FIG. 10.

FIG. 12 shows cyclic voltammograms (A) at a scan rate of 25 mV s⁻¹ of Pt-modified ITO working electrodes in electrolytes containing 0.5 M sodium formate and 0.5 M ZnCl₂ (black line), 0.5 M ZnBr₂ (red line), or 0.25 M ZnCl₂ and 0.25 M ZnBr₂ (blue line). Coulombic efficiencies (B) of the CVs of formate and acetate electrolytes with various halide compositions.

FIG. 13 shows transmission at 600 nm of the working electrode during Zn electrodeposition (A) and stripping (B) in electrolytes containing 0.5 M sodium acetate and 0.5 M ZnCl₂ (black line), or 0.5 M sodium formate and 0.5 M ZnCl₂ (red line), 0.5 M ZnBr₂ (blue line), or 0.25 M ZnCl₂ and 0.25 M ZnBr₂ (green line). To elicit Zn electrodeposition, chronoamperometry was conducted at −1.0 V until the transmission at 600 nm reached 1%. Next, Zn stripping was conducted at +2.5 V for 30 s.

FIG. 14 shows the scanning electron microscopy images of Zn electrodeposits obtained after a linear sweep voltammogram from 0 V to −1 V at 5 mV s⁻¹ in an electrolyte containing 0.5 M sodium formate and 0.5 M ZnCl₂ (A, B), 0.5 M ZnBr₂ (C, D), or 0.25 M ZnCl₂ and 0.25 M ZnBr₂ (E, F).

FIG. 15 shows the relative compositions of Zn and ZnO as determined by X-ray diffraction of Zn electrodeposits obtained using the conditions described in FIG. 14.

FIG. 16 shows cyclic voltammogram obtained using the ZnCl₂—ZnBr₂-formate electrolyte containing 0.5 M sodium formate, 0.25 M ZnCl₂, and 0.25 M ZnBr₂ (A, black line). The experiment was halted at −0.1 V (E_{final}) during the negative sweep of the second cycle. After obtaining this voltammogram, the same working electrode was used in an electrolyte containing only 0.5 M sodium formate (A, red line). Lastly, the same working electrode was used a second time in the ZnCl₂—ZnBr₂-formate electrolyte (A, blue line). For panel B, a fresh working electrode was also first cycled in the ZnCl₂—ZnBr₂-formate electrolyte. The experiment was halted at an E_{final}=0 V during the negative sweep of the second cycle. After obtaining this voltammogram, the same working electrode was used in an electrolyte containing only 0.5 M sodium formate (B, red line). Lastly, the same working electrode was used a second time in the ZnCl₂—ZnBr₂-formate electrolyte (B, blue line).

FIG. 17 shows transmission as a function of wavelength of a 25 cm² dynamic window based on reversible Zn electrodeposition after 0 s (black line), 7 s (red line), 15 s (blue line), 21 s (green line), and 30 s (purple line) of device darkening (A). Metal electrodeposition on the working electrode was elicited by applying −0.8 V for 30 s before +2.3 V was applied to induce metal stripping. The transmission at 600 nm during one cycle of switching is shown in panel B. The aqueous-based gel electrolyte used contained 0.5 M sodium formate, 0.25 M ZnCl₂, and 0.25 M ZnBr₂.

FIG. 18 shows minimum and maximum transmission values at 600 nm during cycling of a 3 cm² dynamic window based on Zn electrodeposition. The device was switched at −1 V for 5 s to induce metal electrodeposition and 1.5 V for 30 s to elicit metal stripping.

FIG. 19 shows the X-ray diffraction spectrum of ITO working electrode obtained after 250 switching cycles in a dynamic window.

FIG. 20 shows cyclic voltammograms (A) and corresponding transmission at 600 nm (B) at a scan rate of 50 mV s of Pt-modified ITO working electrodes in electrolytes containing 0.5 M ZnSO₄ (black line), 0.5 M Zn(NO₃)₂ (red line), or 0.5 M Zn(ClO₄)₂ (blue line).

FIG. 21 shows cyclic voltammograms (A) and corresponding transmission at 600 nm (B) at a scan rate of 50 mV s of Pt-modified ITO working electrodes in electrolytes containing 0.1 M ZnSO₄ (black line), 2.5 M ZnSO₄ (blue line), or containing 2.5 M sodium formate, 0.5 M ZnSO₄ (red line).

FIG. 22 shows cyclic voltammograms (A) and corresponding transmission at 600 nm (B) at a scan rate of 50 mV s of Pt-modified ITO working electrodes in electrolytes containing 0.5 M sodium formate and 0.25 M ZnSO₄ and 0.25 M ZnCl₂ (black line), 0.25 M ZnSO₄ and 0.25 M ZnBr₂ (red line), or 0.25 M ZnBr₂ and 0.25 M ZnCl₂ (blue line)

FIG. 23 shows cyclic voltammograms (A) and corresponding transmission at 600 nm (B) at a scan rate of 50 mV s of Pt-modified ITO working electrodes electrolytes containing 0.5 M ZnSO₄ (green line), 0.5 M sodium formate and 0.5 M ZnSO₄ (red line), 0.25 M ZnCl₂, and 0.25 M ZnSO₄ (blue line), or 0.5 M sodium formate, 0.25 M ZnSO₄, and 0.25 M ZnCl₂ (black line).

FIG. 24 shows coulombic efficiencies of the CVs of sulfate electrolytes with various compositions.

FIG. 25 shows the transmission at 600 nm of the working electrode during Zn electrodeposition (A) and stripping in electrolytes containing 0.5 M ZnSO₄ (green line), 0.5 M sodium formate and 0.5 M ZnSO₄ (red line), 0.25 M ZnCl₂ and 0.5 M ZnSO₄ (blue line), or 0.5 M sodium formate, 0.25 M ZnSO₄, and 0.25 M ZnCl₂ (black line). To elicit Zn electrodeposition, chronoamperometry was conducted at −1.0 V until the transmission at 600 nm reached 1%. Next, Zn stripping was conducted at +2.5 V for 30 s.

FIG. 26 shows scanning electron microscopy images of Zn electrodeposits obtained after a linear sweep voltammogram from 0 V to −1 V at 5 mV s⁻¹ in electrolytes containing 0.5 M ZnSO₄(A), 0.5 M sodium formate and 0.5 M ZnSO₄ (B), 0.25 M ZnSO₄ and 0.25 M ZnCl₂ (C) and 0.5 M sodium formate, 0.25 M ZnSO₄ and 0.25 M ZnCl₂.

FIG. 27 shows an X-ray diffraction spectrum of ITO working electrode obtained after at various points of cycling.

FIG. 28 shows four consecutive cyclic voltammograms at a scan rate of 25 mV/s (A) and corresponding transmission at 600 nm of an fluorine-doped tin oxide (FTO) on glass working electrolyte in a pH=5 electrolyte containing 0.25 M ZnBr₂, 0.25 M ZnCl₂, 0.5 M sodium formate, and 2 wt. % hydroxyethylcellulose.

FIG. 29 shows cyclic voltammetry at a scan rate of 25 mV s (A) and corresponding transmission at 500 nm (B) of an ITO on glass working electrode in an electrolyte containing 5 mM Cu(ClO₄)₂, 5 mM BiOClO₄, 10 mM HClO₄, and 1 M LiClO₄.

FIG. 30 shows cyclic voltammetry at a scan rate of 25 mV s (A) and corresponding transmission at 500 nm (B) of an ITO on glass working electrode in an electrolyte containing 5 mM Cu(ClO₄)₂, 5 mM BiOClO₄, 10 mM HClO₄, 1 M LiClO₄, and 100 mM ED3A.

FIG. 31 shows cyclic voltammetry at a scan rate of 25 mV s (A) and corresponding transmission at 500 nm (B) of an ITO on glass working electrode in an electrolyte containing 5 mM Cu(ClO₄)₂, 5 mM BiOClO₄, 10 mM HClO₄, 1 M LiClO₄, and various concentrations of ED3A: 5 mM (black line), 10 mM (red line), 25 mM (blue line), 50 mM (green line), 75 mM (purple line), and 100 mM (yellow line).

FIG. 32 shows cyclic voltammetry at a scan rate of 25 mV s⁻¹ (A) and corresponding transmission at 500 nm (B) of an ITO on glass working electrode in an electrolyte containing 5 mM Cu(ClO₄)₂, 5 mM BiOClO₄, 10 mM HClO₄, 1 M LiClO₄, 100 mM ED3A, and 1% wt PVA.

FIG. 33 shows cyclic voltammetry at a scan rate of 25 mV s⁻¹ (A) and corresponding transmission at 500 nm (B) of a Pt-ITO on glass working electrode in an electrolyte containing 18.5 mM Cu(ClO₄)₂, 18.5 mM BiOClO₄, 10 mM HClO₄, 1 M LiClO₄, 100 mM ED3A, and 1% wt PVA.

FIG. 34 shows cyclic voltammetry at a scan rate of 25 mV s⁻¹ (A) and corresponding transmission at 500 nm (B) of a Pt-ITO on glass working electrode in an electrolyte containing 18.5 mM Cu(ClO₄)₂, 18.5 mM BiOClO₄, 10 mM HClO₄, 1 M LiClO₄, 100 mM ED3A, and various concentrations of PVA: 0.1% wt (black line), 1% wt (red line), 5% wt (blue line), and 10% wt (pink line).

FIG. 35 shows cyclic voltammetry at a scan rate of 25 mV s (A) and corresponding transmission at 500 nm (B) of a Pt-ITO on glass working electrode in an electrolyte containing 18.5 mM Cu(ClO₄)₂, 18.5 mM BiOClO₄, 10 mM HClO₄, 1 M LiClO₄, 100 mM ED3A, and 1% wt PVA at pH 7 (black line) and pH 9 (red line).

FIG. 36 shows cyclic voltammetry at a scan rate of 25 mV s⁻¹ (A) and corresponding transmission at 500 nm (B) of a Pt-FTO on glass working electrode in an electrolyte containing 18.5 mM Cu(ClO₄)₂, 18.5 mM BiOClO₄, 10 mM HClO₄, 1 M LiClO₄, 100 mM ED3A, and 1% wt PVA at pH 7 (black line) and pH 9 (red line).

FIG. 37 shows cyclic voltammetry at a scan rate of 25 mV s⁻¹ (A) and corresponding transmission at 500 nm (B) of a Pt-ITO on glass working electrode in an electrolyte containing 18.5 mM Cu(ClO₄)₂, 18.5 mM BiOClO₄, 10 mM HClO₄, 1 M LiClO₄, 100 mM ED3A, 1% wt PVA and various concentrations of Cu(ClO₄)₂: 10 mM (black line), 14 mM (red line), and 18.5 mM (blue line).

FIG. 38 shows cyclic voltammetry at a scan rate of 25 mV s⁻¹ (A) and corresponding transmission at 500 nm (B) of a Pt-ITO on glass working electrode in an electrolyte containing 18.5 mM Cu(ClO₄)₂, 18.5 mM BiOClO₄, 10 mM HClO₄, 100 mM ED3A, and 1% wt PVA, and various concentrations of LiClO₄: 0.5 M (black line), 1 M (red line), and 1.5 M (blue line).

FIG. 39 shows cyclic voltammetry at a scan rate of 25 mV s⁻¹ (A) and corresponding transmission at 500 nm (B) of a Pt-ITO on glass working electrode in an electrolyte containing 18.5 mM Cu(ClO₄)₂, 18.5 mM BiOClO₄, 1 M LiClO₄, 100 mM ED3A, and 1% wt PVA, and various concentrations of HClO₄: 10 mM (black line), 15 mM (red line), 20 mM (blue line).

FIG. 40 shows cyclic voltammetry at a scan rate of 25 mV s⁻¹ of a Pt-ITO on glass working electrode in an electrolyte containing 10 mM HClO₄, 1 M LiClO₄ and 100 mM ED3A at pH 1.9 (black line), 5.3 (red line), 7.6 (blue line), 9.1 (pink line), and 11.7 (green line).

FIG. 41 shows cyclic voltammetry at a scan rate of 25 mV s (of a Pt-ITO on glass working electrode in an electrolyte containing 10 mM HClO₄, 1 M LiClO₄, 100 mM ED3A, and 1% wt PVA at pH 1.6 (black line), 5.7 (red line), 7.8 (blue line), 9.8 (pink line), and 11.7 (green line).

FIG. 42 is a table showing sheet resistance measurements of Pt-ITO and Pt-FTO soaked in electrolyte at 85 C after 1 week.

FIG. 43 is a table showing sheet resistance measurements of Pt-ITO and Pt-FTO soaked in electrolyte at 85 C after 1 month.

FIG. 44 shows cyclic voltammetry at a scan rate of 25 mV s⁻¹ (A) and corresponding transmission at 500 nm (B) of an ITO on glass working electrode in an electrolyte containing 60 mM BiCl₃ and 60 mM ED3A-OH adjusted to pH 7 with NaOH.

FIG. 45 shows cyclic voltammetry at a scan rate of 25 mV s⁻¹ (A) and corresponding transmission at 500 nm (B) of an ITO on glass working electrode in an electrolyte containing 60 mM BiCl₃ and 60 mM EDDA adjusted to pH 7 with NaOH.

FIG. 46 shows cyclic voltammetry at a scan rate of 25 mV s (A) and corresponding transmission at 500 nm (B) of an ITO on glass working electrode in an electrolyte containing 60 mM BiCl₃, 150 mM EDDA, and 5 mM CuCl₂ adjusted to pH 7 with NaOH.

FIG. 47 shows cyclic voltammetry at a scan rate of 25 mV s (A) and corresponding transmission at 500 nm (B) of an ITO on glass working electrode in an electrolyte containing 60 mM BiCl₃, 150 mM EDDA, and 100 M LiBr adjusted to pH 7 with NaOH.

FIG. 48 shows cyclic voltammetry at a scan rate of 25 mV s⁻¹ (A) and corresponding transmission at 500 nm (B) of an ITO on glass working electrode in an electrolyte containing 60 mM Bi(NO₃)₃, 300 mM EDDA, and 5 mM KCl adjusted to pH 7 with NaOH.

FIG. 49 shows cyclic voltammetry at a scan rate of 25 mV s (A) and corresponding transmission at 500 nm (B) of an ITO on glass working electrode in an electrolyte containing 100 mM Bi(NO₃)₃, 25 mM CuCl₂, 75 mM diethylenetriaminepentaacetic acid, and 1 M NaI adjusted to pH 9 with NaOH.

FIG. 50 shows transmission of a two-electrode dynamic window during eleven consecutive switching cycles using an electrolyte containing 100 mM Bi(NO₃)₃, 25 mM CuCl₂, 75 mM diethylenetriaminepentaacetic acid, and 1 M NaI adjusted to pH 9 with NaOH. The window was tinted at −0.8 V following by clearing at +0.9 V. The transmission profile in panel A was collected immediately after window construction, while the transmission profile in panel B was collected 1 week after window construction. The consistency between the two transmission profiles indicates that the window has a stable shelf life using this alkaline electrolyte.

FIG. 51 shows cyclic voltammetry at a scan rate of 25 mV s⁻¹ (A) and corresponding transmission at 600 nm (B) of an ITO on glass working electrode in an electrolyte containing 10 mM BiOClO₄, 10 mM Cu(ClO₄)₂, 1 M LiClO₄, and 20 mM 2-[bis(2-hydroxyethyl)amino]-2-(hydroxymethyl)propane-1,3-diol adjusted to pH 7 with NaOH.

FIG. 52 shows cyclic voltammetry at a scan rate of 50 mV s⁻¹ (A) and corresponding transmission at 600 nm (B) of an ITO on glass working electrode in electrolytes containing 50 mM zinc acetate and 5 M sodium acetate adjusted to pH 8 using NaOH. The electrolytes also contain 5 mM EDDA (black line), 5 mM ED3A-OH (blue line), or 50 mM ED3A-OH (red line).

FIG. 53 shows cyclic voltammetry at a scan rate of 50 mV s⁻¹ (A) and corresponding transmission at 600 nm (B) of an ITO on glass working electrode in electrolytes containing 50 mM zinc acetate, 5 M sodium acetate, and 1 mM copper(II) acetate adjusted to pH 8 using NaOH. The electrolytes also contain 5 mM EDDA (black line) or 5 mM ED3A-OH (red line).

FIG. S1 shows La*b*C* values along with the best RGB color representations of the transmission of a 25 cm² dynamic window with an ITO on glass working electrode, a Zn mesh counter electrode, and a Zn acetate gel electrode during window darkening. For a more detailed explanation of the meaning and calculations of these values, please see DeFoor et al., ACS Appl. Electron. Mater. 2020, 2, 290.

FIG. S2 shows SEM image (a) and corresponding EDX spectrum (b) of an ITO working electrode after the application of −1V in a dynamic window. Peaks for In (indium) are due to the presence of ITO.

FIG. S3 shows the transmission of a 25 cm² dynamic window with an ITO on glass working electrode, a Cu counter electrode, and an acidic Bi—Cu gel electrolyte during switching. The device was switched immediately after construction (week 0) and one week later (week 1). The window was darkened at −0.6 V for 60 s and lightened at +0.8 V for 120 s.

FIG. S4 shows (a) Contrast ratio at 600 nm of a 25 cm² dynamic window with an ITO on glass working electrode, a Zn counter electrode, and a Zn acetate gel electrolyte during cycling over the course of 250 cycles. (b) XRD spectrum of the ITO working electrode after 250 cycles showing the accumulation of ZnO and Zn(OH)₂.

FIG. S5 shows cyclic voltammograms at a scan rate of 5 mV/s (black) and 50 mV/s (red) of a 25 cm² dynamic window with an ITO on glass working electrode and a Zn metal frame as the counter and reference electrodes with a 0.5 M Zn acetate gel electrolyte.

FIG. S6 shows a compositional analysis obtained from XRD measurements of dynamic windows with an ITO on glass working electrode and a Zn frame as the counter and reference electrodes with a 0.5 M Zn acetate gel electrolyte. XRD data were obtained after performing LSVs at 5 mV/s or 50 mV/s from 2 V to −1 V.

FIG. S7 shows a XRD spectrum of the working electrode of a dynamic window with an ITO on glass working electrode, a Zn metal counter/reference electrode, and 0.5 M Zn acetate gel electrolyte after linear sweep voltammetry at 25 mV/s from 2 V to −1 V (a). The electrolytes were bubbled with O₂ (red line) or Ar (green line) for 1 hr before performing the voltammetry. Compositional analysis from the XRD spectra is shown in (b).

FIG. S8 shows XRD spectra of a dynamic window with an ITO on glass working electrode, a Zn metal counter/reference electrode, and a 0.5 M Zn acetate gel electrolyte after voltammetry at 5 mV/s from (a) 2 V to −0.46 V (b) 2 V to −1 V (c) 2 V to −1 V to 0.5 V (d) 2 V to −1 V to 1.45 V.

FIG. S9 shows (a) XRD spectrum of the working electrode of a dynamic window with an ITO on glass working electrode, a Zn metal counter/reference electrode, and a 0.5 M Zn acetate gel electrolyte after chronoamperometry at −1 V for 15 s and (b) Percentage of Zn, ZnO, and Zn(OH)₂ during of the electrodeposits as determined from the XRD spectrum.

FIG. S10 shows cyclic voltammogram at a scan rate of 25 mV s⁻¹ of Pt-modified ITO working electrodes in electrolytes containing 0.5 M sodium acetate and 0.5 M ZnBr₂ (black line) or 0.25 M ZnCl₂ and 0.25 M ZnBr₂.

FIG. S11 shows cyclic voltammogram at a scan rate of 25 mV s of a Pt-modified ITO working electrode in an electrolyte containing 0.5 M ZnI₂ and 0.5 M sodium acetate.

FIG. S12 shows transmission at 600 nm of the working electrode during the second cycle of CVs in an electrolyte containing 0.5 M sodium acetate and 0.5 M ZnI₂ (black line) or ZnBr₂ (red line). The corresponding CVs are displayed in FIGS. S10 and S11.

FIG. S13 shows chronoamperometry during Zn electrodeposition and stripping in electrolytes containing 0.5 M sodium acetate and 0.5 M ZnCl₂ (black line), or 0.5 M sodium formate and 0.5 M ZnCl₂ (red line), 0.5 M ZnBr₂ (blue line), or 0.25 M ZnCl₂ and 0.25 M ZnBr₂ (green line). To elicit Zn electrodeposition, chronoamperometry was conducted at −1.0 V until the transmission at 600 nm reached 1%. Next, Zn stripping was conducted at +2.5 V.

FIG. S14 shows representative X-ray diffraction spectra of Zn electrodeposits obtained after a linear sweep voltammogram from 0 V to −1 V at 5 mV s⁻¹ in an electrolyte containing 0.5 M sodium formate and 0.5 M ZnCl₂ (A), 0.5 M ZnBr₂ (B), or 0.25 M ZnCl₂ and 0.25 M ZnBr₂ (C).

FIG. S15 shows chronoamperometry during switching of 25 cm² dynamic window based on reversible Zn electrodeposition. Metal electrodeposition on the working electrode was elicited by applying −0.8 V for 30 s before +2.3 V was applied to induce metal stripping.

### DETAILED DESCRIPTION OF THE INVENTION

It is noted that, as used in this specification and the appended claims, the singular forms “a,” “an,” and “the,” include plural referents unless expressly and unequivocally limited to one referent. Thus, for example, reference to “a compound” can include two or more different compounds depending on the context of the use of the term. As used herein, the term “include” and its grammatical variants are intended to be non-limiting, such that recitation of items in a list is not to the exclusion of other like items that can be substituted or other items that can be added to the listed items. The term “about” is used to describe a number such as a pH value, amount or concentration, etc. which, within context may be up to 5-10% outside the specific number range enumerated.

The term “effective” is used to describe an amount of a component, an element, an energy source, a reactant, precursor or product which is used in or produced by the present invention to produce an intended result.

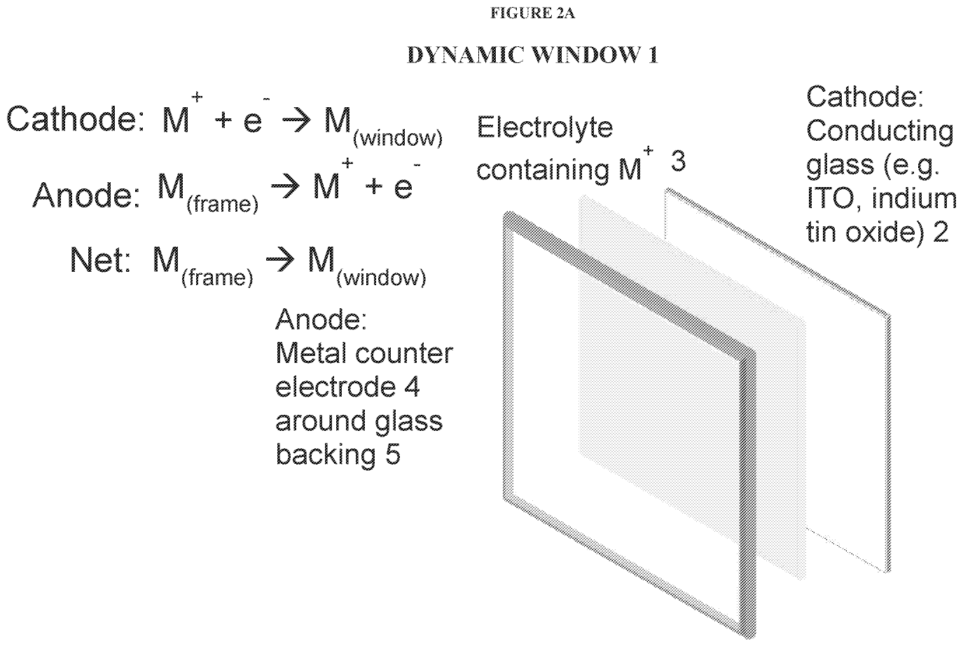

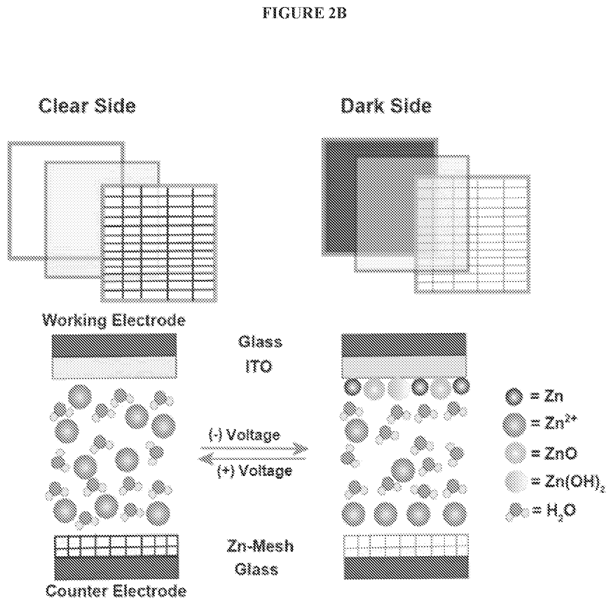

The present invention is directed to a dynamic glass element or window 1 represented by FIG. 2A which comprises a transparent conducting working electrode 2 and a counter electrode 4 immersed in an electrolyte solution or gel 3 (composition) which is enclosed in a frame or border 4, which also serves as the counter electrode, and which can be enclosed with a glass backing 5. The counter electrode may also be fashioned as an electrode mesh as depicted in FIG. 2B (as meshed square in each of top 2 three-square presentations). In the present invention, the electrolyte solution or gel comprises a salt selected from the group consisting of a zinc salt, a bismuth salt, a copper salt or a combination of a bismuth salt and copper salt at a pH ranging from about 3-11, often 4-8. In embodiments, the electrolyte solution may be bordered by plastic or synthetic rubber to maintain the electrolyte solution or gel in place. In embodiments, the zinc salt is included in the electrolyte solution at a concentration of 0.01M to 5.0M, preferably 0.5M to 5.0M. In embodiments, the bismuth salt, the copper salt or the combination of the bismuth salt and copper salt are each included in the electrolyte solution at a molar concentration ranging from 5 to 25 mM, often 10-20 mM. In embodiments, the electrolyte solution comprising the zinc salt, the bismuth salt and/or the copper salt optionally includes a chelating agent at a molar concentration ranging from 0.1 mM to 150-200 mM (up to 5.0M in the case of a zinc salt) of the electrolyte solution. In embodiments, the electrolyte solution which comprises the zinc salt, which is often soluble in the electrolyte solution, often excludes a chelating agent. In embodiments, the electrolyte solution comprising the bismuth salt and/or the copper salt includes a chelating agent. Alternatively, the electrolyte solution comprising the bismuth and/or copper salts are presented as a bismuth or copper chelate at a molar concentration ranging from 5 to 25 mM. In such instances, a separate chelating agent is often excluded from the electrolyte solution. In embodiments, the zinc salt may be presented as a zinc chelate, often at a concentration ranging from 0.1M to 5.0M. In embodiments, the electrolyte solution further comprises a gelling agent in order to gel the electrolyte solution and provide structural integrity to the dynamic window. In embodiments, a leveling agent such as polyvinyl alcohol (PVA), thiourea, cetyltrimethyl ammonium bromide, sodium dodecyl sulfate or chloride ions are included in the electrolyte solution in order to enhance deposit of metal onto the working conducting electrode (cathode). In embodiments, the electrolyte solution or gel can transition 100 cm² two-electrode devices from clear (80% transmission at 600 nm) to highly opaque (<0.1% transmission at 600 nm) in less than one minute, often less than 20 seconds.

FIG. 2A shows the electrodeposition reaction at the cathode at a negative (−) voltage wherein a metal cation (M+) is reduced and deposited onto surface of the working conducting electrode (cathode) as the metal is deposited. Note that the principal reaction in deposition of the cathode is to form the metal, but oxidized species (in the FIGURE, zinc species ZnO and Zn(OH)₂ are also deposited in minor amounts on the cathode surface as depicted in FIG. 2B in the right bottom presentation. When the voltage is switched to positive (+) voltage, the electrodeposition reaction is reversed and the metal species and oxidized species on the surface of the cathode are converted to metal cations (M+) and transferred to the electrolyte solution.

The term “compound” is used to describe any molecular species which is used in the present invention and includes metal salts, metal chelates, chelating agents, gelling agents, leveling agents and related molecular components used in the present invention.

“Electrolyte compositions” are solutions often in a gelled state which comprise water, metal salts (metal cations), anions associated with the metal cations and optional or alternative compounds such as chelating agents, metal chelates, gelling agents, leveling agents and ions (cations) which enhance the ionic conductivity of the electrolyte composition. Electrolyte solutions according to the present invention range in pH from 3 to 11, often 4 to 8, depending upon the metal and/or metal species which are deposited onto the cathode (working conducting electrode) and switched to remove from the cathode.

Zinc salts (also referred to as Zn²⁺ salts or alternatively as Zn²⁺ cations) which are used in the present invention include any zinc salt which is water soluble with the pH range of 3-11, often 4-8 and include the following or mixtures thereof: zinc chloride, zinc bromide, zinc iodide, zinc acetate, zinc formate, zinc halocarboxylates (zinc trifluoroacetate, trichloroacetate, chloroacetate), zinc propionate, zinc butyrate, zinc pentanoate, zinc hexanoate, zinc sulfate, zinc perchlorate, zinc tetrafluoroborate, zinc trifluoromethanesulfonate, zinc methanesulfonate, zinc di bis(trifluoromethylsulfonyl)imide (zinc TFSI), zinc hexafluorophosphate, zinc carborane, zinc nitrate, zinc chlorate, zinc perbromate, zinc bromate and zinc phosphate. Zinc salts which are often used in electrolyte solutions of the present invention include zinc bromide, zinc sulfate, zinc perchlorate, zinc chloride or mixtures thereof. Zinc chloride or zinc chloride and another zinc salt as a mixture are preferred. These zinc salts may be used in the present invention without the addition of a chelating agent or as a metal chelate, which represent optional embodiments. Although most of the Zn salts by themselves will not be neutral due to slight Lewis acidity of Zn (pH usually about 5), solutions could be readily pH adjusted within the range of 3-11, often 4-8.

Bismuth salts (also referred to as Bismuth³⁺ salts or Bi³⁺ cations) which are used in the present invention may include the following salts or mixtures thereof: bismuth chloride, bismuth bromide, bismuth iodide, bismuthyl perchlorate, bismuthyl nitrate, bismuthyl sulfate, bismuth sulfate, bismuth acetate, bismuth nitrate, bismuth trifluoroacetate, bismuth trifluoromethanesulfonate, bismuth methanesulfonate, bismuth TFSI, and bismuthyl carbonate (which will react with free acid to form CO2 and give e.g. a Bi-chelator). Bismuth salts which are often used include bismuth chloride, bismuth bromide, bismuth sulfate, bismuthyl perchlorate and mixtures thereof. Most often used is bismuth perchlorate or a mixture of bismuthyl perchlorate and another bismuth salt. These salts are used in the present invention with an effective amount of a chelating agent as disclosed herein or alternatively, as Bi³⁺ metal chelates as described herein. Electrolytes of these salts and additional components may be pH adjusted.

Copper salts (also referred to as copper(II), Cu²⁺ salts or Cu²⁺ cations) which are used in the present invention may include the following salts or mixtures thereof: copper(II) chloride, copper(II) bromide, copper(II) iodide, copper(II) phosphate, copper(II) sulfate, copper(II) acetate, copper(II) nitrate, copper(II) trifluoroacetate, copper(II) trifluoromethanesulfonate, copper(II) methanesulfonate, copper(II) TFSI and copper (II) carbonate:copper(II) chloride, copper(II) perchlorate. More often used are copper(II) sulfate, copper(II) bromide or a mixture thereof. Most often used are copper(II) chloride, copper(II) perchlorate or mixtures thereof. These salts are used in the present invention with an effective amount of a chelating agent as disclosed herein or alternatively, as Cu²⁺ metal chelates as described herein. Electrolytes of these salts and additional components may be pH adjusted.

The present invention is exemplified by the following examples.

### Zinc Electrodeposition Examples (References Listed Below as First Set)

### Overview

Dynamic windows harnessing RME are electrochemical devices in which the working electrode is a transparent conductive electrode such as tin-doped indium oxide (ITO) and the counter electrode is a metal frame or mesh. In between the two electrodes, RME devices contain a solution of transparent metal ions in a liquid or gel electrolyte. By applying a negative potential with respect to the working electrode, the metal ions in the electrolyte are reduced to elemental metal on the working electrode, which transforms the device from clear to dark. At the same, metal is oxidized on the counter electrode to form metal ions and charge balance the device. To switch the device from dark to clear, a positive potential is applied to the working electrode to induce the opposite reactions.

Most previous RME dynamic windows operate via the electrodeposition of a mixture of Bi and Cu.^{[8, 30, 31]} Although these devices exhibit fast switching speeds and excellent color neutrality, one disadvantage is the limited solubility of Bi ions in aqueous electrolytes due to the formation of insoluble Bi(OH)₃. As a result, Bi—Cu electrolytes are typically acidic such that the Bi(OH)₃ is solubilized. The acid in these electrolytes, however, slowly etches the transparent conducting electrodes and as a result, the devices switch increasingly slowly over time even in the absence of continual cycling. In other words, devices with acidic electrolytes possess poor resting stability, which is one of the biggest challenges hampering the durability of RME dynamic windows.^{[32]}

Most aqueous RME electrolytes contain metal ions with positive standard reduction potentials vs. NHE such as Bi³⁺, Cu²⁺, and Ag⁺. Due to their positive reduction potentials, these metal ions can be thermodynamically electrodeposited before H₂ is evolved from H₂O. In contrast, the standard reduction potential of Zn²⁺/Zn is −0.76 V vs. NHE.^{[33]} From a thermodynamic standpoint, this negative reduction potential means that H₂ generation will occur before Zn electrodeposition.^{[34]} However, neutral pH electrolytes and Zn metal's sluggish ability to evolve H₂ can kinetically impede this unwanted side reaction.^{[14, 35, 36]} Furthermore, ZnO, which also can form during electrodeposition, prevents H₂ production.^{[37]} The Zn aqueous battery literature shows that organic acids or surfactants in the electrolyte can adsorb on electrodes and further increase the overpotential for H₂ generation.^{[38, 39]}

In this work, the inventors developed dynamic windows based on reversible Zn electrodeposition with a pH neutral gel electrolyte. As a result of the neutral pH, the dynamic window functions for at least four weeks without any significant degradation, far exceeding the resting stability of previous RME devices using acidic electrolytes. Furthermore, 100 cm² dynamic window switch with a ˜80% contrast ratio within less than 20 s.

FIG. 2B shows the device architecture of Zn-based dynamic windows in which tin-doped indium oxide (ITO) is used as the working electrode and a Zn mesh serves as the counter electrode. Alternatively, a Zn frame as depicted in FIG. 2A could be used. In between these two electrodes, there is a gel-modified aqueous electrolyte, which contains Zn²⁺ ions for reversible metal electrodeposition and K⁺ ions for increasing the ionic conductivity of the electrolyte. The application of −1 V with respect to the working electrode switches the dynamic window from clear to dark. At a negative potential, Zn²⁺ ions are reduced to metallic Zn and electrodeposited on the ITO surface. At the same time, to counter this reaction, Zn metal from the counter electrode is oxidized to Zn²⁺. Upon flipping the polarity of the potential, the opposite reactions occur, and the dynamic window switches back to its original clear state.

### Zn Deposition Mechanism:

$${Zn}^{2 +} + 2 {e}^{-} \to Zn \qquad ( 1 )$$

$$2 Zn + {O}_{2} \to 2 ZnO \qquad ( 2 )$$

$$ZnO + {H}_{2} O + 2 {e}^{-} \to Zn + 2 {OH}^{-} \qquad ( 3 )$$

$$ZnO + {H}_{2} O \to {Zn ( OH )}_{2} \qquad ( 4 )$$

$${Zn ( OH )}_{2} + 2 {e}^{-} \to Zn + 2 {OH}^{-} \qquad ( 5 )$$

### Stripping Mechanism:

$$Zn \to Z {n}^{2 +} + 2 {e}^{-} ( Fast stripping ) \qquad ( 6 )$$

$$ZnO + {H}_{2} O + 2 {CH}_{3} {COO}^{-} \to Z {n ( C {H}_{3} COO )}_{2} + 2 {OH}^{-} ( Slow stripping ) \qquad ( 7 )$$

$$Zn {( OH )}_{2} + 2 {CH}_{3} {COO}^{-} \to Z {n ( C {H}_{3} COO )}_{2} + 2 {OH}^{-} ( Very slow stripping ) \qquad ( 8 )$$

Equation (1) represents Zn electrodeposition on the ITO surface during the application of a reductive potential at the working electrode. However, the presence of dissolved O₂ in the aqueous electrolyte can react with the electrodeposited Zn to form ZnO (Equation 2). In a subsequent step, ZnO can be electrochemically reduced to Zn (Equation 3) or be chemically converted to Zn(OH)₂ (Equation 4). Zn(OH)₂ can also be electrochemically reduced to Zn (Equation 5). It is known that the conversion of ZnO and Zn(OH)₂ to Zn is kinetically sluggish (Equations 3 and 5).^{[40, 41]}

When stripping (Zn cathode electrodeposition reversal) occurs at the working electrode to turn the device clear, Zn metal is oxidized to soluble Zn²⁺ ions in a kinetically fast reaction (Equation 6). For ZnO and Zn(OH)₂ to be removed from the electrode, they must chemically react with acetate in the electrolyte to form soluble Zn(CH₃COO)₂ (Equations 7 and 8). The kinetics of dissolving the ZnO and Zn(OH)₂ deposits depend upon their solubilities and their acidities (pKₐ values) because they react with a base, CH₃COO⁻. While the pKₐ values of ZnO and Zn(OH)₂ are similar,^{[42]} the solubility of ZnO in water (20 μM) is significantly higher than that of Zn(OH)₂ (1 μM).^{[43, 44]} For this reason, the thought is that ZnO dissolution is kinetically more favorable than Zn(OH)₂ dissolution. Evidence supporting this expectation is presented later in the manuscript.

### Cycle Life and Durability

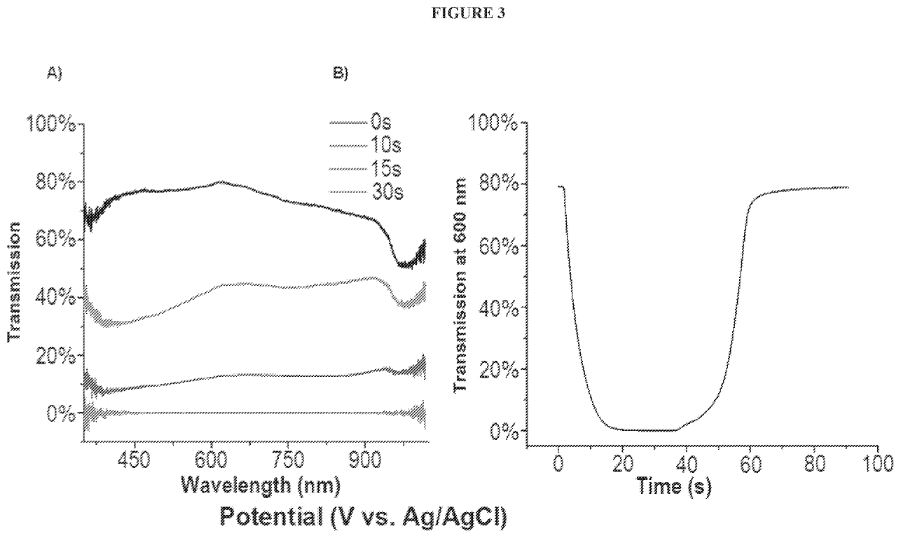

Using the architecture and Zn chemistry described above, the inventors constructed 25 cm² dynamic windows (FIG. 3), which possesses 70%-78% transmission from 450 nm to 900 nm in their clear state. Upon application of −1 V for 30 s, the dynamic window transitions from its clear state to an opaque state. In its dark state, the dynamic window exhibits less than 0.1% transmission from 400 nm to 1000 nm (FIG. 3a), resulting in an extremely dark appearance. This low transmission is important for dynamic window applications requiring privacy such as in residential settings. Moreover, the spectrum of the dynamic window over the visible and near-IR regions is relatively flat after 10 s and 15 s of electrodeposition and extremely flat at 30 s of electrodeposition, which is reflective of a color neutral appearance throughout switching. The calculated color neutrality values (c*) of the transmission spectra are 9, 9, and 3 after 10 s, 15 s, and 30 s, respectively (FIG. S1), in which values less than 10 are considered color neutral for most purposes.^{[45]}

FIG. 3b shows the transmission of the dynamic window at 600 nm versus electrodeposition time. By applying −1 V for 30 s, the dynamic window transitions from 78% to less than 0.10% transmission after 20 s. This switching speed is the fastest reported for a metal-based dynamic window that has a dark state with less than 1% transmission.^{[8, 22, 23, 25, 28, 31]} To switch the window to its clear state, 1 V was applied, and the window returned mostly to its original transmission after 40 s.

To understand the origin of the extreme opacity of the device, the inventors conducted scanning electron microscopy (SEM) coupled with energy dispersive X-ray spectroscopy (EDX) of the working electrode after the window was switched to its dark state (FIGURE S2). The SEM image (FIG. S2a) shows that the Zn electrodeposits are ˜5 m in size and are densely packed, which results in the high opacity of the films. The EDX spectrum confirms the presence of Zn metal on the electrode along with In and O from ITO (FIGURE S2b).

The majority of previous dynamic windows based on metal electrodeposition utilize acidic electrolytes (pH<3) to improve metal ion solubility and reaction kinetics.^{[30, 31, 46, 47]} A major problem of these acidic systems is that they slowly etch ITO in conjunction with halides also present in the electrolyte. For this reason, the windows have poor shelf life, and they exhibit slower switching speeds in the weeks following initial device construction.^{[48]} Because the Zn acetate electrolyte used in this work is nearly neutral (pH=6.4), the inventors anticipated that the shelf life of the windows would be significantly improved.

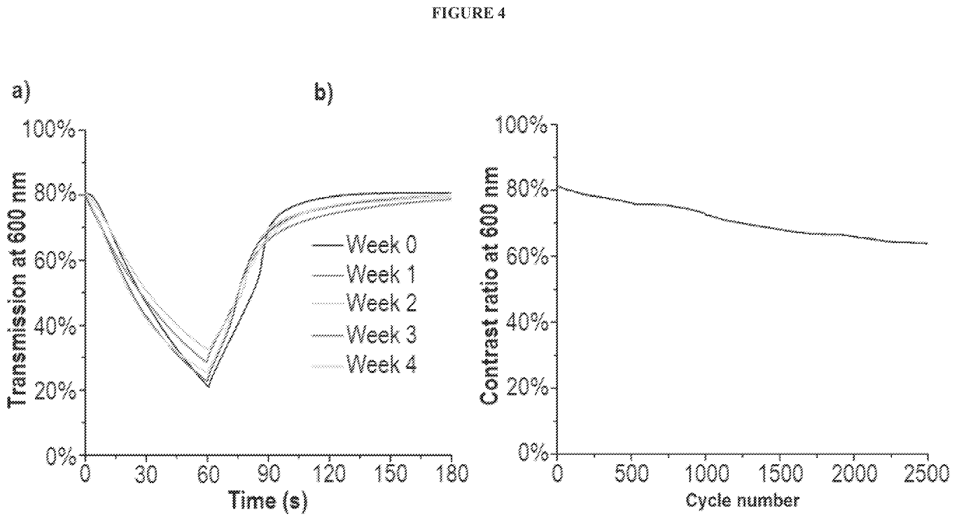

FIG. 4a shows the transmission at 600 nm of a 25 cm² Zn-based dynamic window while it switches over the course of four weeks. After applying −0.5 V for 60 s, the transmission of the dynamic window decreases to between 21%-34% each week. Although there are small variations in the minimum transmission reached each week, there is no clear trend, suggesting that the windows are not degrading over time in the Zn electrolyte. By contrast, a metal-based dynamic window using a standard acidic Bi—Cu electrolyte degrades substantially after one week (FIG. S3). We ascribe the improved durability of the Zn electrolyte to its nearly neutral pH, which prevents ITO etching that occurs in acidic electrolytes.

Although the Zn-based dynamic windows possess excellent optical reversibility and long-term durability, they exhibit poor cycleability when continuously cycled without rest. For example, the contrast ratio of a 25 cm² dynamic window decreases steadily over the course of 250 cycles when continuously switched (FIG. S4a). XRD data show that ZnO and Zn(OH)₂ accumulate on the ITO electrode after this continuous cycling (FIG. S4b). As described in section 2.1, ZnO and Zn(OH)₂ are chemically converted to soluble Zn²⁺ through kinetically slow reactions. As a result, ZnO and Zn(OH)₂ do not have time to fully dissolve into the electrolyte during continuous cycling, and thus they slowly accumulate on the ITO electrode, which decreases the transmission of the device in its clear state. A more detailed discussion of the chemical principles of these phenomena are described herein below.

To overcome this problem, the inventors explored the use of electrolyte additives to potentially slow down the formation of chemically sluggish ZnO and Zn(OH)₂. Bi and Pb are commonly used as electrolyte additives for enhancing Zn electrodeposition in aqueous battery applications.^{[49,50]} Because Bi and Pb have more positive reduction potentials than Zn, Bi and Pb electrodeposition occurs before Zn. The small amounts of Bi and Pb electrodeposits serve as nucleation sites for Zn electrodeposition that later occurs, and in this way, the amount of ZnO and Zn(OH)₂ formed is limited.

Due to its toxicity, Pb was not studied, and it was found that Bi salts are insoluble in the Zn electrolyte due to the formation of a Bi(OH)₃ precipitate. For this reason, Cu was used as an electrolyte additive because Cu also has a more positive reduction potential than Zn. We found that the addition of 1 mM of Cu(CH₃COO)₂ in the electrolytes suppresses the formation of ZnO and Zn(OH)₂ during window switching. With this Zn—Cu electrolyte, the devices can cycle 2,500 times (FIG. 4b). Even though the Cu additive greatly improve the cycle life of the dynamic windows, the contrast ratio still slowly degrades when continuously cycled 2,500 times. In later experiments, the inventors studied additional additives such as chelating ligands that aid in ZnO and Zn(OH)₂ dissolution and further improve device cycle life.

### 100 cm² Dynamic Window

To assess the scalability of Zn-based dynamic windows, the inventors constructed a 100 cm² device using an ITO working electrode, a Zn-coated stainless steel grid as the counter electrode, and the Zn only electrolyte. The Zn grid provides a uniform distribution of Zn²⁺ during switching across the large electrode area. In principle, a transparent Zn grid could be designed to increase device aesthetics. For a sufficiently transparent grid that does not give rise to unwanted diffraction patterns, the grid lines would have to possess a thickness of ˜10 m and an interline spacing of hundreds of microns.

Photographs (FIG. 5a-c) of the 100 cm² device during darkening show that the device switches relatively uniformly. Transmission data indicate that the window switches faster at its edge compared to its center (FIG. 5d). This result is expected because the current of the device is collected along its perimeter, and there is a voltage drop that is established across the ITO working electrode toward its center. In future work, we will explore the coupling of reversible Zn electrodeposition on the working electrode with an electrochromic intercalation-based counter electrode such as those based on hexacyanoferrates. The use of an electrochromic counter electrode enables both electrodes of the device to darken during switching, and thus the amount of current needed to achieve a given switching speed can be decreased. The decreased current requirement would result in a decreased voltage drop across the working electrode, thus increasing switching uniformity without sacrificing switching speed.

### Zn Electrolytes

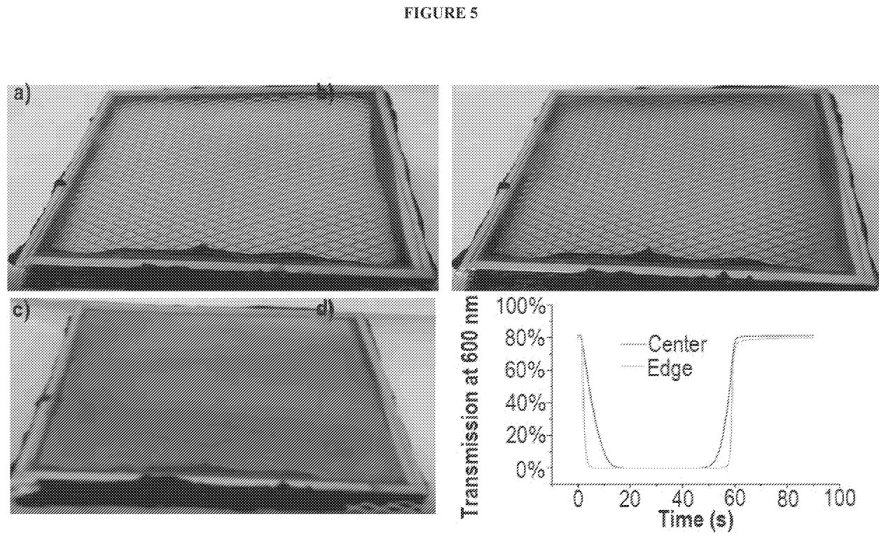

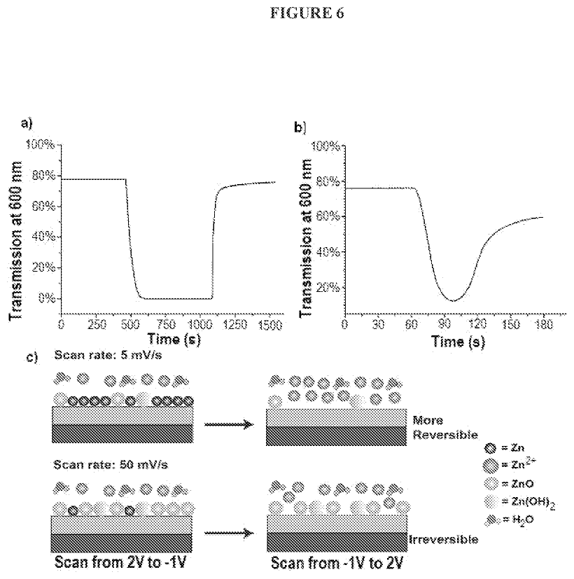

To understand how the Zn electrolyte supports reversible metal electrodeposition, we performed spectroelectrochemical studies of a 25 cm² dynamic window with an ITO working electrode and Zn metal frame counter/reference electrode. We conducted cyclic voltammetry (CV) from 2 V to −1 V at a slower scan rate of 5 mV/s and a faster scan rate of 50 mV/s (FIG. S5) with in situ optical measurements shown in FIGS. 6a and 6b, respectively. At 5 mV/s, the device initially possesses 78% transmission at 600 nm. The transmission decreases to less than 0.10% due to the electrodeposition of Zn on the ITO surface during the reductive scan from 2 V to −1 V. On the reverse scan, metallic Zn is oxidized to soluble Zn²⁺ at potentials above 0 V. As a result, the electrode transmission increases and returns to 76%, close to but below its original value. The electrode transmission is not fully reversible due to the formation of small amounts of ZnO and Zn(OH)₂ on the ITO surface (vide infra).

By comparison, with a scan rate of 50 mV/s, the transmission of the electrode decreases to only ˜10% during Zn electrodeposition because about 10 times less charge is passed during electrodeposition due to the faster scan rate. Interestingly, during the oxidative scan, the transmission only returns to 55%, which indicates that at this faster scan rate Zn electrodeposition is not reversible. It was hypothesize that at this faster scan rate, a greater proportion of ZnO and Zn(OH)₂ deposit on the electrode as compared to metallic Zn. At a slower scan rate, the greater amount of charge passed goes towards the electrochemical conversion of ZnO and Zn(OH)₂ to Zn (Equations 3 and 5). In other words, the amount of available O₂ dissolved in the electrolyte to form ZnO (Equation 2) and subsequently Zn(OH)₂ (Equation 4) is relatively small compared to the amount of Zn electrodeposited at the slower scan rate. As a result, at the slower scan rate, there is a larger amount of Zn as compared to ZnO and Zn(OH)₂, which enables the transmission of the electrode to be more reversible (FIG. 6c) because the electrochemical dissolution of metallic Zn (Equation 6) is much faster than the chemical dissolution of ZnO and Zn(OH)₂ (Equations 7 and 8).

To probe the relative amounts of Zn, ZnO, and Zn(OH)₂ on the ITO surface under different conditions, we performed XRD. After conducting linear sweep voltammetry (LSV) at 5 mV/s and 50 mV/s from 2 V to −1 V, we recorded the XRD spectra of these two samples and compared the integrated peak areas associated with Zn, ZnO, and Zn(OH)₂ to estimate the composition of the electrodeposits (FIG. S6). This analysis reveals that the percentage of metallic Zn in the electrodeposits at the slower scan rate is higher than those produced at the faster scan rate in accordance with the relative rates of Equations 1-5. Experiments analyzing the composition of electrodeposits produced in an Ar-sparged electrolyte versus an O₂-sparged electrolyte demonstrate that the percentage of Zn increases with the Ar-sparged electrolyte, which supports an electrodeposition mechanism that involves Equations 2 (FIG. S7).

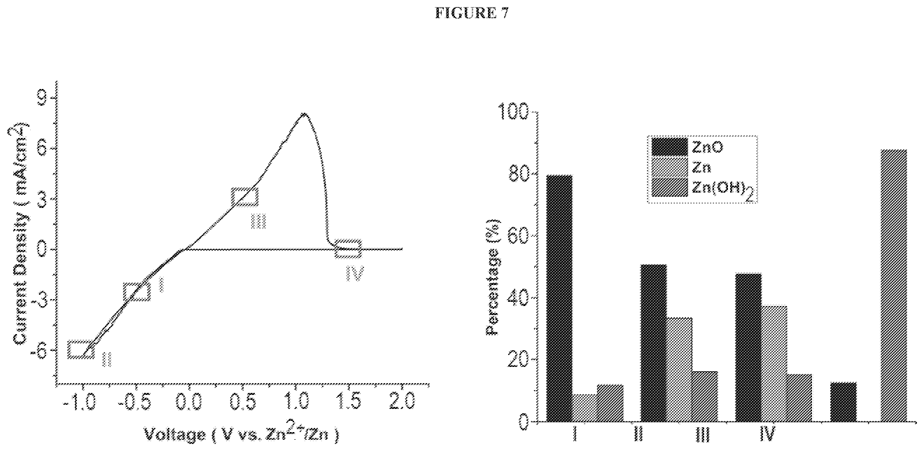

To understand further the dynamics of reversible Zn electrodeposition, we collected XRD spectra of the electrodeposits after halting a CV scan from 2 V to −1 V to 1 V at four different voltages (FIG. 7a) and determined the relative compositions of Zn, ZnO, and Zn(OH)₂ (FIGS. 7b and S8). At the early stages of electrodeposition (point I), the electrodeposits mostly consist of ZnO (80%). Because little charge has passed at this stage, there is a relatively large amount of O₂ available in the electrolyte. Most of the electrodeposited Zn thus reacts with this O₂ to form ZnO according to Equation 2. In contrast, during the latter stages of electrodeposition (point II), less O₂ is available in the electrolyte, and fresh Zn electrodeposits remain in their metallic state, and ZnO and Zn(OH)₂ are electrochemically converted back to Zn (Equations 3 and 5). As a result, the electrodeposits at point II contain less ZnO (50%) and more metallic Zn (33% vs. 9%). An additional experiment producing electrodeposits by holding the potential at −1 V instead of performing a CV yields an even higher metallic Zn content (52%, FIG. S9). This finding further demonstrates that the percentage of metallic Zn in the electrodeposits increases as more electrodeposition occurs.

At point III, the electrodeposits have undergone a small amount of electrochemical stripping, but their overall composition is similar to the values obtained at point II due to the small amount of stripping charge passed. At the end of stripping (point IV) though, the composition of the electrodeposits dramatically changes. At this stage, all of the metallic Zn has been removed from the electrode according to Equation 6 and only ZnO and Zn(OH)₂ remain. Because the transmission of the electrode has returned nearly to its original transparency at this stage (FIG. 6a), the total quantity of ZnO and Zn(OH)₂ left on the electrode is small. Some ZnO and Zn(OH)₂ electrodeposits are left on the electrode because both of these compounds can only be removed from the surface through slow chemical dissolution steps (Equations 7 and 8). Of the electrodepositions that remain, however, most are comprised of Zn(OH)₂ (FIG. 7b, rightmost bar). This finding confirms that the chemical dissolution of Zn(OH)₂ (Equation 8) is slower than that of ZnO (Equation 7). The chemical rationale for the difference in the rates of these two reactions is described in section 2.1. As discussed in section 2.2, it is the slow accumulation of Zn(OH)₂ on the electrode during cycling that explains why the maximum transmission of dynamic windows with a Zn only electrolyte decreases during hundreds of continuous cycles (FIG. S4).

### Conclusions

In conclusion, reversible Zn electrodeposition was studied on ITO electrodes and proposed mechanisms for the Zn deposition and dissolution processes. An understanding of reversible Zn electrodeposition dynamics allowed the inventors to construct dynamic windows with promising device metrics. In particular, a pH neutral electrolyte resulted in a device with excellent resting durability and high optical contrast. 100 cm² dynamic windows switch between clear (˜80% transmission at 600 nm) and dark (<0.1% transmission at 600 nm) states within 30 s. Additionally, the dynamic windows show promising cycleability when a Cu additive is included in the electrolyte. Taken together, these results demonstrate that reversible Zn electrodeposition is a promising alternative to current RME windows based on more noble metals.

### Zn Electrolytes Experimental Section

### General Procedure

ITO substrates were cleaned by sonicating with a 5% Extran solution for 5 minutes. After rinsing the substrates with water followed by isopropanol, the surfaces were sonicated in isopropanol for 5 minutes. The substrates were then rinsed with isopropanol and water and dried under a stream of air. The Zn acetate electrolyte was prepared using 0.5 M Zn(CH₃COO)₂ and 0.9 M KCl in aqueous medium, and the acidic Bi—Cu electrolyte consisted of 5 mM BiCl₃, 15 mM CuCl₂, 1 M LiCl, and 10 mM HCL.^{[15, 28]} After dissolving the solute, 2% of hydroxyethylcellulose (HEC) was added to the electrolyte, and the resulting suspension was stirred overnight to form a gel.

### Material Characterization

Electrochemical studies were conducted using a VSP-300 Biologic potentiostat. Optical measurements were carried out with an Ocean Optics FLAME-S_VIS-NIR spectrometer coupled to an Ocean Optics DH-mini UV-vis-NIR light source. A Sony Xperia X Series phone camera was used for photography of the dynamic windows. A JEOL JSM-6010LA microscope operating with an acceleration voltage of 10 kV was used to collect SEM-EDX images. XRD measurements were conducted using a Bruker D2 X-ray diffractometer. All samples for XRD spectra were fabricated using a 3 cm² ITO on glass working electrode. For XRD spectra, peak assignments were used following literature precedent.^{[51, 52]} The integral of the peaks were measured for Zn, ZnO, and Zn(OH)₂ and used to calculate percent compositions as compared to the total peak area for all three compounds.

### Dynamic Window Assembly

100 cm² or 25 cm² Zn dynamic windows were constructed using ITO on glass as the working electrode, a galvanized Zn grid or a Zn metal frame as the counter electrode, and the Zn acetate gel electrolyte. The diameter of the wire of the Zn grid was 3 mm with a spacing of −1 cm. A non-conducting piece of glass was used on the opposite side of the working electrode to hold electrolyte inside the device. Cu tape with conductive adhesive was applied around the perimeter of the ITO working electrode to ensure uniform electrical connection. Butyl rubber was used to seal the device and separate the working and counter electrodes. To construct 25 cm² Bi—Cu dynamic windows, we followed previous literature procedures.^{[28]}

Three-electrode systems consisted of an ITO on glass working electrode, a Zn wire counter electrode, and a Zn wire reference electrode. A glass cuvette (2 cm×2 cm×2 cm) was used to contain the gel electrolyte, and the immersed area of the ITO working electrode was 3 cm².

### Further Zinc Electrodeposition Examples Using Haloacetates to Influence Electrodeposition of Zinc (References Listed Below as Second Set)

In this experiment, the paradigm for which metals can be used in reversible metal electrodeposition electrolytes for dynamic windows was broadened by demonstrating fully functional Zn electrolytes. Despite the fact that Zn is a non-noble metal with a standard reduction potential of −0.76 V vs. NHE,³⁴ we demonstrate that the hydrogen evolution reaction and other deleterious side reactions can be kinetically passivated in properly designed reversible Zn electrodeposition electrolytes. These Zn electrolytes possess high Coulombic efficiency and support the formation of a highly opaque metal film. In addition to probing the fundamental electrochemical properties of these electrolytes, their successful design allows us to construct practical two-electrode dynamic windows that possess high optical contrast. Although a recent publication utilized reversible Zn electrodeposition on a metal grid as a counter electrode,³⁵ to the best of our knowledge, this work is the first to use reversible Zn electrodeposition on a transparent conducting oxide working electrode. By harnessing a non-noble metal, this work diversifies the chemical space of reversible metal electrodeposition on transparent conductors.

### Experimental

Chemicals were received from commercial sources and used without further purification. Half-cell experiments were performed using a Zn metal (99.9%) reference electrode, a separate Zn metal counter electrode, and a Pt-modified ITO on glass working electrode with a geometric surface area of 3 cm². Electrochemistry was conducted using a VSP-300 Biologic potentiostat. All CV data presented is the second cycle unless otherwise stated. Transmission data were recorded with an Ocean Optics FLAME-S-VIS-NIR spectrometer together with an Ocean Optics DH-mini UV-Vis-NIR light source.

Various electrolytes were studied with their compositions listed in the FIGS. 8-19 captions. Solutions were prepared by adding the appropriate solids to 20 mL of de-ionized water. The pH values of the solutions were then adjusted to 4.8±0.3 with the conjugate acid of an electrolyte anion. The solutions were next converted to gels by the addition of 2% wt. hydroxyethylcellulose (Sigma Aldrich, average M, ˜90,000) and overnight stirring.

Pt-modified ITO on glass electrodes were prepared by spraying coating a 3:1 mixture of water:Pt nanoparticles (Sigma Aldrich, 3 nm in diameter) on ITO on glass substrates (Xinyan Technology, 15 Ωsq⁻¹). The Pt-modified ITO on glass substrates were then heated under air at 250° C. for 20 minutes.

For two-electrode 25 cm² dynamic windows, Cu tape with conductive adhesive was first placed along the edges of the Pt-modified ITO on glass to make uniform electrical connection to the working electrode. The counter electrode was comprised of Zn foil placed on top a nonconductive glass backing. Butyl rubber was placed around the edges of the device stack to seal the two electrodes together with an interelectrode spacing of ˜5 mm. The gel electrolyte was then injected into the device stack through the butyl rubber sealant via a syringe. The outside surfaces of the completed dynamic window were cleaned with glass cleaner before performing the optical measurements.

Scanning electron microscope (SEM) images were obtained using a JOEL JSM-6010LA microscope with an operating voltage of 20 kV. X-ray diffraction (XRD) was conducted using a Bruker D2 X-ray Diffractometer. To estimate the relative percentages of Zn and ZnO, the integral of the XRD peaks for Zn located at ˜39° and ˜43° were compared to the integral of the peak for ZnO located at ˜36°. The Zn/ZnO electrodeposits for SEM and XRD analysis were formed by conducting linear sweep voltammograms at a scan rate of 5 mV s⁻¹ from 0 V to −1 V.

### Results and Discussion

### Zn Haloacetate Electrolytes

As a starting point for designing reversible Zn electrodeposition electrolytes, we used an electrolyte containing 0.5 M ZnCl₂ and 0.5 M NaCH₃COO. This composition using relatively simple salts is inspired in part by a previous electrolyte containing ZnSO₄ and KCl used in dynamic windows that facilitate reversible Zn electrodeposition on a stainless steel mesh.³⁵ The acetate-chloride electrolyte evaluated here supports electrochemically (FIG. 8, black line) and optically reversible Zn electrodeposition. On a Pt-modified ITO working electrode, an electrode commonly used to enhance metal nucleation in reversible metal electrodeposition devices,²³ cyclic voltammetry (CV) shows that Zn electrodeposition commences at about −30 mV vs. Zn/Zn²⁺. This onset potential, which is close to 0 V, indicates that Zn electrodeposition has a low overpotential in this electrolyte. After electrodeposition occurs, the positive current at voltages greater than 0 V is due to the oxidization of Zn off of the electrode to form Zn²⁺. The rapid decrease in the current after the anodic peak around 1.3 V is due to the complete depletion of Zn from the electrode. The Coulombic efficiency, as defined by the ratio of the integrated anodic charge to the integrated cathodic charge in the CV, for this electrolyte is 98%, indicating good electrochemical reversibility.

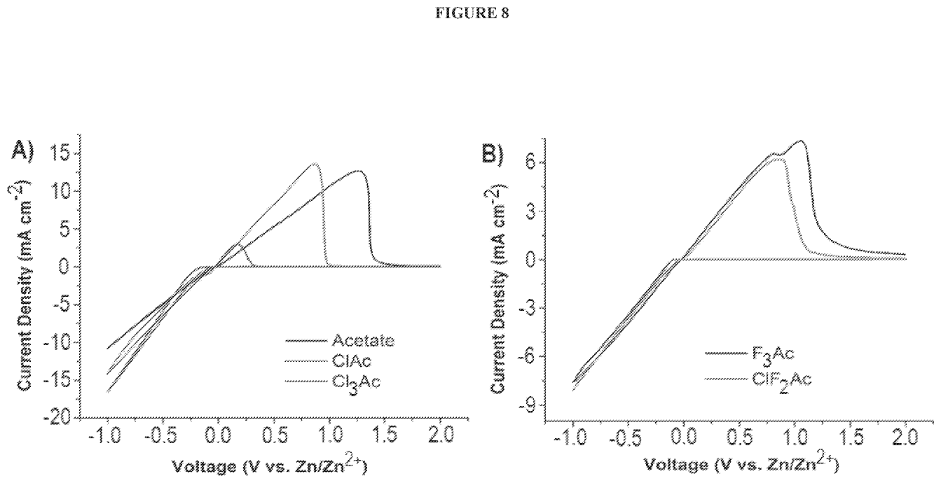

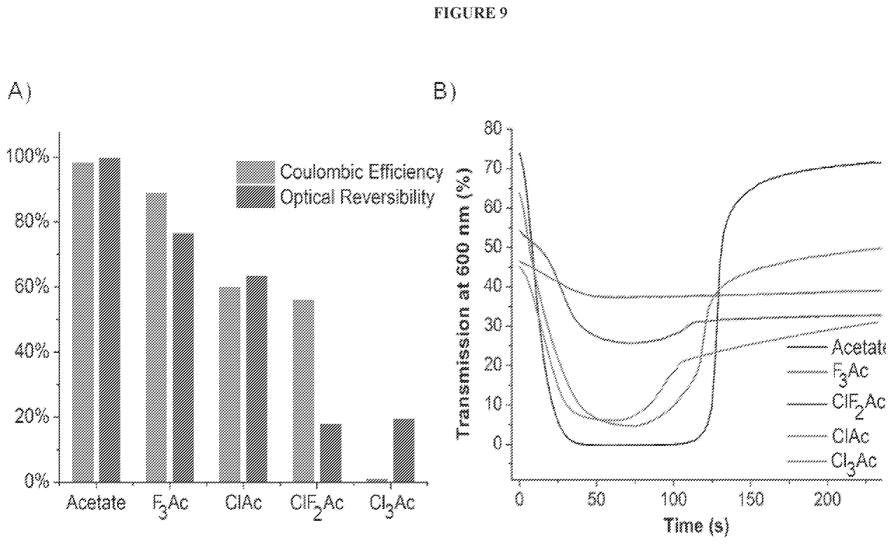

In an effort to understand the electrochemical behavior of this electrolyte, the inventors systematically altered the chemical identity of its acetate component. First, evaluated was the electrochemistry of Zn electrolytes with halogen-substituted acetates. Substituting one of the hydrogen atoms of acetate with chlorine gives chloroacetate. Although the Zn electrolyte with chloroacetate possesses the same general Zn deposition and stripping features as the acetate electrolyte, there are important differences. First, the onset potential for Zn deposition is about −70 mV, a value that is 40 mV more negative than that of the acetate electrolyte. Second, the Coulombic efficiency obtained from the CV with the chloroacetate electrolyte is 60% as compared to the 98% value in the acetate electrolyte (FIG. 9A). These findings indicate that both the Zn deposition and stripping processes are impeded with chloroacetate relative to acetate.

The complete chlorine substitution of acetate in a trichloroacetate electrolyte further inhibits the Zn deposition and stripping reactions. The onset potential for Zn deposition in the trichloroacetate electrolyte shifts further negative to −150 mV, indicating that there is a significant kinetic barrier for Zn deposition to occur using this electrolyte. Additionally, the Coulombic efficiency of the trichloroacetate CV further decreases to only 4% (FIG. 9A), which signifies that the Zn stripping reaction is slow in the presence of trichloroacetate. Taken together, these results indicate that chlorine substitution on the acetate ligand decreases the kinetics of reversible Zn electrodeposition. Increasing the number of chlorine atoms on the conjugate acids of the acetates results in progressively stronger acids (acetic acid: pKₐ=4.8, chloroacetic acid: pKₐ=2.9, trichloroacetic acid: pKₐ=0.7).³⁶ As a result, the corresponding anions with chlorine substitutions used in the Zn electrolytes are weaker bases than acetate and thus will form weaker coordination complexes with Zn²⁺, which is a Lewis acid.³⁷ Evidently, the basic nature of acetate facilitates the stripping of Zn through the formation of soluble Zn acetate complexes at the electrode-electrolyte interface. The decreased stability of the analogous Zn chloroacetate and Zn trichloroacetate complexes likely explains the decreased Coulombic efficiencies in the chlorine-substituted electrolytes.

Next was evaluated electrolytes with fluorine-substituted acetates. FIG. 9B displays CVs of reversible Zn electrodeposition in electrolytes containing trifluoroacetate and chlorodifluoroacetate. Like the trichloroacetate electrolyte, these two electrolytes contain trihaloacetates. However, the Coulombic efficiencies of the two CVs are significantly higher than that of the trichloroacetate CV (FIG. 9A). In particular, the trifluoroacetate CV possesses a higher Coulombic efficiency than the chlorodifluoroacetate CV, indicating that a greater number of fluorine substitutions enhances Zn stripping kinetics. These higher Coulombic efficiencies with fluoroacetates are observed despite the fact that trifluoroacetate and chlorodifluoroacetate are even weaker bases than trichloroacetate (trifluoroacetic acid: pKₐ=0.2, chlorodifluoroacetic acid: pKₐ=0.3).³⁸ It was hypothesize that noncovalent interactions between Zn and F, which are known to be particularly strong as compared to other Zn-halide interactions,³⁹ enhance the stability of the Zn fluoroacetate coordination complexes, thus explaining the increased stripping kinetics of the fluoroacetate electrolytes relative to the chloroacetate electrolytes.

FIG. 9B displays the transmission at 600 nm of the working electrodes during one CV cycle of reversible Zn electrodeposition in the various acetate electrolytes as measured in a spectroelectrochemical cell. For the electrolyte containing unsubstituted acetate, the transmission begins at about 74% and decreases to nearly 0% during metal electrodeposition (FIG. 9B, black line). During the stripping portion of the CV, the transmission returns close to its original 74% value, indicating that reversible Zn electrodeposition from this acetate electrolyte is nearly completely optically reversible under these conditions. The optical reversibility of the electrode during the CV cycle is defined as the ratio of the transmission changes during the deposition and stripping processes, and is given by Equation 1, where Tᵢₙᵢₜᵢₐₗ a is the transmission at the beginning of the CV, T_{final} is the transmission at the end of the CV, and Tₘᵢₙ is the minimum transmission recorded during the CV.

$$Optical Reversibility = \frac{{T}_{final} - {T}_{min}}{{T}_{initial} - {T}_{min}} \qquad ( Equation 1 )$$

Electrodes using electrolytes with halide-substituted acetates do not get nearly as opaque as the electrode using the unsubstituted acetate electrolyte. Furthermore, the electrolytes with substituted acetates all possess optical reversibilities less than 100%. The lack of optical reversibility in these electrolytes correlates well with their decreased Coulombic efficiencies (FIG. 9A), which is indicative of slower stripping kinetics. We note that in FIG. 9B, the starting transmission values of all of the electrolytes differ substantially. These differences arise from the fact that the data analyzed were taken from the second CV cycles, and so optical irreversibility in the first CV cycle resulted in a decreased initial transmission value for the substituted acetate electrolytes. We chose to analyze the second cycle of the CVs because initial nucleation processes occur on the ITO working electrode during the first CV cycle that complicate analysis.¹⁹

### Effects of Ligand Chain Length on Zn Electrolytes

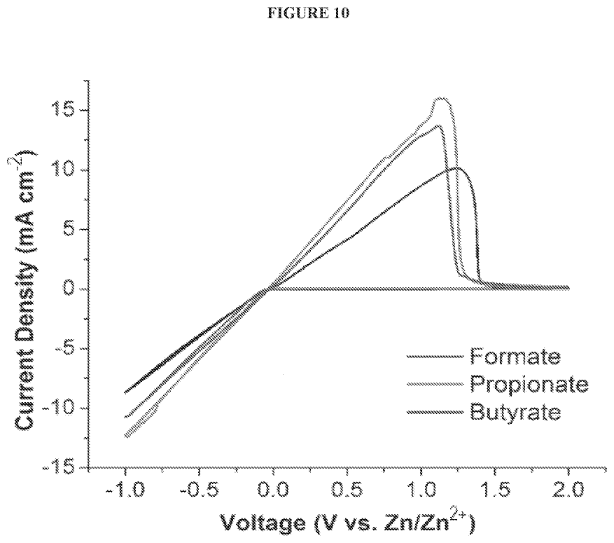

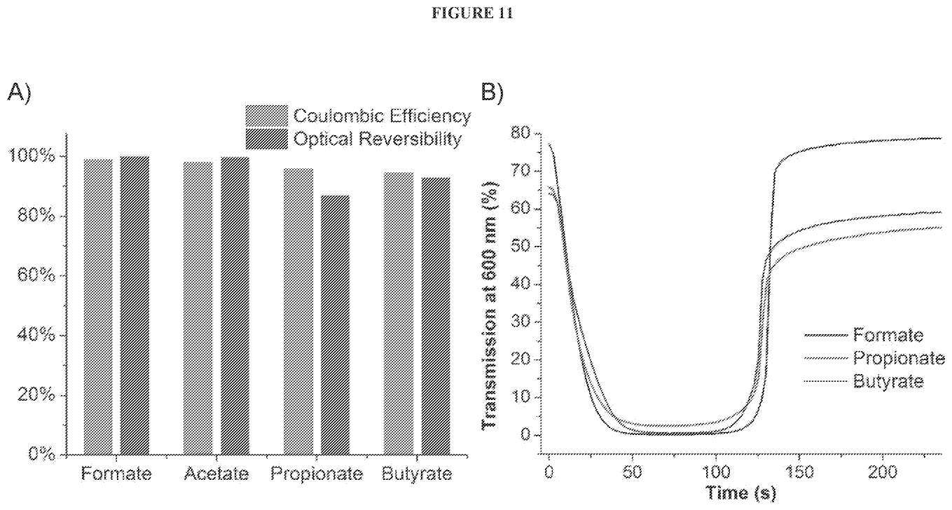

In addition to studying the effect of haloacetates, we also investigated electrolytes containing ZnCl₂ and various chain lengths of carboxylates. FIG. 10 displays CVs of the Zn electrolytes with formate, propionate, or butyrate in place of acetate. All three CVs exhibit the typical features associated with Zn electrodeposition and stripping. However, a clear trend emerges when analyzing the Coulombic efficiencies of the CVs, which increase using carboxylates with shorter chain lengths (FIG. 11 A, red bars). In particular, the CV for the formate electrolyte possesses a Coulombic efficiency of 99% as compared to 98% for the acetate electrolyte, indicating that Zn stripping kinetics are accelerated with the formate anion.

As for the haloacetate electrolytes, the trend in the optical reversibilities of the electrolytes with different carboxylates also follows the Coulombic efficiency trend (FIG. 9A and FIG. 11A). In particular, the transmission of the working electrode when using the formate electrolyte returns back to its original ˜77% value after the stripping portion of the CV is completed, indicating that this electrolyte exhibits complete optical reversibility (FIG. 111B, black line). The good electrochemical and optical reversibility observed in the formate electrolyte is likely due to the sterically unencumbered nature of the small formate anion, which enhances Zn stripping kinetics. Formate is less basic than acetate³⁸ (formic acid: pKₐ=3.7, acetic acid: pKₐ=4.8) and from the haloacetate results described in the previous section, the lower basicity of formate is expected to impede stripping kinetics. Evidently though, the smaller amount of steric hindrance with formate is a more impactful effect in dictating stripping kinetics. Furthermore, the importance of the steric effect is confirmed with experiments using the long-chained propionate and butyrate. These electrolytes possess slower stripping kinetics than acetate even though all three carboxylates have similar basicities³⁸ (propionic acid: pKₐ=4.9, butyric acid: pKₐ=4.8).

### Effect of Halides on Zn Electrolytes

We next studied the effect of halide compositions on the Zn electrolytes. Because in the section above, we found that both the acetate and formate electrolytes possess good Coulombic efficiency and optical reversibility, we investigated the influence of halide composition on both of these systems with a particular focus on the formate electrolytes due to their enhanced stripping kinetics.

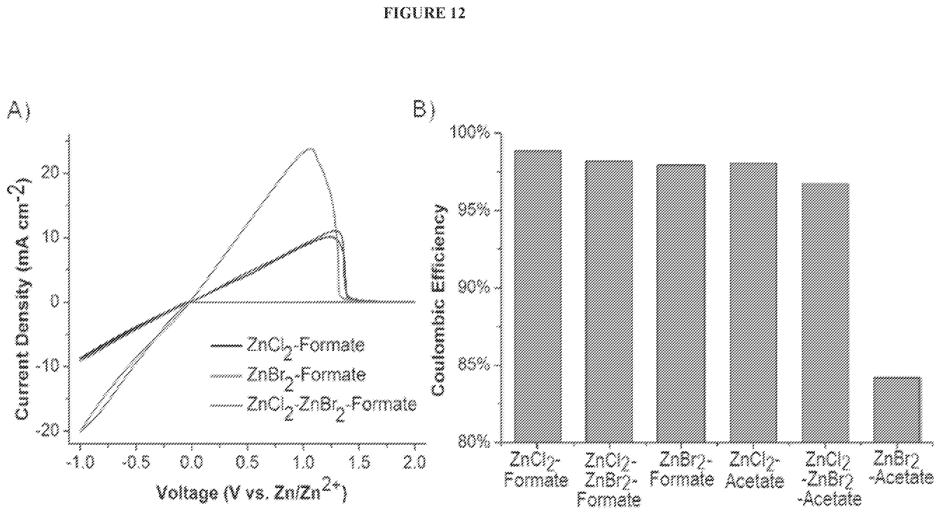

FIG. 12A displays CVs of Zn electrodeposition and stripping in formate electrolytes with ZnCl₂, ZnBr₂, and a 1:1 mixture of ZnCl₂ and ZnBr₂. The CV of the electrolyte containing ZnBr₂ (red line) possesses approximately twice the deposition current as the CV of the ZnCl₂ electrolyte (black line), and as a result, the ZnBr₂ CV also exhibits about twice as much stripping current. In Cu electrodeposition baths, the bromide anion is known to be an accelerant for electrodeposition that operates via the formation of bridges halide complexes,^{40, 41} and a similar phenomenon may explain the enhanced deposition current observed with the ZnBr₂ electrolyte. However, because bromide induces morphological differences in Zn electrodeposits, the ZnBr₂ electrolyte results in films that switch to their opaque states as quickly as those formed using ZnCl₂ (vide infra) despite the increased current sustained by the ZnBr₂ electrolyte. For this reason, we also studied a 1:1 mixture of ZnCl₂ and ZnBr₂ with the intention of accelerating deposition kinetics while maintaining an optically favorable electrodeposit morphology. Interestingly, the CV of the ZnCl₂—ZnBr₂ electrolyte (blue line) possesses similar currents as the CV of the ZnCl₂ electrolyte (black line). This result suggests that the ZnCl₂—ZnBr₂ electrolyte is dominated by chlorine species from which electrodeposition occurs. Indeed, Zn—Cl bonds are significantly stronger than Zn—Br bonds, which explains the greater stability of Zn—Cl electrodeposition precursors.³⁹

The Coulombic efficiencies of the CVs increase in the order of ZnCl₂>ZnCl₂—ZnBr₂>ZnBr₂ for both the formate and acetate electrolytes (FIG. 12B and S10). Furthermore, for a given halide composition, each formate electrolyte exhibits a higher Coulombic efficiency than the corresponding acetate electrolyte due to the enhanced stripping kinetics of formate as discussed previously. It was hypothesized that the greater Coulombic efficiencies in the electrolytes containing ZnCl₂ is due to enhanced stripping kinetics of chloride that result from the greater stability of Zn—Cl coordination complexes.

We also tested an electrolyte containing ZnI₂. The iodide-containing electrolyte produced a yellow-colored solution as a result of the oxidation of iodide to iodine during the anodic portion of the CV (FIG. S11). This iodine formation interfered with measurements of the transmission of the working electrode (FIG. S12), and thus ZnI₂ electrolytes were not studied further. ZnF₂ electrolytes could not be examined due to the insolubility of ZnF₂ in water.

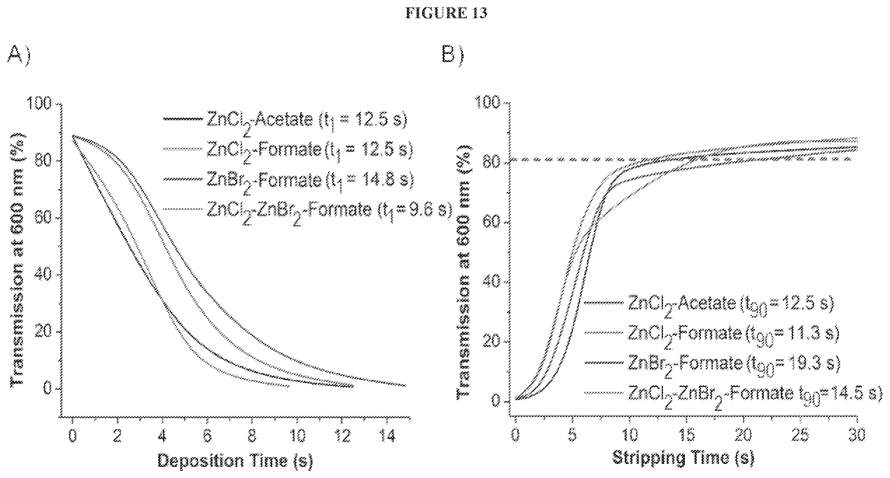

Given the high Coulombic efficiencies (>98%) of the ZnCl₂-acetate, ZnCl₂-formate, ZnBr₂-formate, and ZnCl₂—ZnBr₂-formate systems, we studied these four electrolytes using chronoamperometry to better assess their deposition and stripping speeds (FIG. S13). FIG. 13 displays the transmission of the working electrode at 600 nm during Zn electrodeposition and stripping. Electrodeposition was elicited by applying a potential of −1.0 V until the transmission reached 1% (FIG. 13A). Upon reaching 1% transmission, the potential was switched to +2.5 V to induce metal stripping (FIG. 13B). This procedure allows for the comparison of electrode darkening and lightening speeds at a fixed contrast ratio (i.e. switching between a 88% clear state to a 1% dark state) among the four electrolytes.

For both the ZnCl₂-acetate and ZnCl₂-formate electrolytes, the time it takes to reach 1% transmission is 12.5 s (FIG. 13A, black and red lines). However, the darkening speed decreases to 14.8 s with the ZnBr₂-formate electrolyte (FIG. 13A, blue line) despite the additional deposition current observed with ZnBr₂ (FIG. 12A). This finding implies that the morphology of the Zn electrodeposits with the ZnBr₂ electrolyte are less effective at blocking light than the ZnCl₂ electrolyte. This supposition is confirmed by SEM analysis (vide infra). Strikingly, the fastest darkening speed of 9.6 s is obtained with the ZnCl₂—ZnBr₂-formate electrolyte. The interpretation of this result is discussed later in the manuscript.

Electrode lightening speeds were assessed by calculating the time it takes the electrode to complete 90% of its transmission change during metal stripping (t₉₀ values, dashed purple line, FIG. 13B). The t₉₀ value for the ZnCl₂-formate electrolyte (11.3 s) is less than for the ZnCl₂-acetate electrolyte (12.5 s) due to the enhanced stripping kinetics by the less sterically bulky formate anion as discussed previously. The lightening speeds for the three formate electrolytes increase in the order of ZnCl₂>ZnCl₂—ZnBr₂>ZnBr₂. This trend directly correlates with the same order of increasing Coulombic efficiency (FIG. 12B), which demonstrates the enhanced stripping kinetics imparted by chloride.

### Surface Characterization of Zn Electrodeposits

To investigate the morphology of the Zn electrodeposits as a function of halide composition in the electrolyte, we use SEM to image the electrodeposits. The Zn electrodeposits obtained from the ZnCl₂ (FIGS. 14A and 14B) and ZnCl₂—ZnBr₂ (FIGS. 14E and 14F) electrolytes are relatively similar and consist of a uniform film of material decorated with protrusions approximately 1 μm in length. In contrast, the morphology of the electrodeposits obtained from the ZnBr₂ electrolyte is markedly different and consists of a lower density of larger particles (>10 μm in length) with visible gaps in between them. These images suggest that in the ZnBr₂ electrolyte, the metal nucleation density is lower than in the chloride-containing electrolytes, which gives rise to more nonuniform growth. Larger particles, however, grow in the ZnBr₂ electrolyte because of the enhanced deposition kinetics observed with bromide as discussed previously. These larger and less uniform particles that contain gaps are less effective at blocking light compared to the more uniformly distributed electrodeposits obtained from the chloride-containing electrolytes. These results explain why the ZnBr₂-formate electrolyte exhibits a slower darkening time as compared to the ZnCl₂-formate and ZnCl₂—ZnBr₂-formate electrolytes (FIG. 13A) despite the greater magnitude of current measured during the CVs (FIG. 12A).

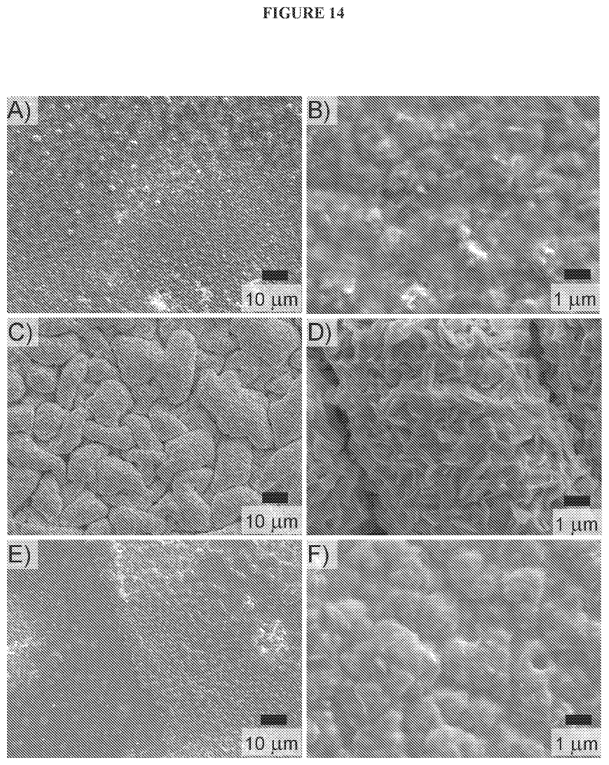

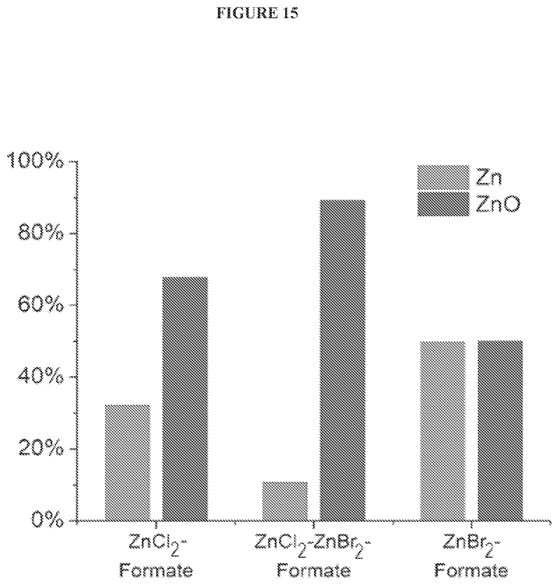

However, given the fairly similar morphologies of the electrodeposits obtained from the ZnCl₂ and ZnCl₂—ZnBr₂ electrolytes, it is unclear at this stage of our analysis why the ZnCl₂—ZnBr₂ electrolyte possesses a faster darkening speed (FIG. 13A). To complement the SEM morphological data, we used XRD to probe the chemical composition of the electrodeposits. XRD analysis shows that the electrodeposits consist predominantly of Zn and ZnO (FIG. S14). By comparing the ratios of the integrated peaks in the XRD spectra for Zn and ZnO, we were able to gauge the oxide content in the various electrodeposits (FIG. 15).

Interestingly, electrodeposits obtained from the ZnCl₂—ZnBr₂ electrolyte have a significantly higher percentage of ZnO than electrodeposits created from the ZnCl₂ or ZnBr₂ systems. Perhaps the greater quantity of ZnO causes the electrodeposits formed from the ZnCl₂—ZnBr₂ electrolytes to block light more effectively than the morphologically-similar electrodeposits obtained from ZnCl₂. However, because the extinction coefficient of ZnO is substantially less than Zn,^{42, 43} uniform thin films of pure ZnO block less light than a uniform Zn film of the same thickness. This inconsistency means that a completely uniform thin film of Zn or ZnO is an inadequate way of modeling the optics of these electrodeposits. It is likely that more complex optical phenomena occur within the electrodeposits, which are highly heterogeneous both in terms of their physical and chemical structures.

### The Electrochemical Window of ITO in Zn Electrodeposition Electrolytes

As mentioned in the introduction, dynamic windows based on reversible metal electrodeposition typically harness relatively noble metals such as Cu, Bi, and Ag.¹⁶ These metals have standard reduction potentials more positive than H₂, and therefore, it is thermodynamically more favorable in aqueous electrolytes to electrodeposit these metals as opposed to generating H₂, which is not tolerable for window applications.³⁴ Not only is there the potential issue of H₂ generation with less noble metals, electrodepositing metals with more negative reduction potentials can also lead to the application of voltages outside of the electrochemical window of transparent conductors like ITO. For instance, ITO is known to degrade at voltages more negative than about −0.3 V vs. Zn²⁺/Zn at neutral pH.⁴⁴

Despite the instability of ITO and the thermodynamic possibility of H₂ generation at negative potentials, we do not observe ITO degradation or H₂ generation in any of the studied Zn electrolytes when cycling between +2.0 V and −1.0 V vs. Zn²⁺/Zn. These findings suggest that some property of the Zn electrolytes impedes H₂ evolution and ITO degradation, thus protecting the electrode from undergoing these unwanted side reactions.

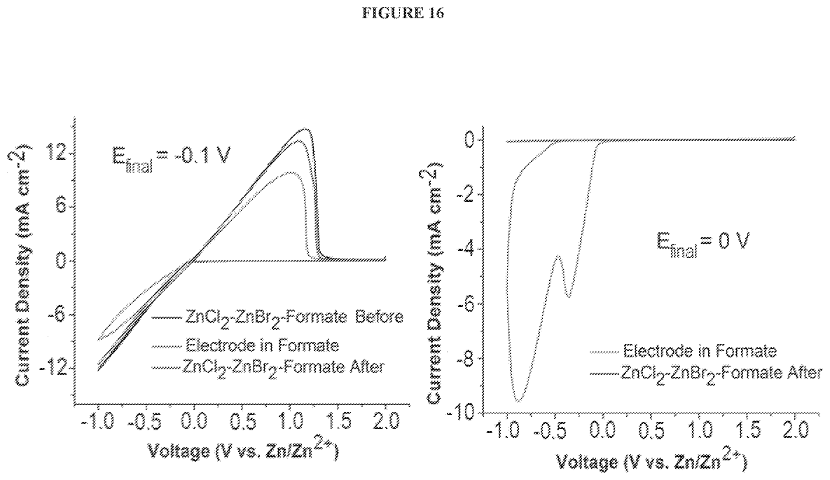

We performed a series of CV experiments to interrogate how the Zn electrolytes protect the ITO electrode and prevent H₂ formation. These experiments have three distinct stages. In the first stage, we conducted a CV in the previously described electrolyte containing sodium formate, ZnCl₂, and ZnBr₂ (FIG. 16A, black line). During the second cycle of this CV, the experiment was stopped at −0.1 V during the negative going sweep (E_{final}=−0.1 V). As a result, the working electrode at this stage contained a small amount of electrodeposited Zn on its surface.

In the second stage of the experiment, the electrode was removed from the first electrolyte and placed in a second electrolyte containing sodium formate without any Zn salts. The CV in this blank formate electrolyte still contains the characteristic reversible Zn deposition and stripping peaks (FIG. 16A, red line). These peaks are due to the stripping and redepositing of Zn that was originally electrodeposited during the first stage. (In part, the peaks are also due to Zn²⁺ impurities in the blank electrolyte, which come from residual Zn electrolyte on the original wet electrode. We do not rinse the electrode before moving it to the blank formate electrolyte so as to not destroy the integrity of the electrodeposited Zn film.) Finally, in the third stage of the experiment, the electrode is removed from the second electrolyte and placed in a third electrolyte, which is a freshly prepared solution containing sodium formate, ZnCl₂, and ZnBr₂. The CV of the electrode in this new ZnCl₂—ZnBr₂-formate electrolyte (FIG. 16A, blue line) is similar to the CV of the electrode in the first electrolyte (FIG. 16A, black line). The similarity of the CVs before and after cycling in the blank formate electrolyte indicates that cycling in the blank formate electrolyte does not degrade the ITO electrode when E_{final}=−0.1 V.

With a new working electrode, next was performed the same three-part experiment, but during the first CV in the ZnCl₂—ZnBr₂-formate electrolyte, the negative going sweep was halted at 0 V during the second cycle (E_{final}=0 V). Because the experiment was halted before Zn electrodeposition occurred during the second cycle, the electrode did not contain a significant amount of Zn at this stage. Next, the electrode was placed in the blank formate electrolyte. The CV in the blank formate electrolyte does not contain the typical Zn electrodeposition and stripping peaks (FIG. 16B, red line). Instead, the cathodic peaks observed are a combination of H₂ evolution and ITO degradation to metallic In and Sn. In the third stage of the experiment, the electrode was placed back in the ZnCl₂—ZnBr₂-formate electrolyte. Notably, the CV in this case shows little current density throughout the scan (FIG. 16B, blue line). This result indicates that the ITO electrode degraded and as such no longer supports reversible Zn electrodeposition.

In summary, H₂ evolution and ITO degradation occur when E_{final}=0 V, but not when E_{final}=−0.1 V. These results demonstrate that Zn electrodeposits protect the ITO electrode from degradation and from evolving H₂. During the second stage of the experiments in the blank formate electrolyte, the Zn electrodeposits are only present on the electrode when E_{final}=−0.1 V. It is known that Zn is a poor catalyst for the H₂ evolution reaction,⁴⁵ and in this way the electrodeposited Zn prevents the system from generating H₂ even at relatively high magnitude cathodic potentials. Furthermore, the Zn electrodeposits protect the ITO from degrading into metallic In and Sn likely by physically blocking access of the electrolyte to the ITO surface. In this manner, the electrochemical window of ITO is expanded in the presence of reversible Zn electrodeposition electrolytes.

### Practical Two-Electrode Devices Using Reversible Zn Electrodeposition

Having designed and investigated reversible Zn electrodeposition electrolytes, we next constructed practical two-electrode 25 cm² dynamic windows using these electrolytes. We built these windows with the electrolyte containing ZnCl₂, ZnBr₂, and sodium formate because our studies described above determined that this electrolyte has a high Coulombic efficiency and fast switching times.

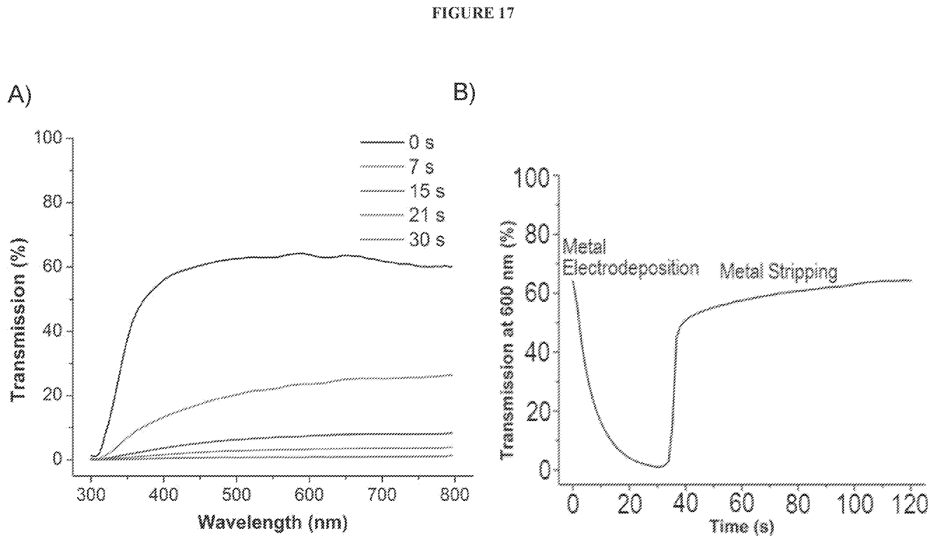

The application of −0.8 V for 30 s to the 25 cm² device causes the initial visible light transmission of the window to decrease from ˜60% to <0.1% (FIG. 17A). The high opacity of the window in its dark state is enabled by the dense morphology of the Zn electrodeposits on the ITO surface, which blocks light effectively. In its opaque state, the window appears black due to its flat transmission profile across the visible spectrum. Additionally, the window in its opaque state effectively blocks near-infrared light, which is desirable for building applications in which heat management is important. After 30 s of metal electrodeposition on the working electrode, switching the voltage of the device to +2.3 V elicits rapid metal stripping, which causes the device to return to its original clear state within 90 s (FIG. 17B).

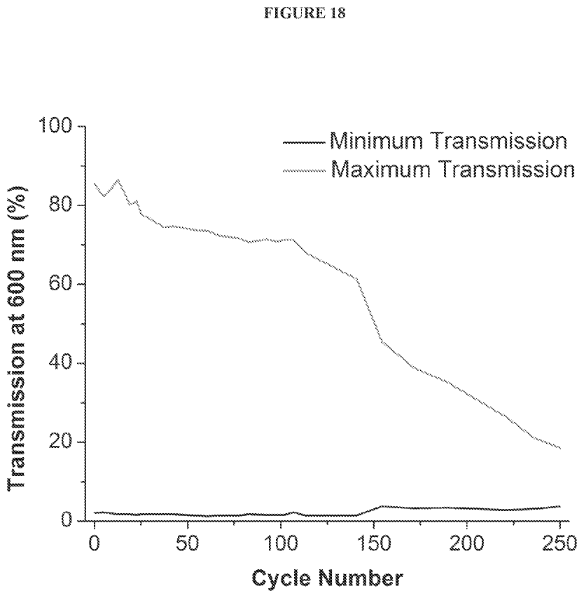

An important attribute of any dynamic window technology is device cycle life. Thus far, several different variants of dynamic windows based on reversible metal electrodeposition have been developed that cycle thousands of times without significant degradation.^{24, 25, 31} FIG. 18 displays the minimum and maximum transmission values of a dynamic window based on reversible Zn electrodeposition during consecutive switching cycles. From the data, it is clear that the maximum transmission value of the device steadily decreases over the course of 250 cycles. This less-than-optimal cycleability is in contrast to our previous work showing excellent cycle lives in windows using reversible Bi and Cu electrodeposition.

To understand the origin of the decrease in the maximum transmission value during cycling of the Zn windows, we conducted XRD on the working electrode after the 250 switching cycles. The XRD spectrum shows a prominent peak that is due to the presence of Zn(OH)₂. Because the intensity of this peak is much larger than any Zn(OH)₂ peak observed after one cycle of Zn electrodeposition, this finding suggests that Zn(OH)₂ progressively accumulates on the working electrode and is responsible for the steady decrease in the transparency of the window in its clear state during cycling.

In future work, we will carefully interrogate the origin of this accumulation of Zn(OH)₂ during cycling, and we will pursue several strategies to mitigate this problem including utilizing different voltage switching profiles and chemical additives such as chelating ligands that may facilitate Zn(OH)₂ dissolution. However, the focus on this manuscript is to interrogate the physicochemical parameters that allow for reversible Zn electrodeposition electrolytes, not to develop practical windows or optimal cycling parameters. Nonetheless, because the design of such electrolytes is still in its infancy, we are hopeful that future versions of these electrolytes will enable the construction of robust and practical dynamic windows.

### Conclusions

In these experiments, the inventors investigated a variety of chemical and physical properties of reversible Zn electrodeposition on transparent conducting electrodes. In particular, we systematically studied the effect of the chain length of carboxylates, the halogen in haloacetate, and the identity of supporting halides on the electrochemical reversibility of Zn electrolytes. These studies enabled us to develop electrolytes that are both optically and electrochemical reversibility (Coulombic efficiency up to 99%). Using SEM and XRD analysis, we correlated electrolyte composition with electrodeposit morphology and composition, both of which effect the reversibility of the system. We also discovered how reversible Zn electrodeposition occurs in these electrolytes despite the fact that electrode degradation and H₂ production are thermodynamically favorable within the voltage regimes need to elicit Zn electrodeposition. Lastly, we applied these findings to the construction of practical 25 cm² dynamic windows based on reversible Zn electrodeposition.

### Example—Zinc Electrodeposition Examples Using SO₄²⁻ to Influence Electrodeposition of Zinc

In this experiment, the inventors explore a method to reduce the amount of side products, including ZnO, by constructing fully functional Zn electrolytes. While these electrolytes focus on non-coordinating anions, we are able to design and construct reversible, high contrast electrolytes that possess high Coulombic efficiency.

### Experimental

Chemicals were obtained from commercial sources and used without further purification. Three-electrode experiments were performed and measured using a Zn metal foil (99.9%) as a reference electrode and a separate Zn metal foil as a counter electrode. ITO on glass was modified by spraying coating a 3:1 vol. % dispersion of water and Pt nanoparticles (Sigma Aldrich, 3 nm in diameter) on ITO on glass substrates (Xinyan Technology, 15 Ωsq⁻¹). The Pt-modified ITO on glass substrates were then heated under air at 200° C. for 20 minutes and were used as the working electrodes with a geometric surface area of 3 cm². Electrochemistry was conducted using a VSP-300 Biologic potentiostat. All CV data presented are the second cycle unless otherwise stated. Transmission data were recorded with an Ocean Optics FLAME-S-VIS-NIR spectrometer with an Ocean Optics DH-mini UV-Vis-NIR light source.

The compositions of various electrolytes are listed in the figure captions. Solutions were prepared by adding the appropriate solids to 20 mL of de-ionized water. The pH values of the solutions were then adjusted to 4.8±0.3 with the conjugate acid of an electrolyte anion. The solutions were next converted to gels by the addition of 2% wt. hydroxyethylcellulose (Sigma Aldrich, average Mv ˜90,000) after stirring overnight.

For two-electrode 25 cm² dynamic windows, Cu tape with conductive adhesive was first placed along the edges of the Pt-modified ITO on glass to make uniform electrical connection to the working electrode. The counter electrode was comprised of Zn mesh placed on top a nonconductive glass backing. Butyl rubber was placed around the edges of the device stack to seal the two electrodes together with an interelectrode spacing of ˜5 mm. The gel electrolyte was then injected into the device stack through the butyl rubber sealant via a syringe. The outside surfaces of the completed dynamic window were cleaned with glass cleaner before performing the optical measurements.

Scanning electron microscope (SEM) images were obtained using a JOEL JSM-6010LA microscope with an operating voltage of 20 kV. X-ray diffraction (XRD) was conducted using a Bruker D2 X-ray Diffractometer. The Zn/ZnO electrodeposits for SEM and XRD analysis were formed by conducting linear sweep voltammograms at a scan rate of 5 mV s¹ from 0 V to −1 V.

### Results and Discussion

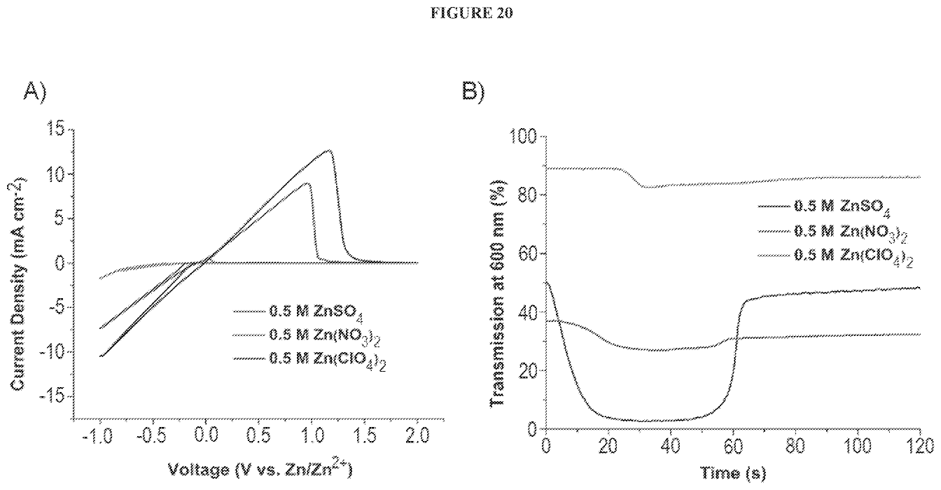

To further study the electrochemical behavior of Zn and how the supporting anions can influence the process, the inventors selected three Zn compounds that have non-coordinating anions. Each experiment was done with the same molarity of metal ions to ensure that the only difference would be the anions. Due to this selection, we expected that all of the electrolytes would share general Zn deposition and stripping features. However, the results show important differences. While both the cyclic voltammograms (CVs) of ZnSO₄ and Zn(ClO₄)₂ contain prominent deposition and stripping features, the CV for Zn(NO₃)2 possesses a relatively small amount of current (FIG. 20A). In tandem with Zn electrodeposition, NO₃⁻ reduction to NO₂⁻ and NH₃ occurs at potentials more negative than −0.3 V. This finding matches previous studies of NO₃⁻ on Zn electrodes. (https://pubs.acs.org/doi/pdf/10.1021/acscatal.1c01525). As a result, the NO₃⁻ reduction reaction inhibits the reversible Zn electrodeposition process.

The differences in the voltammetry also correspond to differences in the optical transmission of the electrodes during the CVs (FIG. 20B). The electrode transmission using the Zn(NO₃)₂ electrolyte possesses the lowest change in transmission with a contrast ratio of less than 10% during deposition (FIG. 20B, red line) due to the inhibitory effect of NO₃⁻. Similarly, the experiment with Zn(ClO₄)₂ exhibits an electrode transmission of only slightly greater than 10% (FIG. 20B, blue line). In addition to its non-coordinating nature, ClO₄ is an electrochemically inert anion unlike NO₃⁻. Previous studies of RME electrolytes with Bi and Cu have demonstrated that ClO₄⁻ does not actively participate in the metal deposition and stripping processes. (https://www.nature.com/articles/s41560-021-00816-7 https://www.sciencedirect.com/science/article/pii/S2542435120301914?via%3Dihub) Therefore, the voltammetry and transmission results for the Zn(ClO₄)₂ can be interpreted as arising from solely Zn electrochemistry. Interestingly, the transmission curve for the ZnSO₄ possesses much greater optical contrast (>45%) than the other two electrolytes (FIG. 20B, black line). Furthermore, the electrode with the ZnSO₄ electrolyte is the only one that reaches its original transmission during Zn stripping. The finding that the ZnSO₄ electrolyte supports high current density and good optical contrast and reversibility demonstrates that even though SO₄²⁻ is a non-coordinating anion, there is a beneficial secondary effect of SO₄²⁻ that aids in Zn spectroelectrochemistry. The subsequent experiments in this manuscript explore this hypothesis.

In FIG. 20B and all subsequent analogous figures, the initial transmission values of the electrolytes are different. These discrepancies result from the fact that the data were taken from the second CV cycles, and so any irreversibility from the first cycle resulted in a decreased starting electrode transmission. We analyze the second cycles of the CVs because nucleation occurs more prominently on the ITO working electrode during the first CV cycle, which complicates analysis. In this way, the second CV cycle is more representative of the general spectroelectrochemical behavior of the electrolytes.

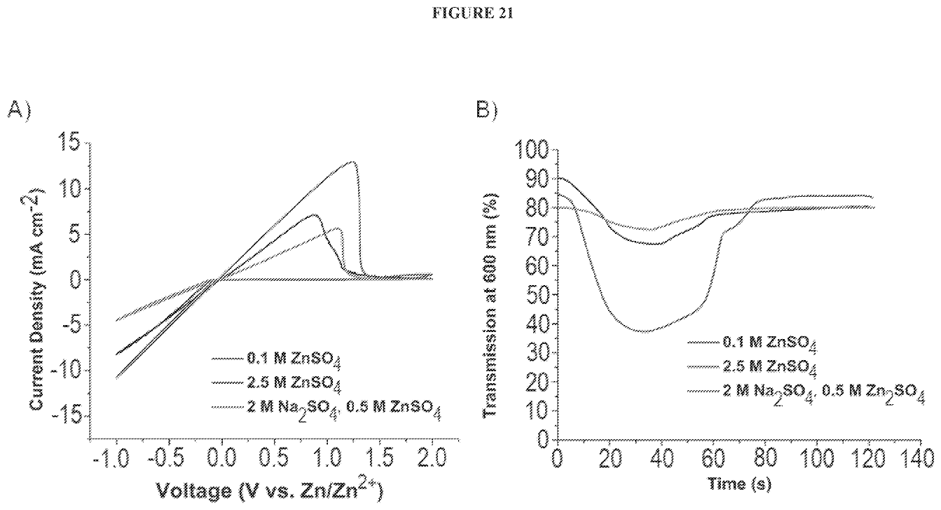

After identifying the beneficial effects of SO₄²⁻, we evaluated the spectroelectrochemistry of the ZnSO₄ electrolyte at two additional concentrations (FIG. 21, black and blue lines). Before explaining the results, we note that the electrolytes in FIG. 21 are liquid electrolytes, while those in all other figures in the manuscript are gels formed by the addition of 2 wt. % hydroxyethylcellulose. Liquid electrolytes were analyzed in this data set because ZnSO₄ is not soluble in a gel form at the higher 2.5 M concentration. Compared to the 0.1 M electrolyte, the electrode using the 2.5 M ZnSO₄ electrolyte exhibits a greater current density during both deposition and stripping, as well as better optical properties including greater contrast and reversibility. This finding is expected because a greater of Zn ions increases the current associated with Zn electrochemistry.

However, in the discussion of FIG. 20 above, it was identified that SO₄²⁻ influences Zn electrodeposition, and therefore the inventors wondered if the enhanced Zn deposition and stripping current with 2.5 M ZnSO₄ is attributed solely to the increased Zn²⁺ concentration. To determine the effects of Zn²⁺ and SO₄²⁻, we performed a CV with 2 M Na₂SO₄ and 0.5 M ZnSO₄ (FIG. 21A, red line). This electrolyte contains an equal molarity of SO₄²⁻ ions, but a reduced amount of Zn²+, 0.5 M, as compared to the 2.5 M ZnSO₄ electrolyte. Because the CV of the electrode with the Na₂SO₄—ZnSO₄ electrolyte possesses less current than the 2.5 M ZnSO₄ electrolyte, we conclude that the increased concentration of Zn²⁺ does indeed result in increased Zn electrochemistry.

Furthermore, the transmission curve of the 2.5 M ZnSO₄ liquid electrolyte (FIG. 21B, blue line) exhibits similar optical contrast (>45%) as the 0.5 M ZnSO₄ gel electrolyte (FIG. 20B, black line). Previous studies with Bi—Cu RME systems have shown that gel electrolytes facilitate higher contrast ratios than liquid electrolytes due to their ability to produce more compact metal electrodeposits. (https://www.nature.com/articles/s41560-021-00816-7) The observation that the two electrolyte concentrations exhibit similar optical contrasts demonstrates that while the increased concentration of Zn²⁺ is beneficial for optical contrast in the 2.5 M electrolyte, the absence of the gel is detrimental. These two processes effectively cancel each other out, giving the 2.5 M liquid electrolyte and 0.5 M gel electrolyte equal optical contrasts. However, the gel electrolyte has the advantage of being more suited to the construction of practical dynamic windows. Because the 2.5 M gel electrolyte is not soluble, the inventors chose to study derivatives of the 0.5 M ZnSO₄ gel electrolyte for the remainder of this manuscript.

The next objective was to identify if there were any additional supporting ions that could be added to improve the electrolyte performance. Previous studies have shown that sodium formate improved the performance of Zn RME electrolytes that do not contain SO₄²⁻.(ref) This improvement is due in part to the basicity of formate (pKₐ=3.7), which increases Zn stripping kinetics through the formation of soluble Zn formate complexes at the ITO-electrolyte interface. In addition to its basicity, the sterically unencumbered structure of formate allows enhanced nucleophilic attack on electrodeposited Zn as compared to other carboxylates such as acetate. It was also shown that halides aid Zn stripping due to the formation of stable Zn-halogen bonds. Based on this previous work, we decided to study ZnSO₄ electrolytes with the addition of sodium formate and Zn halides. Due to the insolubility of ZnF₂ and the ease with which I⁻ is oxidized to I₂, the inventors focused our studies on ZnCl₂ and ZnBr₂.

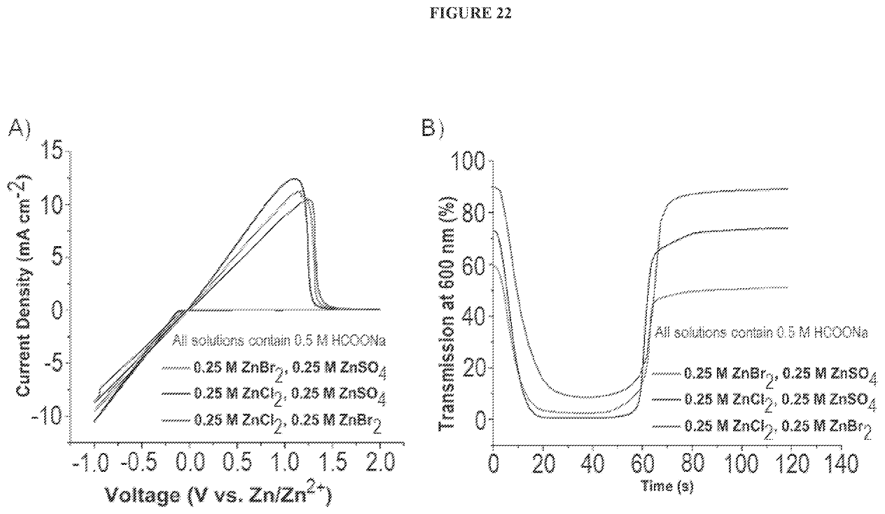

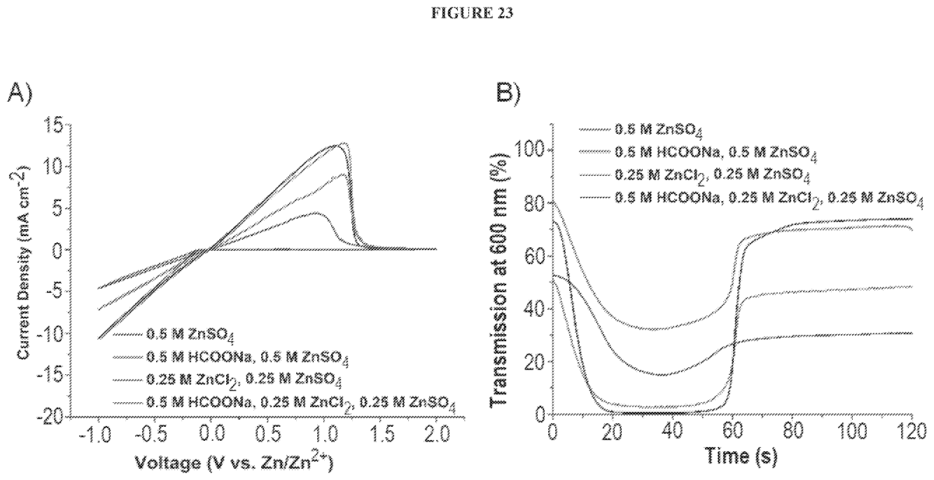

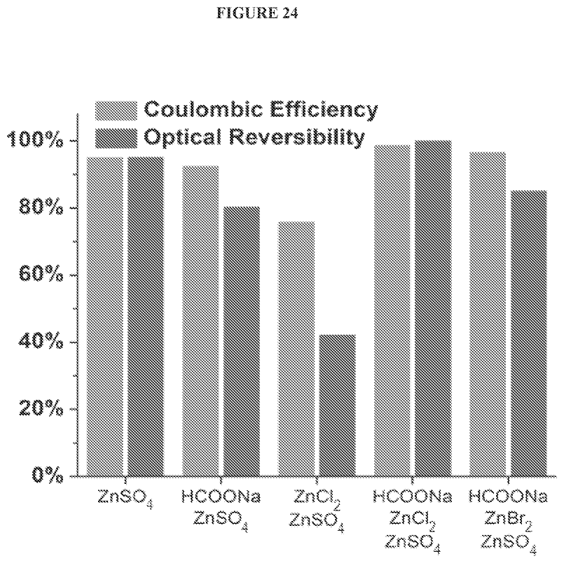

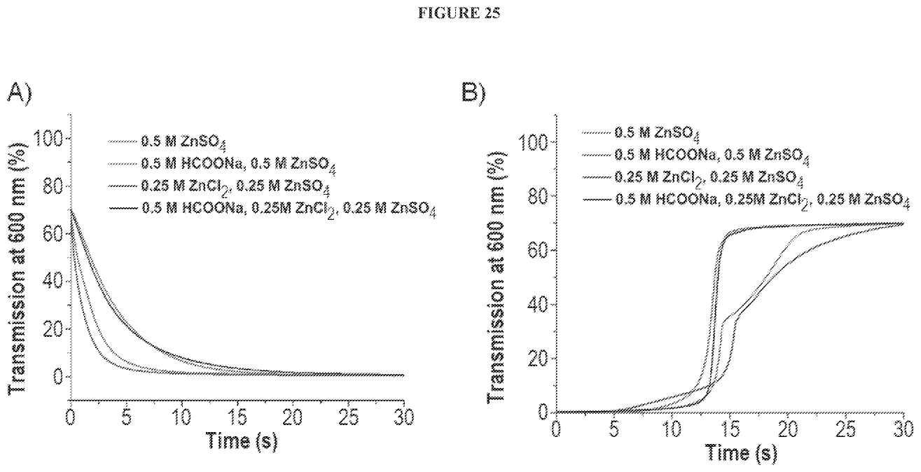

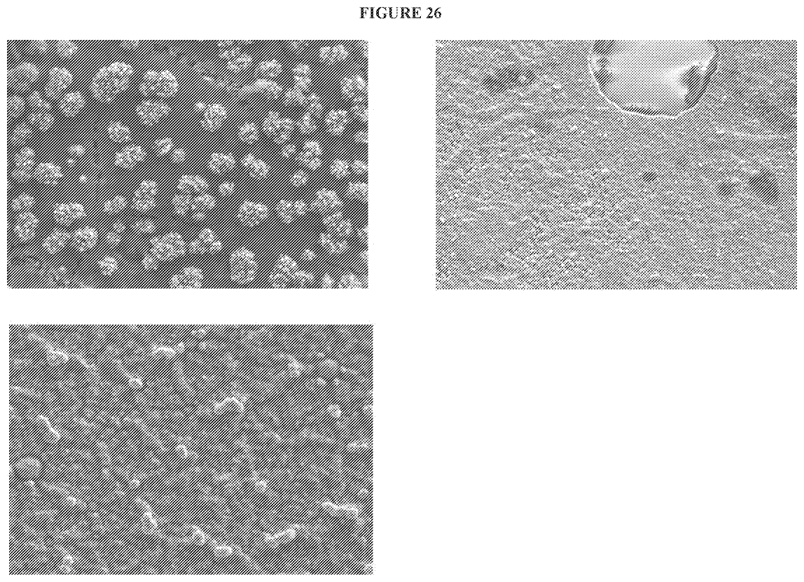

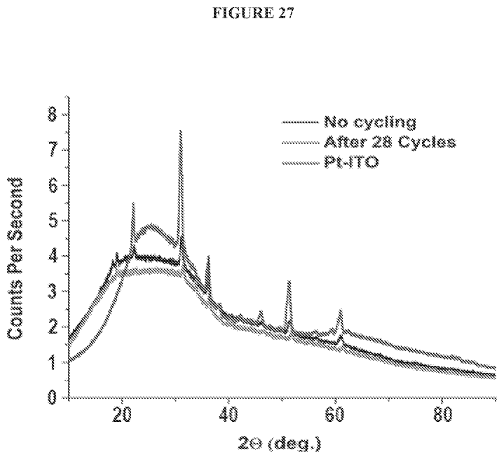

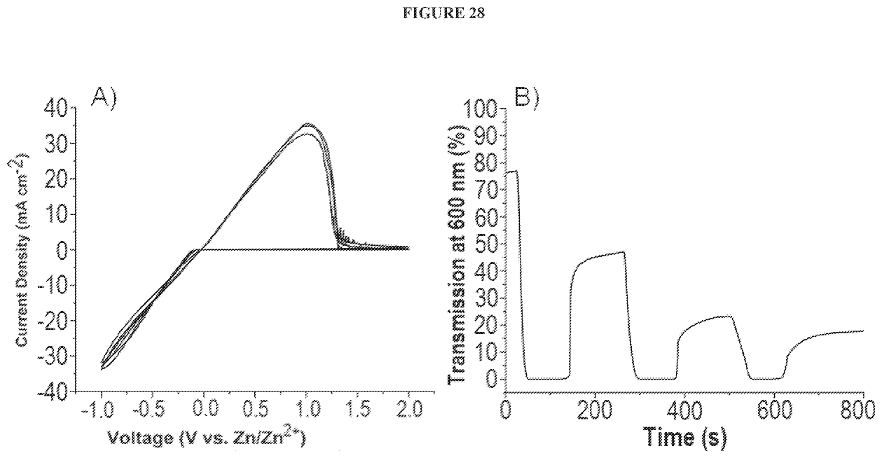

FIG. 22 shows CVs and the corresponding electrode transmissions for the ZnCl₂—ZnSO₄-formate and ZnBr₂—ZnSO₄-formate electrolytes as compared to the previously studied ZnCl₂—ZnBr₂-formate electrolyte. While the general features of the CVs amongst the three electrolytes are similar (FIG. 22A), there are important differences in the optical reversibilities of the systems (FIG. 22B). The ZnCl₂—ZnSO₄-formate and the ZnCl₂—ZnBr₂-formate electrolyte both possessed similarly large optical contrast ratios, and the electrode transmission for both electrolytes returns to its initial transmission during stripping. These results indicate that the ZnCl₂—ZnSO₄-formate developed in this manuscript is comparable in terms of its spectroelectrochemical performance to the previously optimized ZnCl₂—ZnBr₂-formate.

Furthermore, the electrode using the ZnBr₂—ZnSO₄ electrolyte exhibits the lowest contrast ratio (<60%) and also is the least optically reversible. Previous results with ZnBr₂-formate RME electrolytes demonstrate that bromide favors the formation of large heterogeneous particles that are more difficult to strip than films of smaller, more homogenous deposits.

Having established that the ZnCl₂—ZnSO₄-formate electrolytes possess promising spectroelectrochemical attributes for dynamic windows, the next performed systematic compositional studies to understand the function of each electrolyte component and their relation to each other.

### Bismuth-Copper Electrodeposition Examples

Previous research shows that Bi and Cu electrolytes on ITO on glass and related transparent electrodes facilitate fast, reversible, and color neutral metal electrodeposition over thousands of cycles. Most metal-based electrolytes that are studied are acidic because metal ions are Lewis acids, and these solutions tend to not be soluble at more alkaline conditions. Bi—Cu also forms insoluble Bi(OH)₃ at neutral or alkaline conditions as seen in Equation 1:

$$B {i}_{( aq )}^{3 +} + 3 {H}_{2} O ⇌ {Bi ( O H )}_{3 ( s )} + 3 {H}_{( aq )}^{+} \qquad ( 1 )$$

However, there are two main problems with acidic electrolytes in metal-based dynamic windows utilizing ITO. The first major issue is that acidic solutions slowly degrade the ITO. ITO has good conductivity and a sheet resistance of ˜10 Ω/sq, but as the ITO is soaked in the acidic electrolyte, the sheet resistance starts to increase and will eventually become non-conductive. The second issue is that acidic solutions are more prone to evolving H₂ gas than neutral or alkaline solutions. According to the Nernst Equation, at pH 2 the thermodynamic potential for H₂ evolution is at −0.33 V vs. Ag/AgCl at pH 2, while it would be −0.62 V vs. Ag/AgCl at pH 7. This greatly increases the electrochemical window allowing for the voltage limit to be expanded.

To increase the pH of the solution, a method is needed to solubilize the Bi⁺³ ions. Chelating agents are ligands that bond metal ions, effectively “trapping” them. This would force the Bi⁺³ ions to stay in a soluble state even at higher pHs until a current is applied, and Bi metal is electrodeposited.

### Discussion

To develop a neutral electrolyte, a Bi—Cu electrolyte previously reported by Hernandez et al. containing Cu(ClO₄)₂, BiOClO₄, HClO₄, and LiClO₄ was used as the baseline electrolyte composition with a chelating agent and NaOH added to increase the pH to a neutral solution.

The first electrolyte contained Cu(ClO4)₂ (5 mM), BiOClO₄ (5 mM), HClO₄ (10 mM), and LiClO₄ (1 M) at pH 2. Cyclic voltammetry (CV) was used on an ITO working electrode to test the electrochemical capabilities of these Bi—Cu electroplating solutions, while optical reversibility was monitored at 500 nm in a spectroelectrochemical cell.

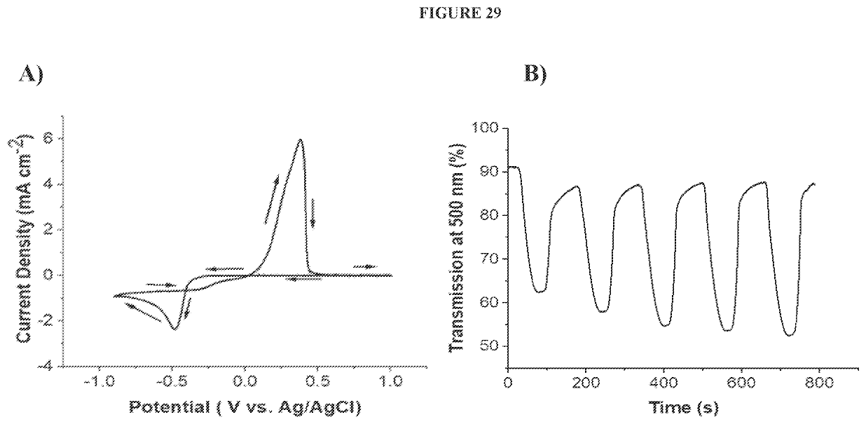

When testing the Bi—Cu electrolytes using CV, the potential was swept between −0.9 V to +1 V vs. Ag/AgCl at a scan rate of 25 mVs¹. All CVs in this work present the second cycle rather than first because the second cycle is more representative of the general electrochemical behavior of the system. During the first cycle, metal seeds may be deposited in grain boundaries and other defect sites on the ITO working electrode that affect further cycles. The resulting CV possessed a Coulombic efficiency, defined as the ratio of integrated anodic charge to cathodic charge, of 58% as well as poor optical reversibility (FIG. 29A). At potentials more negative than −0.35V, Bi and Cu electrodeposition is observed with the cathodic charge reducing Bi⁺³ to Bi metal and Cu²⁺ to Cu metal. During the first cycle of the cathodic current, the transmission is seen starting at 94% and falling to 32% due to the Bi and Cu electrodeposits (FIG. 29B). At potentials more positive than 0 V, anodic current is seen in the CV due to Bi stripping to Bi⁺³ and Cu stripping to Cu²⁺. The corresponding transmission at the first cycle shows an increase from 32% to 81% due to the stripping of the two metals. However, not all of the metal was stripped off as seen by its inability to reach its starting transmission. As there are more cycles, the incomplete stripping combined with the reduced deposition shows an electrolyte with low reversibility.

The greatest problem with increasing the pH of this electrolyte is with the Bi ions. Bi at neutral or alkaline conditions will form Bi(OH)₃, an insoluble compound. To get around this issue, the Bi ions must be bonded with something else before the pH is raised. Chelating agents allow for the metal ion to be bonded into a water-soluble complex therefore interfering with the reaction Bi has with water to form insoluble Bi(OH)₃.

Of the multiple chelating agents that were tested with the previous electrolyte, not many were soluble. Of the ones that were soluble, there was ethylenediaminediacetic acid (EDDA) and ED3A-OH. While the addition of 15 mM of EDDA was soluble, it was unable to stay soluble in slightly less acidic conditions.

Another chelating agent, N-(2-hydroxyethyl)ethlylenediamine-N,N′,N-triacetic acid (ED3A-OH), was added to bind and solubilize the Bi, while NaOH was used to increase the pH of the solution. The addition of 100 mM of ED3A-OH allowed the Bi ions to soluble and was able to stay soluble in neutral and basic conditions. Using the same parameters as the previous electrolyte, the onset potential shifted more negative, at −0.5 V for Bi and Cu co-deposition, and had lower current, showing that the addition of ED3A-OH changed the redox potential because of the formation of Bi-ED3A-OH complexes (FIG. 2A). The onset potential of the oxidation peak also shifted to be more negative, at −0.35 V, confirming that this shift is due to a change in redox species because both onset potentials shifted in the same direction.

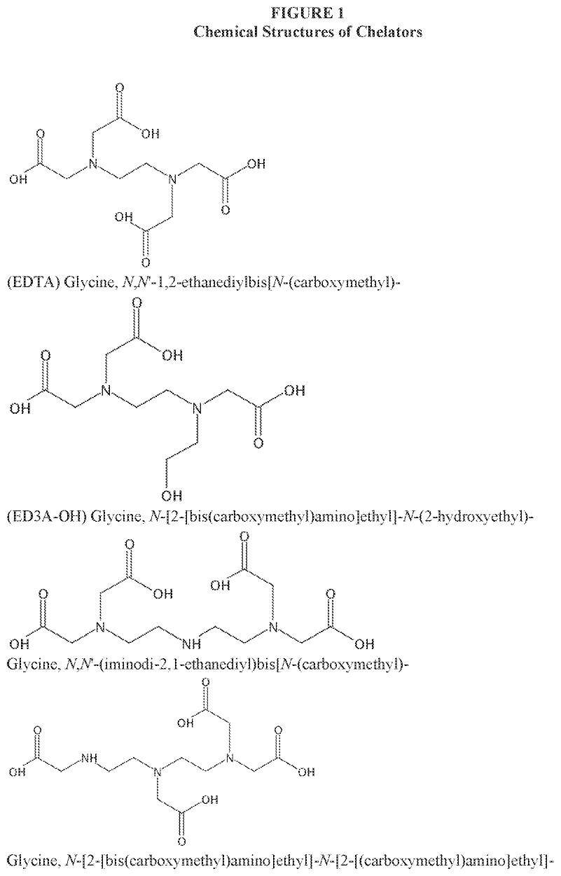

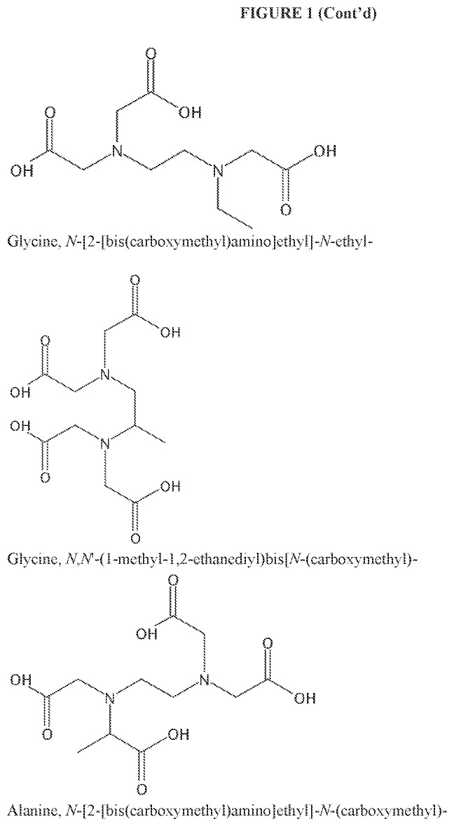

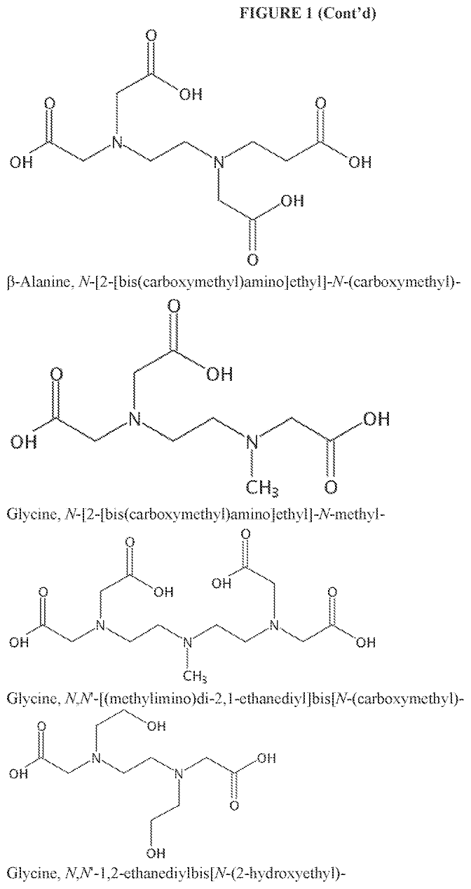

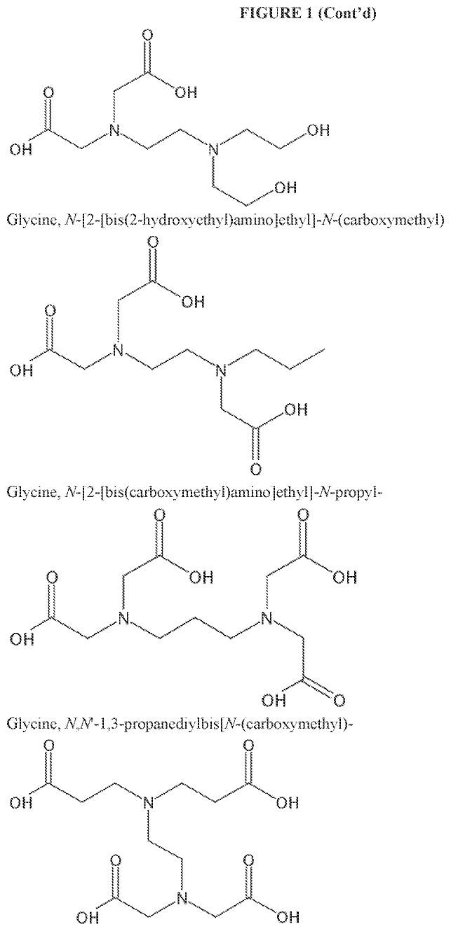

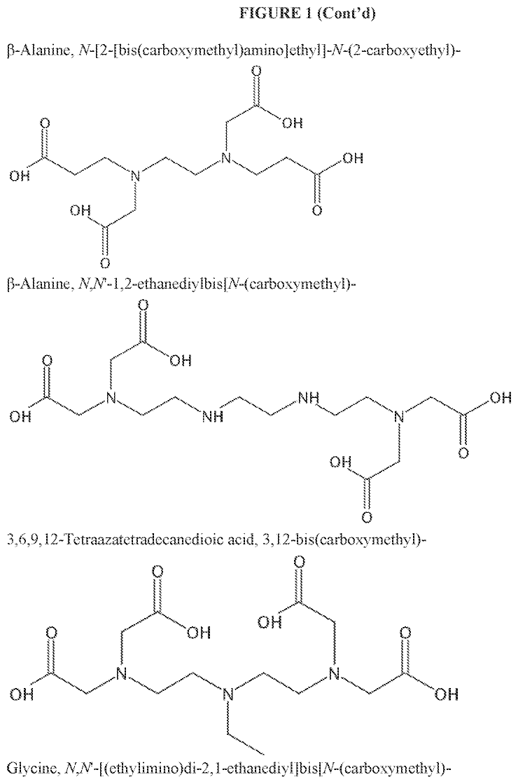

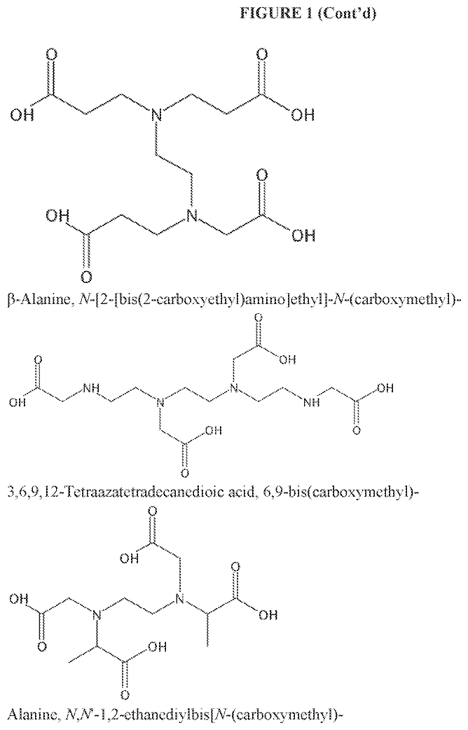

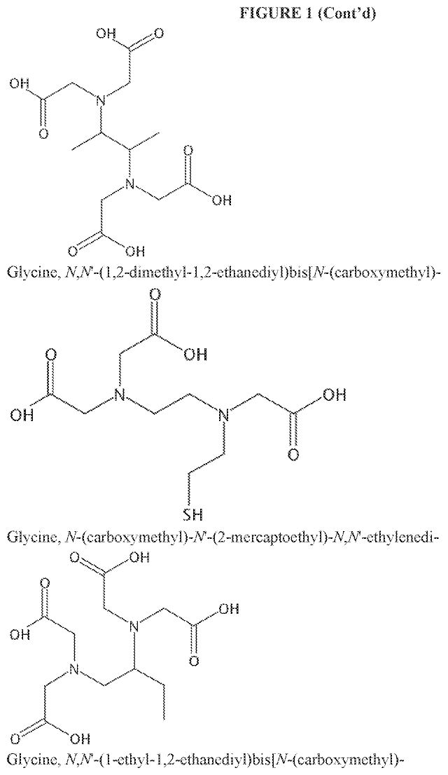

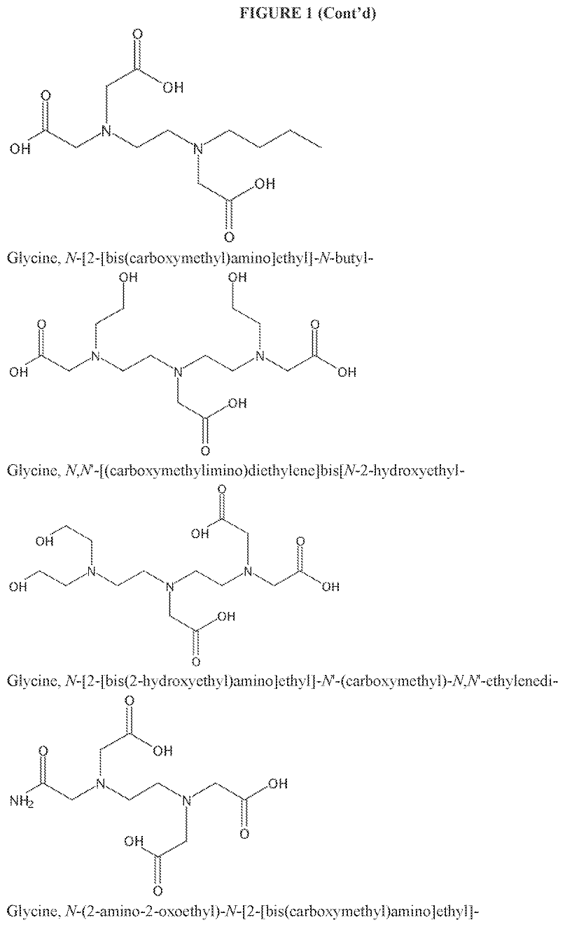

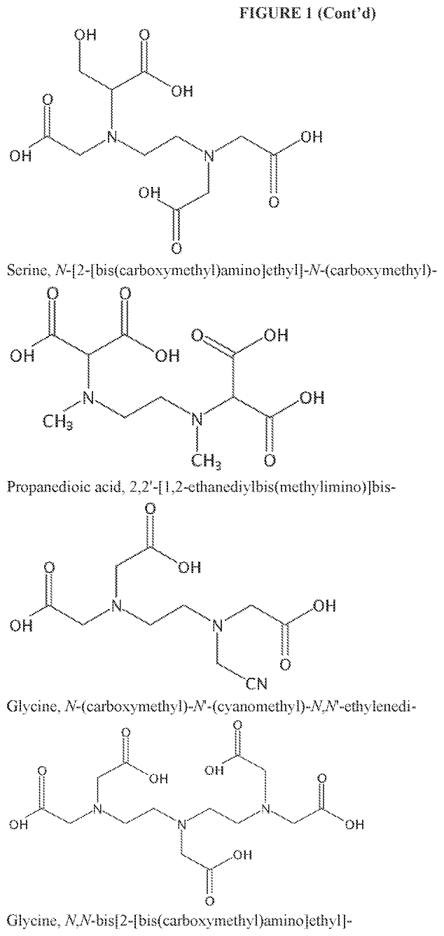

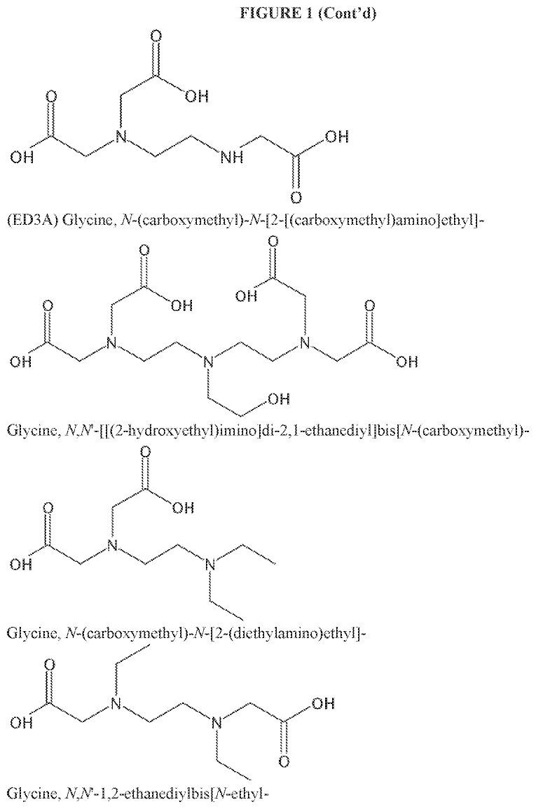

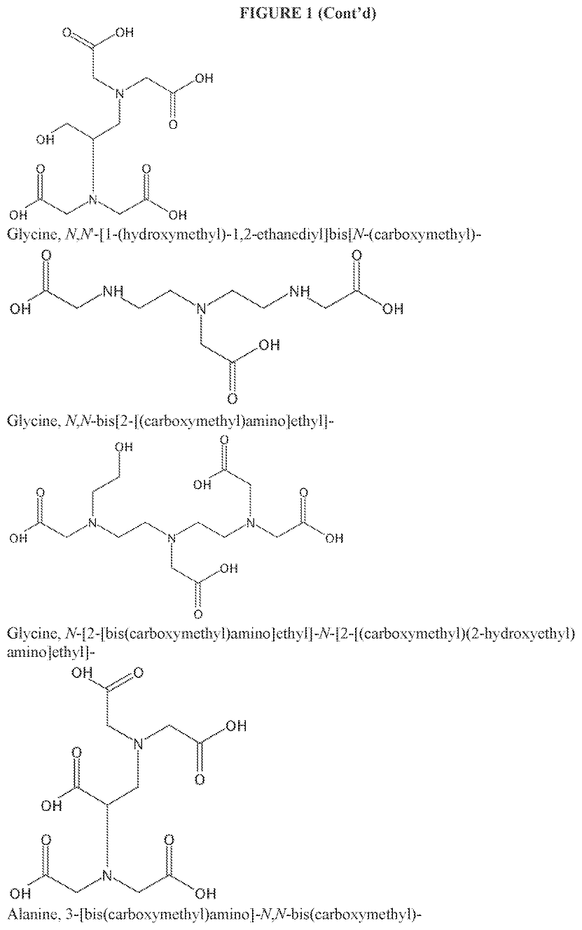

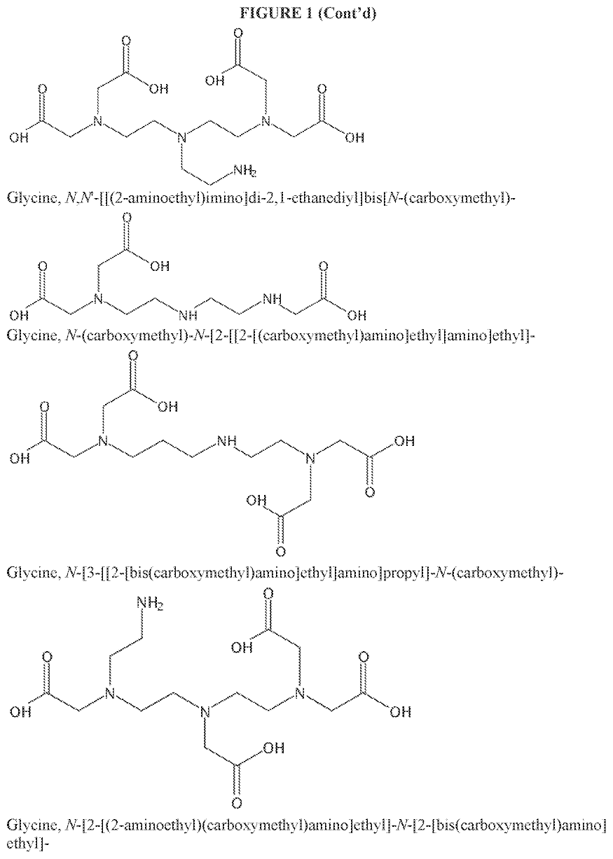

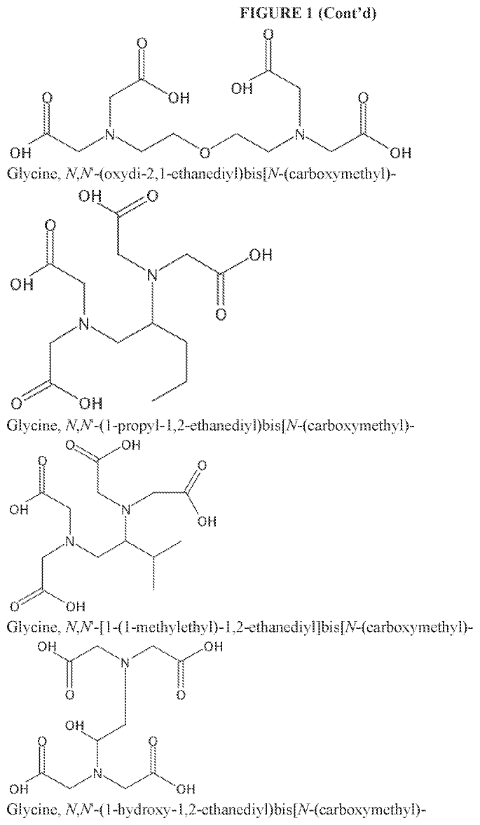

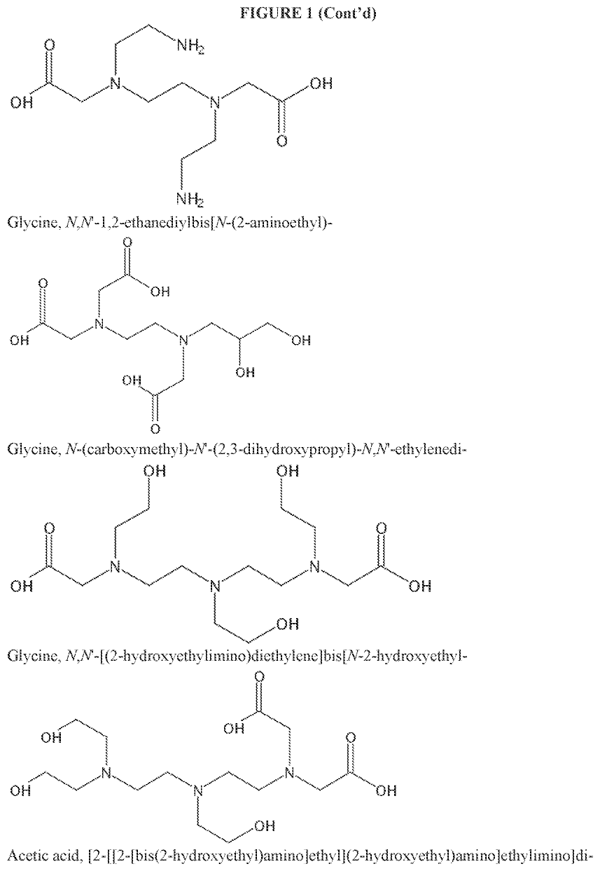

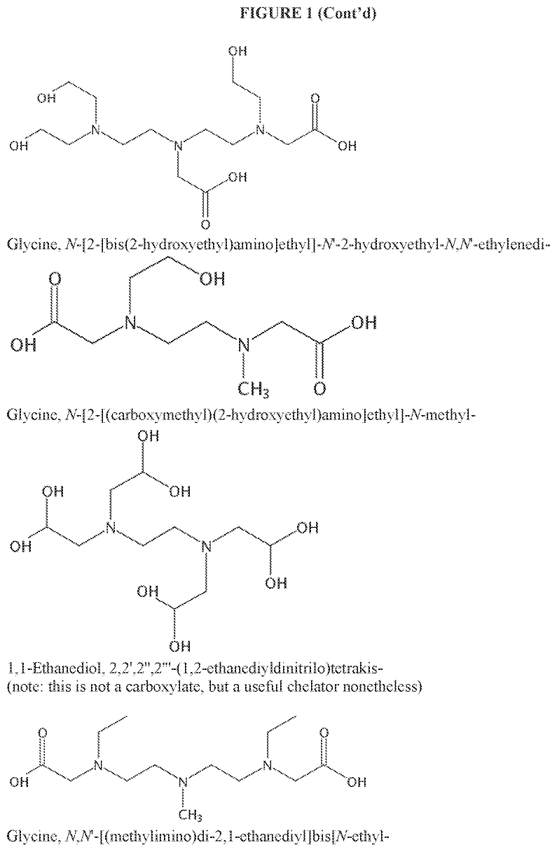

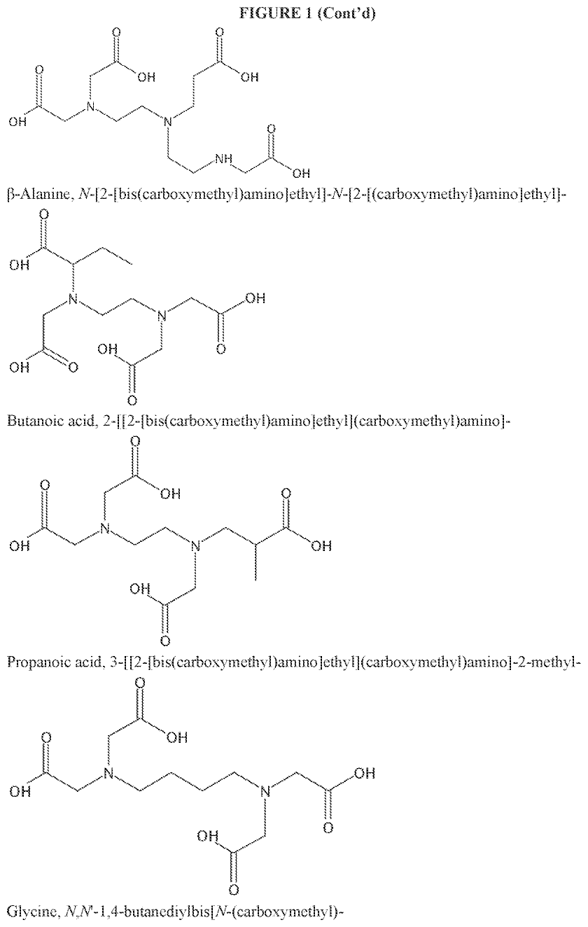

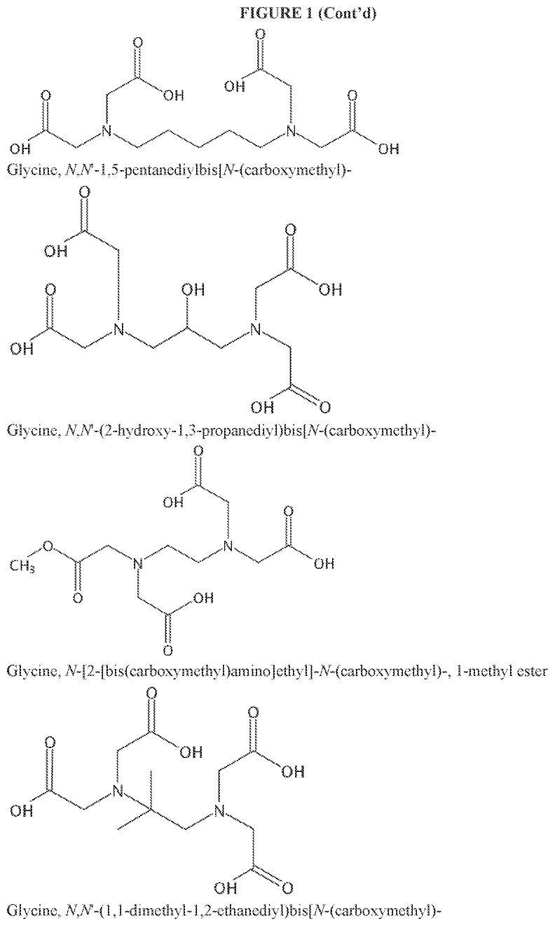

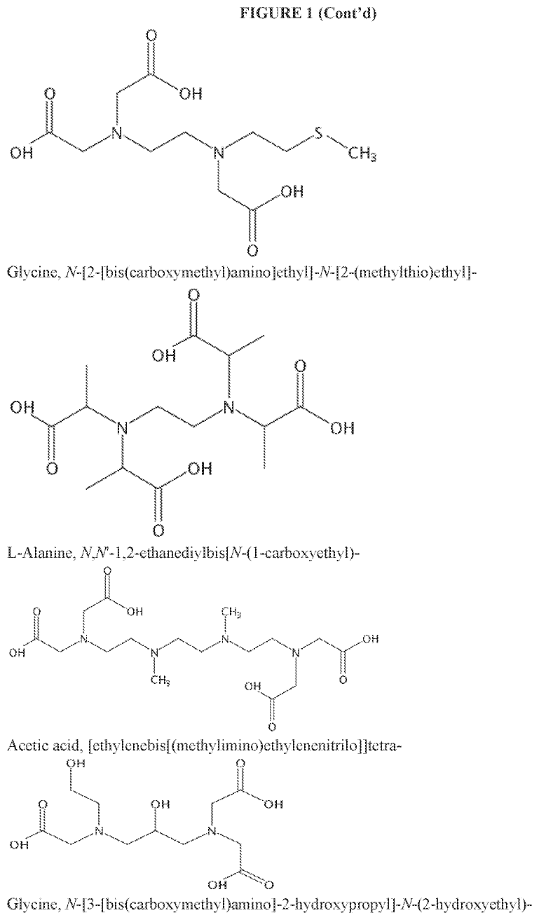

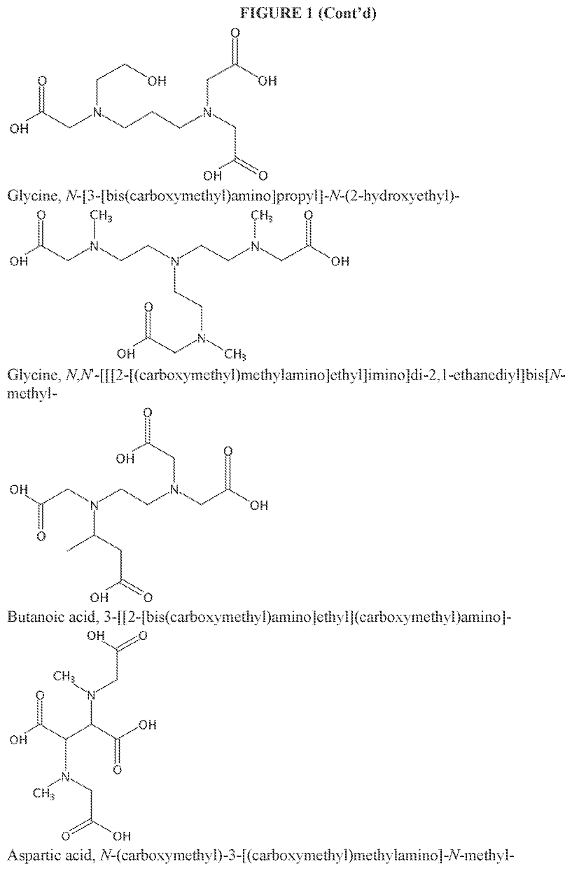

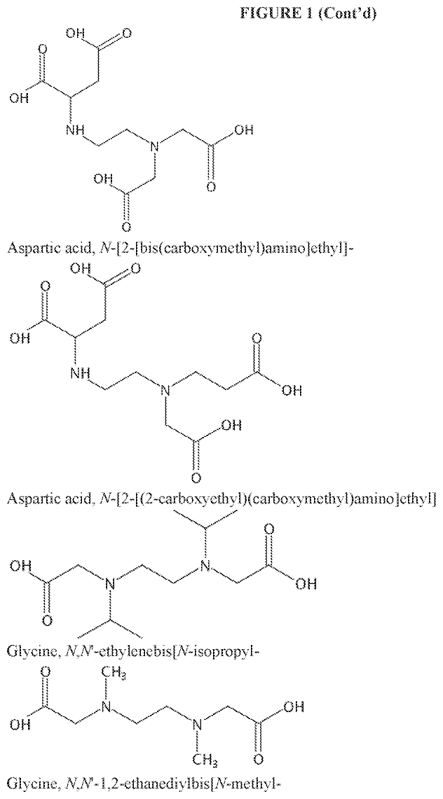

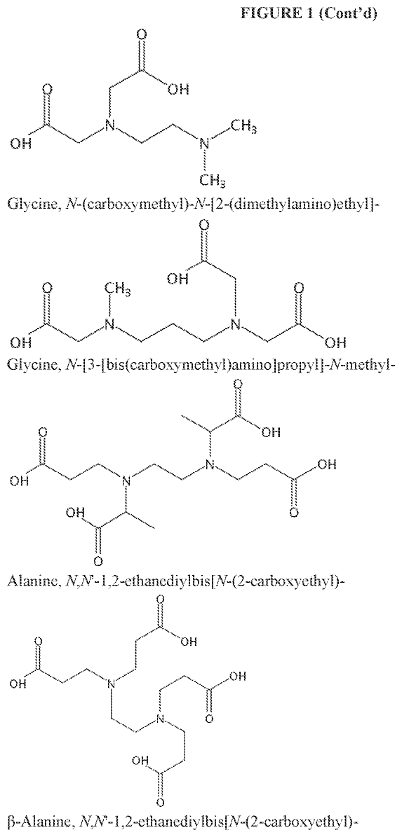

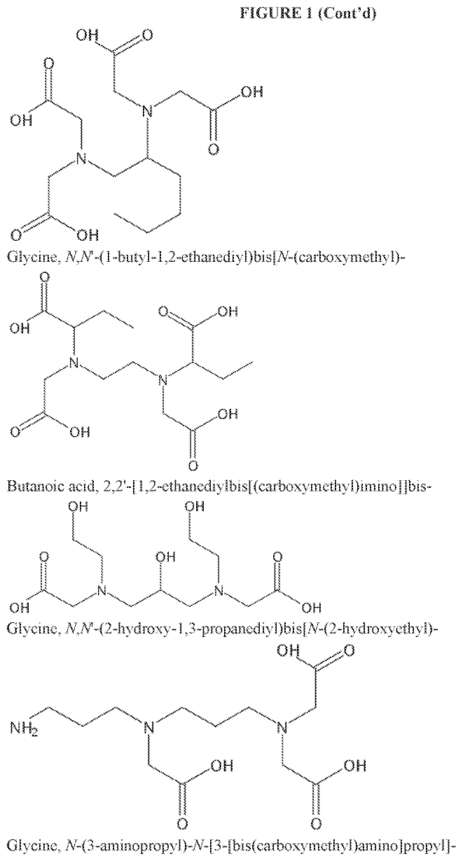

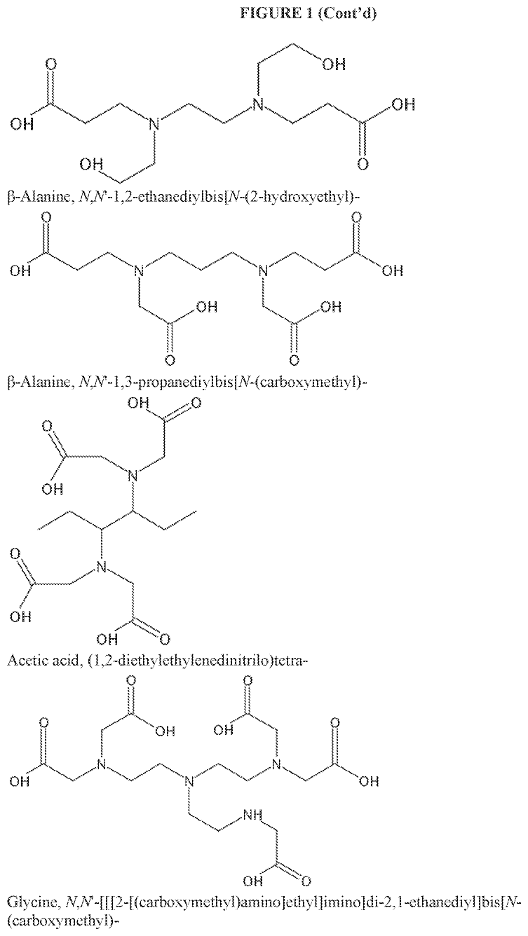

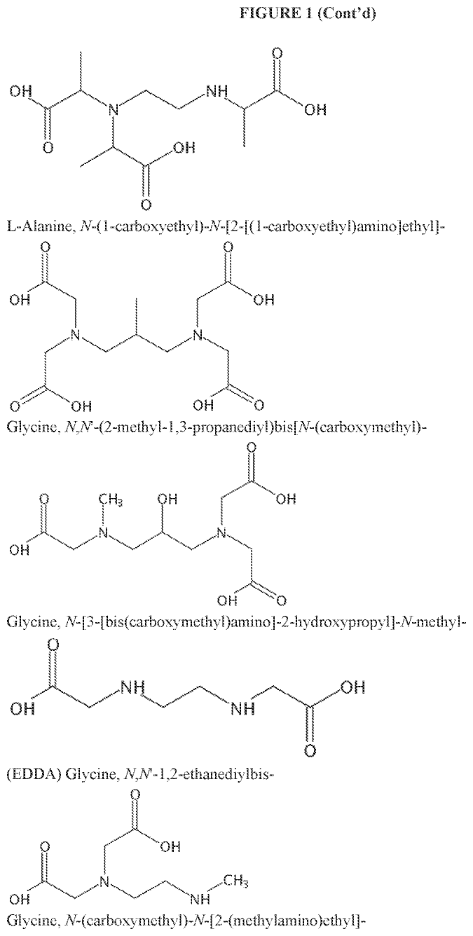

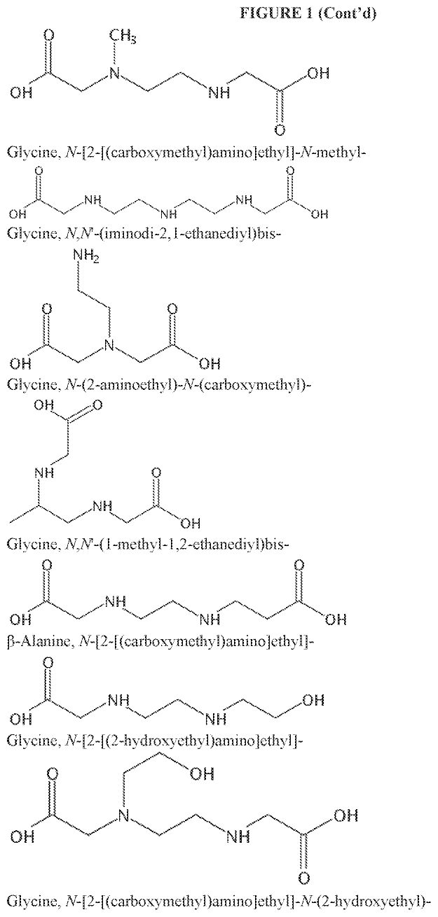

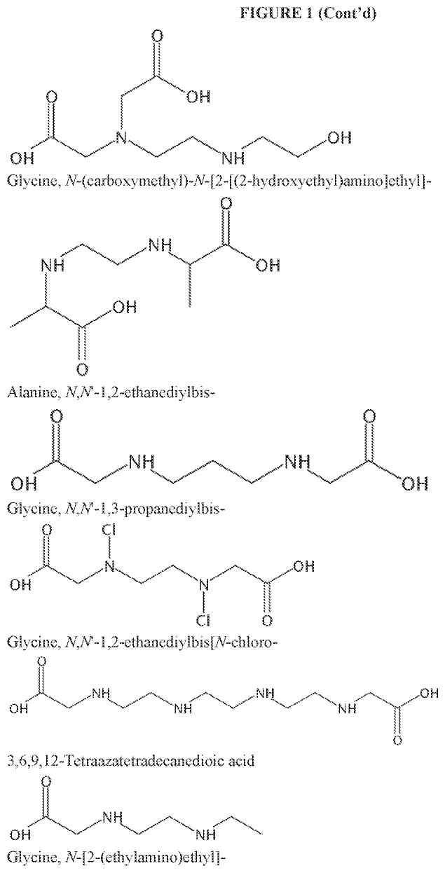

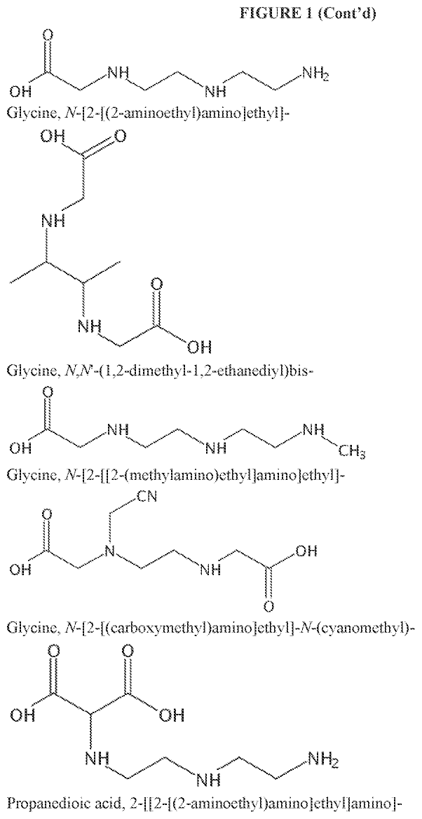

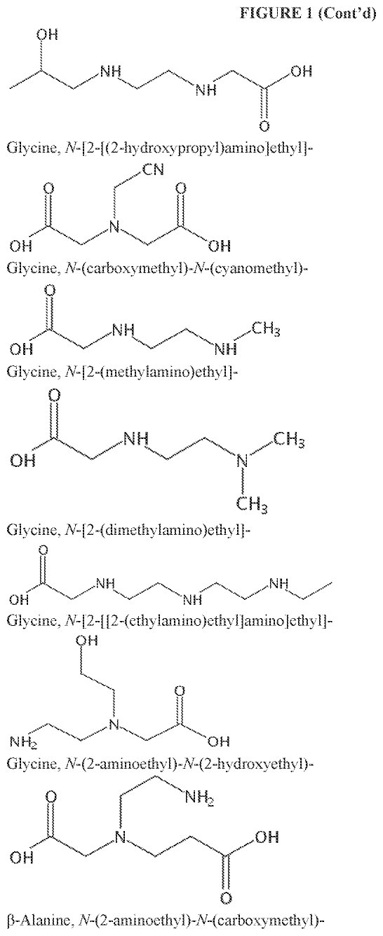

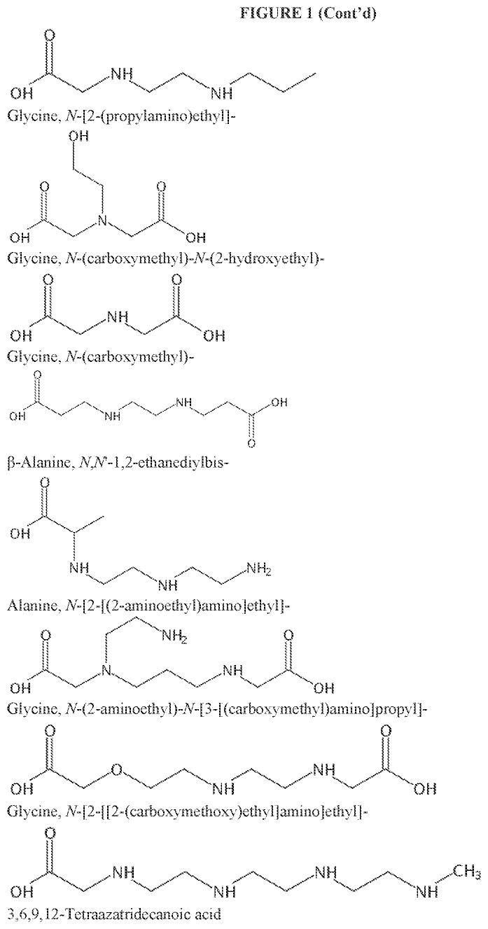

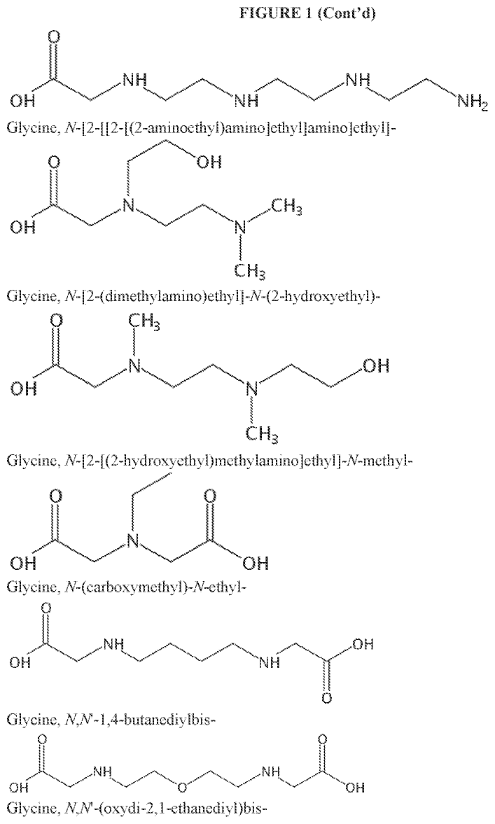

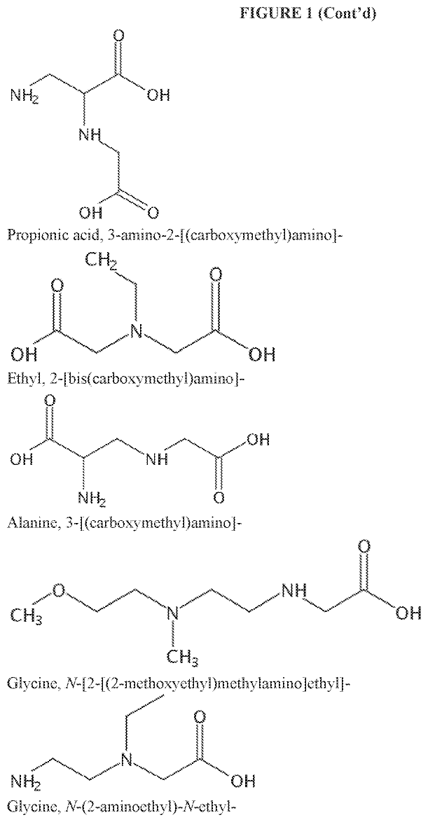

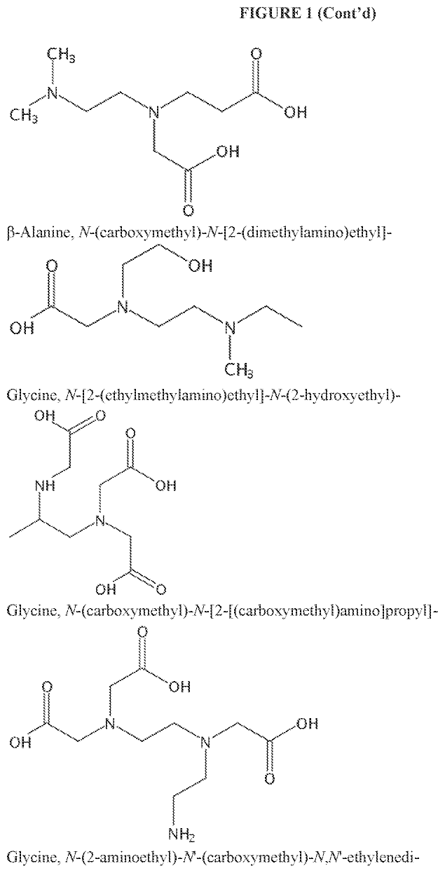

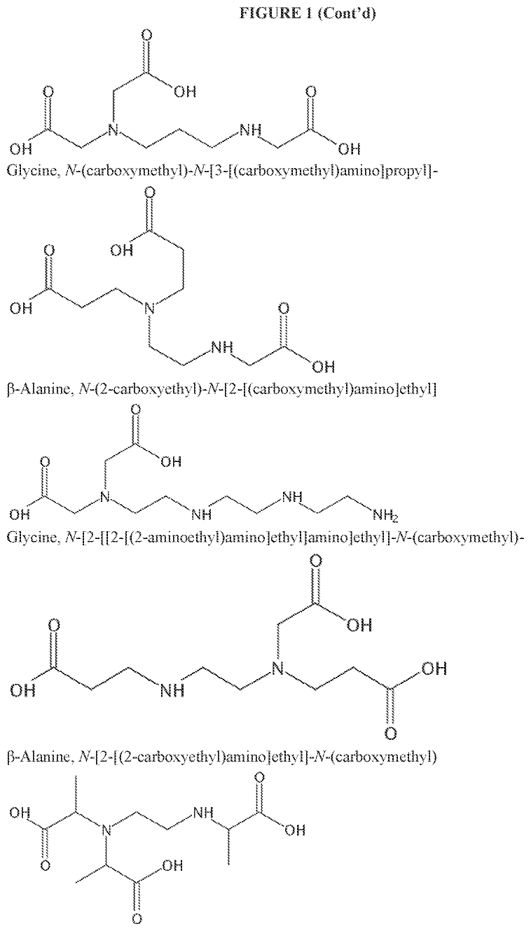

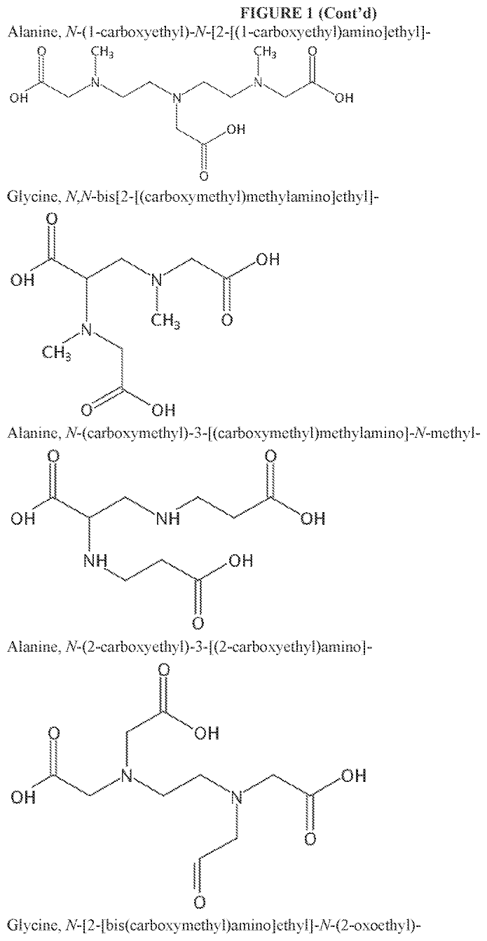

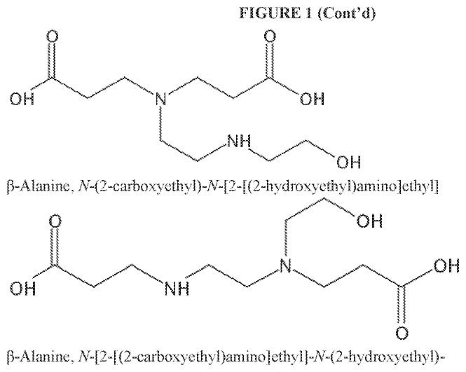

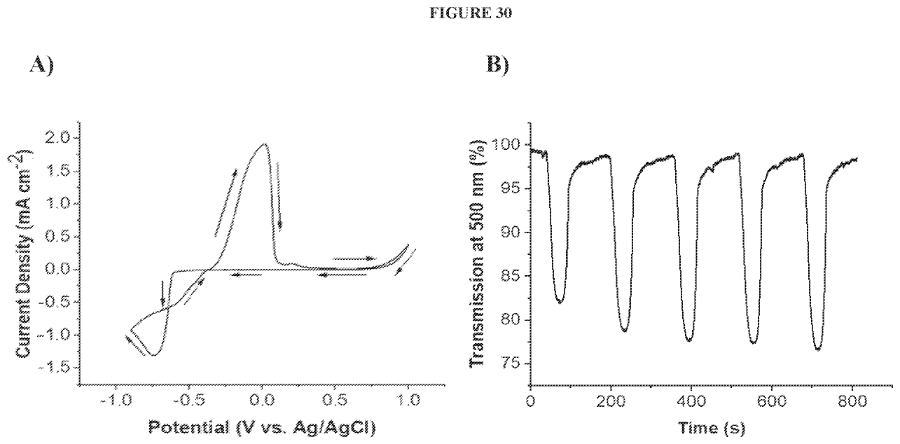

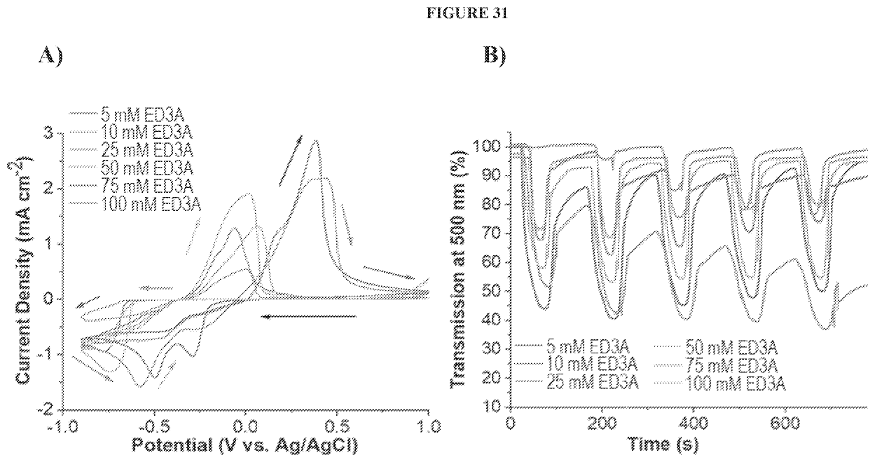

To further understand the binding nature of ED3A-OH, a systematic study of various concentrations of ED3A-OH was designed. This focused on lowering the concentration because higher amounts were insoluble. As seen with FIG. 30, the current density of electrolytes with ED3A-OH is lower than those without ED3A-OH. In both the 5 and 10 mM ED3A-OH, there is no left shift, but a very clear indication of 2 peaks in 5 mM of ED3A-OH, and a slight indication in 10 mM of ED3A-OH (FIG. 31 A, black and red line). This shows a selectivity on the binding of one metal complex over another, most likely Bi⁺³ as it is the larger ion, leaving more unbound Cu in the solution. The first negative peak of the black line is at −0.28 V, possibly Cu stripping to Cu²⁺, with the second peak at −0.5V, being the same co-deposition of Bi—Cu peak as seen in FIG. 29. The 5 mM ED3A-OH (black line) also shows similar onset potential of the oxidation peak to FIG. 1, but with a slight shoulder. The 10 mM ED3A-OH has a slightly earlier onset potential of −0.1V, but a similar peak potential to FIGS. 1 and 5 mM ED3A-OH. In the corresponding transmission spectra, both the 5 and 10 mM (black and red lines) were able to reach a lower transmission, 40%, than the electrolytes with a higher amount of ED3A-OH because there was not enough chelating agent to bind all the metal ions. Metal ions that are not bound into metal complexes will be able to react more quickly as seen by the earlier deposition potential. While the 5 mM is shown to be reversible, the 10 mM was not and has a contrast of ˜23% by the 5^{th} cycle.

At concentrations at or above 25 mM ED3A-OH, the shift to the left seen in FIG. 2 is observed. We can conclude that at or above 25 mM ED3A-OH, all the metals in the electrolyte are turning into metal-complexes with the ED3A-OH causing a change in the redox potential. 25 mM (blue line) and 50 mM (green line) ED3A-OH are very similar, with the cathodic onset potential being −0.64V and −0.6V respectively. 50 mM has less cathodic current density and a more positive anodic peak than 25 mM, even though it has similar anodic onset potential as the other electrolytes at or above concentrations of 25 mM ED3A-OH. Both concentrations show a transmission with a low contrast, ˜30%, where the contrast diminishes each cycle as metal becomes less able to deposit onto the working electrode. The 50 mM electrolyte is able to reach its initial starting transmission each cycle due to its larger current density while the 25 mM electrolyte stagnates in its reversibility. The concentration with the least current density was 75 mM ED3A-OH. While having very similar onset potentials to 25 mM ED3A-OH, it has a third of its current. It shows the smallest amount of deposition compared to all the other studies. The reversibility is high, but this may be because of the small amount of metal is easier to remove than a large amount. The highest concentration, 100 mM ED3A-OH (yellow line), is surprisingly similar to 5 mM ED3A-OH (black line) in transmission despite the difference in CV. Compared to the other “high” concentrations of ED3A-OH, it has the most cathodic and anodic current density. The transmission, while not reaching the same level of deposition, has similar reversibility and higher consistency. Of all these solutions, 5 mM and 100 mM ED3A-OH has the best deposition and reversibility, however only 100 mM has the change in redox species. Therefore, 100 mM is the better option to go forward with.

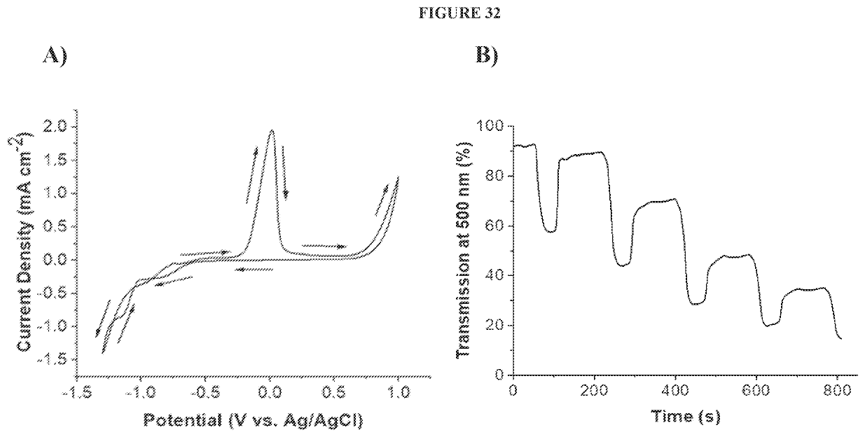

An addition of 1 wt. % of PVA was added to the electrolyte from FIG. 30 to increase the speed and change the morphology of the metal electrodeposits. With this addition, the voltage range had to be increased to −1.25 V from −0.9 V to initiate deposition. Onset potential begins at (−0.75) V and deposition begins at −1 V, where the first cathodic peak starts. When the CV sweeps back around, there is a small bump at −0.5 V that is most likely due to the addition of PVA (FIG. 32A). This reaches the same current density as former electrolytes without the PVA. There is an oxidation peak at 0.01 V, slightly shifted right compared to FIG. 30. There is also a significant peak starting at (0.6) V signifying oxygen evolution reaction (OER). Metal oxidation is kinetically favored, but past +0.57 V, OER is thermodynamically favored. With the creation of more oxygen, the metals become insoluble metal oxides, harming its reversibility. The corresponding transmission showed an electrolyte that is slightly reversible, but unable to strip off the metal from the working electrode (FIG. 32B). The addition of more metal ions would allow for more metal to be deposited on the working electrode, increasing the opacity.

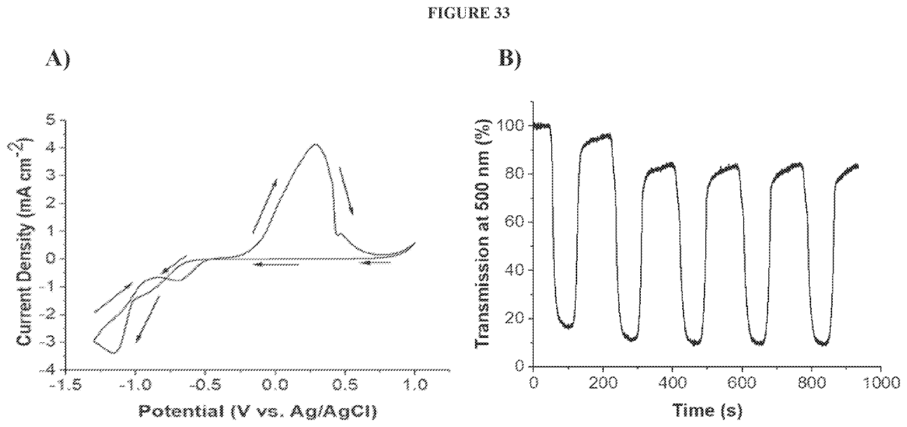

The maximum concentration of metal ions found was at 18.5 mM of Cu(ClO₄)₂ and 18.5 mM BiOClO₄. The onset potential begins around −0.5 V and deposition once again starts at −1.0 V and when swept back around, we see the PVA peak at ˜-0.68 V. The oxidation peak has shifted to the right compared to FIG. 32 to 0.3 V with a slight shoulder to the right and a much smaller OER peak. The corresponding transmission spectra shows a highly reversible electrolyte with a contrast near 80% (FIG. 33B). The addition of PVA increased the uniformity of the Bi—Cu layer, allowing for a more thorough coverage of the ITO with higher opacity.

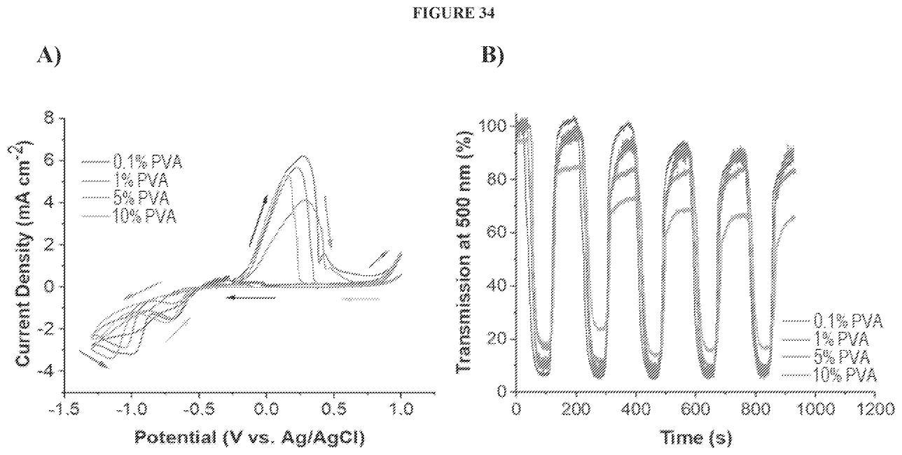

Next, the amount of PVA was systematically studied at concentrations of 0.1 wt. %, 1 wt. %, 5 wt. %, and 10 wt. %. All these additions have the PVA peak ˜−0.7V with the backward sweep. They all start onset deposition at slightly different potentials with 0.1% at −1.3V, 1% at −1.5 V, 5% at −1.15 V, and 10% at −1.2 V. The oxidation peaks shift more left with the addition of PVA. It starts off with 0.1% having a peak at 0.27 V, 1% at 0.27 V, 5% at 0.22 V, and 10% at 1.4V (FIG. 34A). It generally follows the trend of increasing the amount of PVA increasing the amount of current in deposition peaks and decreasing the amount of current in the oxidation peaks, with 1% PVA being a slight outlier. 1% PVA has the most cathodic current, the least anodic current, and no OER tail. The transmission spectra show that 0.1% and 5% PVA had the best reversibility with a contrast of 85% by the 5^{th} cycle, while 1% PVA fared slightly worse with a contrast of 74% by the 5^{th} cycle.

The addition of 10 wt. % PVA does not have a sharp decline when deposition starts unlike the other PVA studies (FIG. 34, green line). It includes the PVA peak near −0.75 V and has similar onset potential to the other anodic peaks but has a smaller oxidation peak in comparison. This is seen in the transmission spectra where it has the least reversibility of all the PVA comparisons (FIG. 34B, green line). At this point, the electrolyte has become too saturated with PVA where it will slow down the electrolyte instead of helping it.

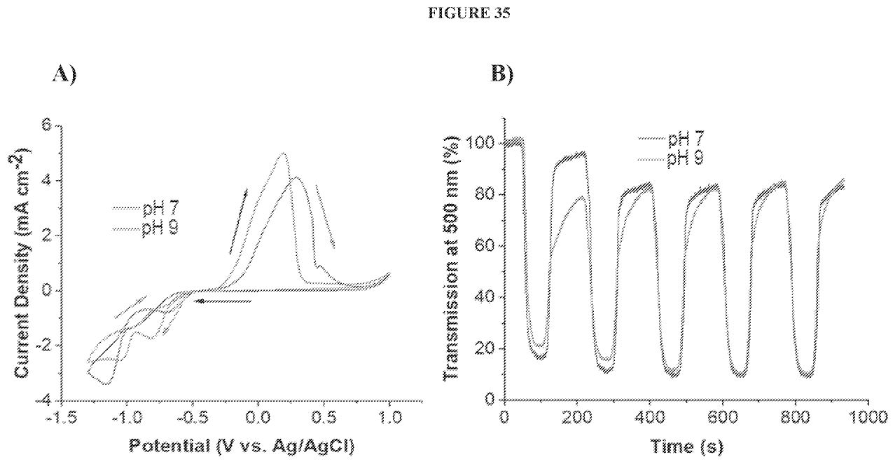

To further study the electrolyte from FIG. 33, the inventors tested it in more alkaline conditions. At pH 9, this electrolyte has the −(0.75)V peak in the forward cathodic scan, instead of the backward sweep, as well as having an earlier deposition peak at −0.9 V instead of −1 V along with an earlier oxidation peak (FIG. 35A, red line). This can be explained with the Nernst Equation, where an increase of pH results in the change in cell potential. Looking at the corresponding transmission spectra, a similar deposition and stripping rate to the neutral electrolyte is seen, with the more alkaline electrolyte having a slower stripping rate but reaching the same maximum stripping height as the neutral electrolyte (FIG. 35B).

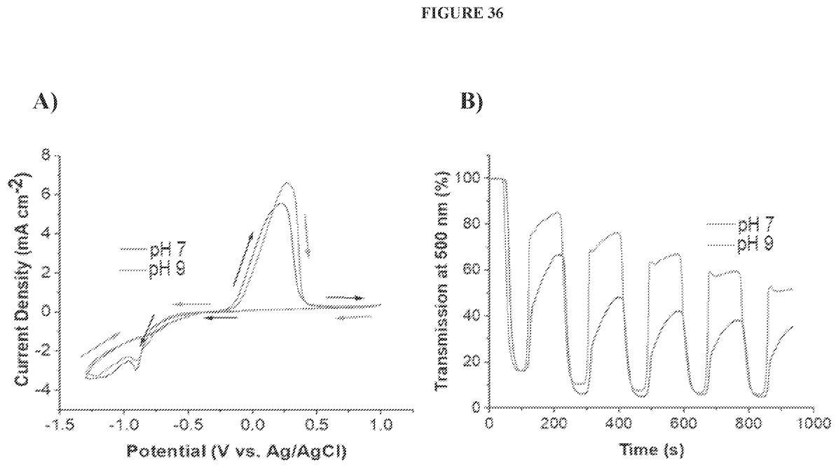

Another possible working electrode we could test is tin-doped fluorine oxide (FTO). It is another transparent thin film with good conductivity. To keep it consistent with former test, a coating of Pt nanoparticles was also applied onto it. Using the same electrolyte as FIG. 33, experiments were conducted at pH 7 and pH 9 on Pt-FTO. The shape of the CV was very similar between the two pH's with the difference of pH 9 having slightly less current density during cathodic current, and higher current density with anodic current. They both have their first peak at −0.9 V followed by more deposition afterwards. Unlike the previous studies on ITO, there isn't a PVA peak around −0.7 V, indicating there is a specific PVA reaction with the ITO. The oxidative scan shows a peak at 0.22 V for the neutral electrolyte and a taller peak at 0.27 V for the more alkaline electrolyte (FIG. 36A). This taller peak greatly affects the transmission, giving it more reversibility than the electrolyte at pH 7. The corresponding transmission shows both electrolytes having the ability to reach a minimum transmission of (5)%, but a contrast of (30-50)% for the neutral electrolyte and a contrast of (50-60)% for the alkaline electrolyte (FIG. 36B).

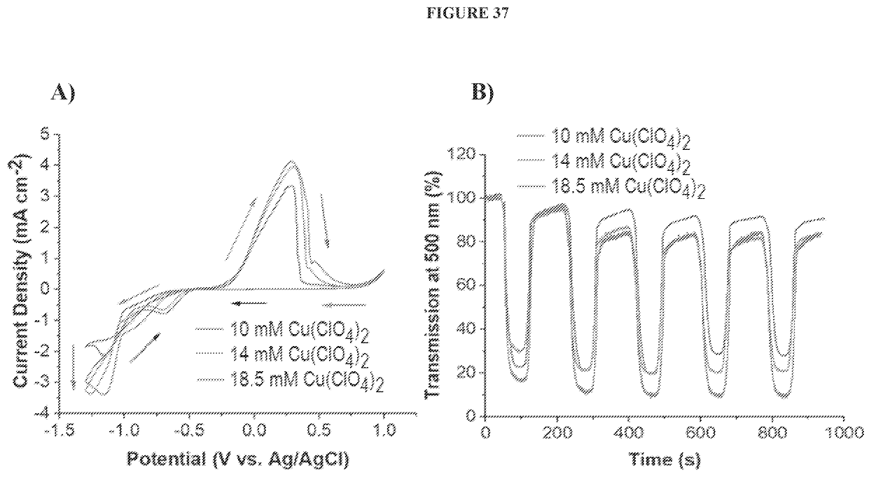

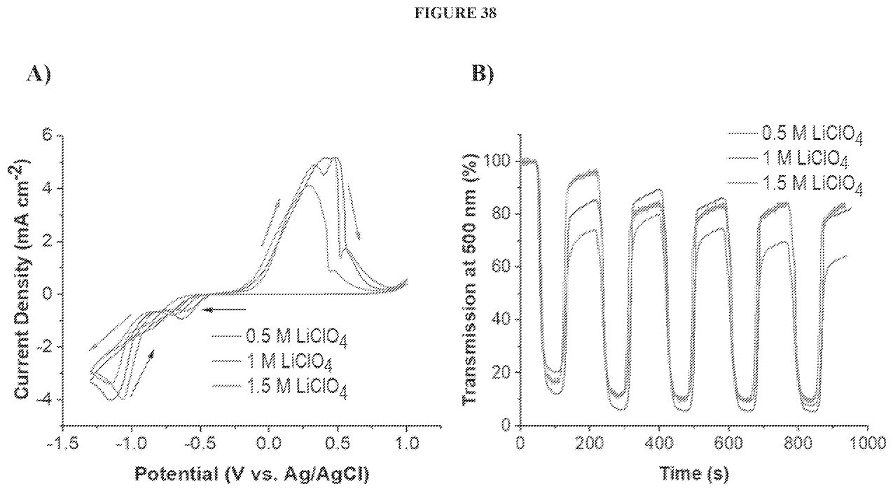

The electrolyte is a transparent blue color due to the Cu ions. Bi ions are colorless in solution and help with color neutrality thus being unnecessary to reduce. To reduce the blue color in the electrolyte we lowered the amount of Cu(ClO₄)₂ ions to 10 mM and 14 mM and compared it with the 18.5 mM from FIG. 33. Both of these electrolytes were a lighter blue color. The 14 mM Cu(ClO₄)₂ (red line) had a slightly more negative onset deposition (−1.03 V) than 18.5 mM Cu(ClO₄)₂ (−1 V) and also has less area under the curve than the 18.5 mM Cu(ClO₄)₂ (FIG. 37A, red and blue line). The oxidation sweep is similar to the 18.5 mM Cu(ClO₄)₂ with a similar onset potential and peak, but has more current limited by mass transport resulting in an earlier decline in current. It shares the same characteristic right shoulder bump as 18.5 mM Cu(ClO₄)₂. Cu is known to affect the rate of stripping of Bi electrodeposits through a Galvanic displacement reaction, which likely results in the variations in the shapes of the stripping curves with varying Cu concentration. The 10 mM Cu(ClO₄)₂ has a small amount of current, only reaching −2.1 mA cm² in the cathodic sweep compared to the electrolytes with more metal ions that reached −3.3 V (FIG. 37A, black line). The oxidative sweep has a peak around 3.3 V similar to the other 2 electrolytes, but only reached 3 mA cm⁻², lower than the other two studies. It also doesn't have the slight shoulder on the right as the other two studies show. Due to the fewer amount of metal ions in the solution to plate onto the ITO, the two electrolytes with less Cu(ClO₄)₂ were unable to reach the same darkness, only 20%, as compared to the electrolyte with more Cu(ClO₄)₂ ions, 10-17%.

To further study the electrolyte, the supporting ions were also systematically studied. LiClO₄ were studied at 0.5 M, 1 M, and 1.5 M. The cathodic sweep's shape looked similar to each other with a few differences in potential and current, but the anodic peak had slightly more differences. The smallest current density of them all was 1 M LiClO₄, with a peak at 0.28 V and 4.1 mA cm⁻². It has a right shoulder bump shared with 1.5 M (blue line), but shifted left. At 1.5 M LiClO₄ has two peaks, 0.3 V and 0.47 V with a large current density similar to 0.5 M LiClO₄. The 0.5 M LiClO₄ has one large peak with no shoulder. The transmission spectra for 0.5 M and 1 M show high reversibility with a contrast of 74-75% by the 5^{th} cycle. The 1.5 M shows slightly less reversibility with 55% contrast by the 5^{th} cycle.

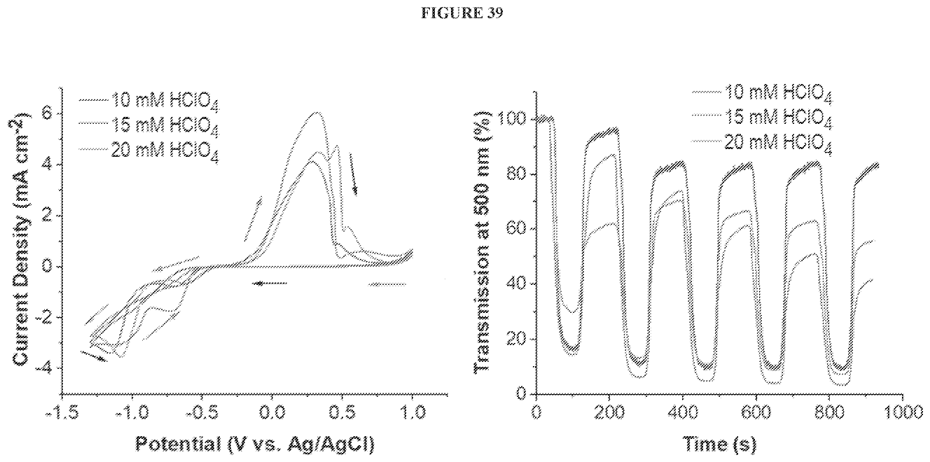

There may be too many (Li) ions in the solution, slowing down the overall kinetics. The other supporting ion, HClO₄, was studied at 10 mM, 15 mM, and 20 mM HClO₄. The addition of HClO₄ shifts peaks to the right. There isn't much difference between 10 and 15 mM cathodic current with 15 mM having more current density (FIG. 39A, black and red line). At 20 mM HClO₄, there is higher current density and a larger PVA peak at −0.7V (FIG. 39A, blue line). In the oxidative scan, 15 mM has two peaks, one at 0.3V and the other at 0.46V, and a shoulder at 0.54V. The 10 mM and 20 mM has one peak, 0.28 V and 0.3 V, respectively, but at 20 mM has more current with its peak reaching 6 mA cm². The right shoulder for 10 mM is at 0.47V, while for 20 mM the right shoulder is very broad. In the transmission spectra, 20 mM had the most deposition, reaching 4%, but it isn't highly reversible. While 15 mM doesn't reach the same amount of deposition, it has slightly better reversibility. The most consistent reversibility comes from 10 mM HClO₄ and has a steady contrast of 75% past the second cycle (FIG. 39B). Of the tested electrolytes, 10 mM shows the most promise.

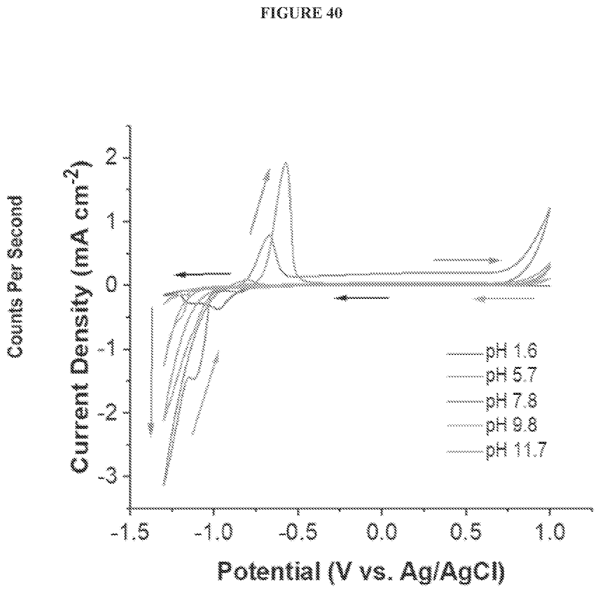

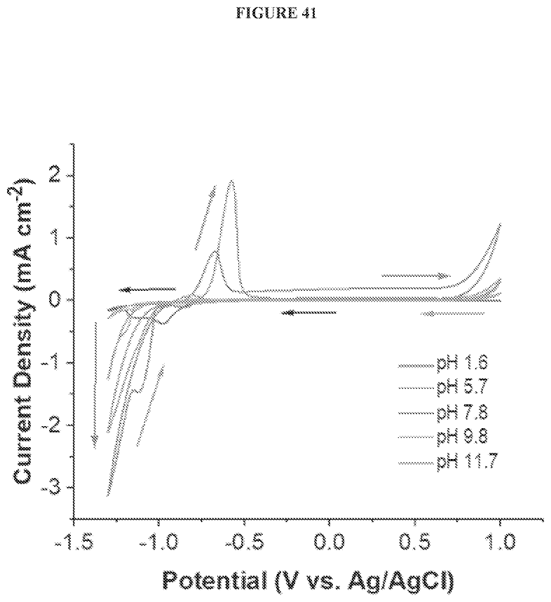

To investigate the electrolyte further, it was tested without any metal ions at multiple pHs. The first investigation was without PVA to test the solution without the extra polymeric effect. There was little deposition current seen for the electrolytes at pH 1.9, 7.6, and 11.7, but both pH 5.3 and 9.1 had some amount of current starting past −0.9V (FIG. 40). This is most likely indium peaks from stripping indium from the ITO. Shown from earlier FIGURES, the potential was only needed to reach to −0.6 V for deposition to start and swept back around at −0.9V. The anodic sweep shows the resulting ITO oxidation peak as well as showing OER happening near 0.64 V.

The same electrolytes with an addition of PVA shows the difference the polymeric affect brings. Other than pH 9.8, the different pH electrolytes had significant amounts of current density during cathodic current. This once again is the ITO stripping, however there is a noticeable shoulder that wasn't there before. Not only that, it shows pH 7.8 having the most current, reaching 3 mA/cm². With the anodic sweep, we see the coinciding peaks for those with deposition peaks other than the electrolyte at pH 1.6. It also shows a decrease in OER in all the electrolytes except for pH 7.8.

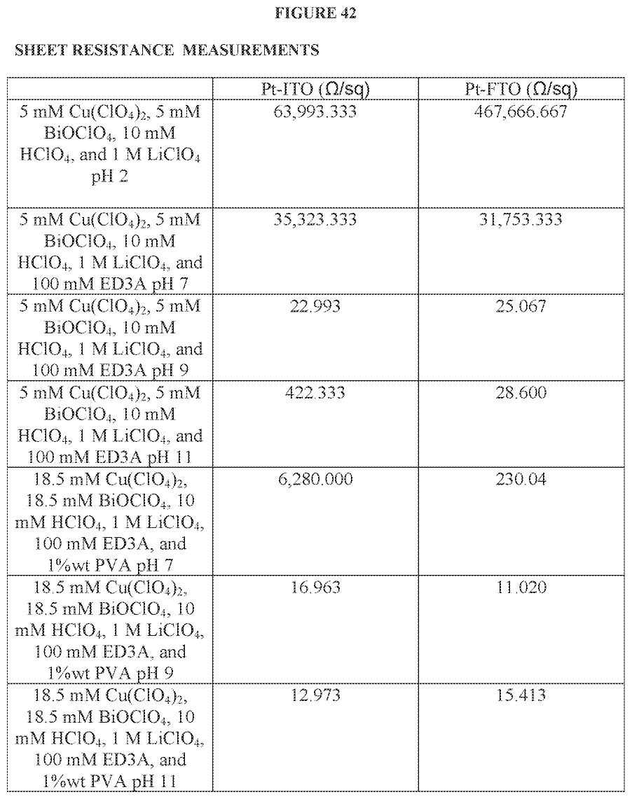

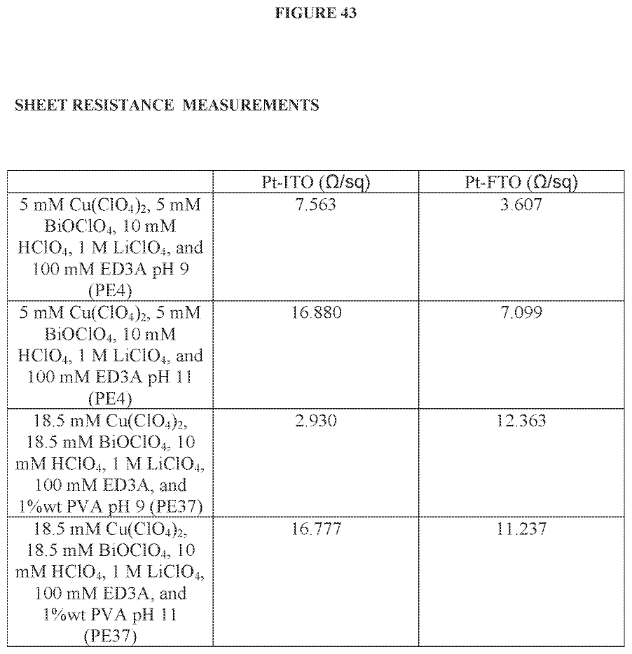

In acidic conditions, ITO will be etched, leading to an inoperable working electrode. To measure how fast it degrades, a four-point probe is used to measure the sheet resistance of the Pt-ITO and Pt-FTO. To test the different electrolytes, pieces of the working electrode were left to soak in the electrolyte within an 85 C oven. Leaving it in an 85 C oven for a month simulates the effect of soaking the electrode in the electrolyte for a year at room temperature. Electrolytes were tested at different pH levels (2, 7, 9, and 11) and with and without the addition of PVA. Both Pt-ITO and Pt-FTO with no soaking started around 5-25 Ω/sq. After the first week, solutions at or below the pH of 7 had a resistance in the k Ω/sq while those with a pH at or above 9 were all within the Ω/sq range (FIG. 42). Having a range in the k Ω/sq would mean that the electrode could no longer conduct electrons, rendering the device that electrolyte is stored in useless. The electrolyte at pH 2 has particularly high sheet resistance compared to the pH 7 electrolytes demonstrating that a lower pH degrades the electrode at a faster rate.

To prove that the electrolytes would survive at least a year at room temperatures, the same test was performed after a month on the surviving electrolytes from the last test. All of electrodes fared excellently, with all of them staying within the initial ranges of the Pt-ITO and Pt-FTO. This establishes that electrolytes that are acidic or neutral would not be able to last long-term and that we should be moving towards more basic electrolytes.

### Additional Chelators Zinc-Bismuth-Copper Electrodeposition Examples

Bi Electrolytes with ED3A-OH and EDDA without Perchlorate

While the bismuth perchlorate solutions were the most studied electrolyte, there are other promising bismuth electrolytes that could be used. These electrolytes also use chelating agents to retain Bi solubility at neutral conditions.

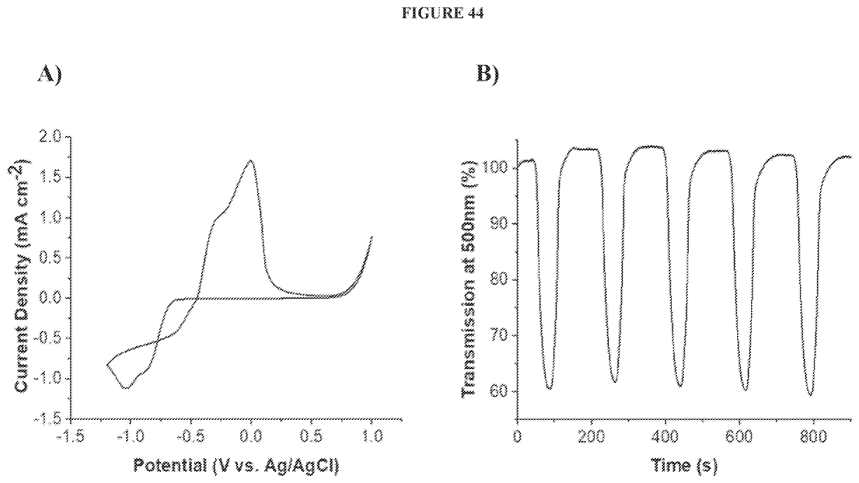

A simple electrolyte containing 60 mM BiCl₃ and 60 mM ED3A-OH was tested. The potential was swept between −1.2V to +1.0V vs Ag/AgCl at a scan rate of 25 mVs⁻¹. There is an onset potential at −0.6V and a deposition peak near −1.1V, signifying Bi metal deposition, and a stripping peak at +0V with a slight left shoulder, signifying Bi metal stripping (FIG. 44A). The corresponding optics show a steady contrast of 40% with an ability to completely strip off all the metal after each cycle (FIG. 44B).

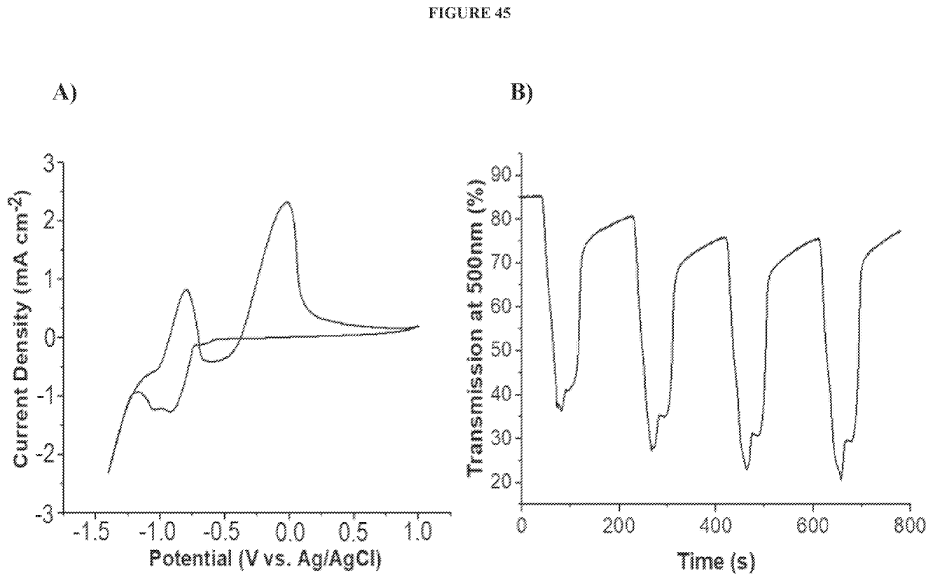

Another electrolyte using BiCl₃, showed greater promise. This time instead of ED3A-OH, EDDA was used in the same ratios. The potential was swept between −1.4V to +1.0V vs Ag/AgCl at a scan rate of 25 mVs¹. The electrodeposition around −1.0V consists of two small peaks and the potentials greater than −1.2V is hydrogen evolution. The oxidative sweep has 2 oxidation peaks, one at −0.8V and the other at 0V, corresponding to the two jumps in oxidation in the transmission spectra (FIG. 45). This showed a greater amount of deposition for the Bi compared to the ED3A-OH, also seen with a greater amount of current density, possibly because EDDA binds less tightly than ED3A-OH allowing for a quicker transition between Bi-EDDA→Bi metal. Its contrast increased as the cycles continued starting from 43% and ending at 56% contrast (FIG. 45B).

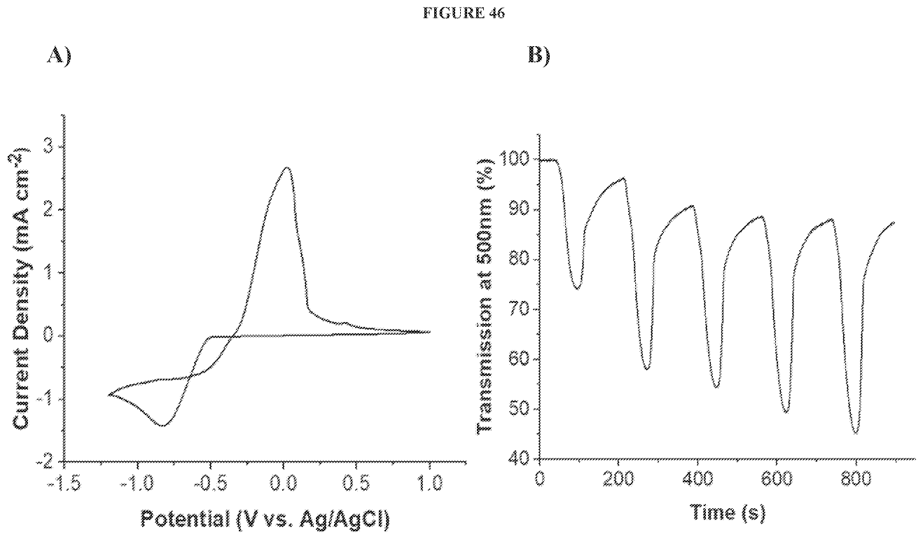

In an attempt to increase its reversibility, the electrolyte increased its concentration of chelating agent and added CuCl₂. This electrolyte contained 60 mM BiCl₃, 150 mM EDDA, and 5 mM CuCl₂ and the potential was swept between −1.2V to +1.0V vs Ag/AgCl at a scan rate of 25 mVs⁻¹. A combination of Bi and Cu metal electrodeposition starts past −0.5V with a peak at −0.8V. The oxidative peak is at 0V showing Bi and Cu dissolution (FIG. 46A). The corresponding transmission shows a small amount of deposition in the first cycle than resulting cycles because of the lack of metal seed nucleation sites that form after the first cycle. After each cycle, there is a greater amount of deposition, but each cycle is able to strip back to >87% transmission (FIG. 46B).

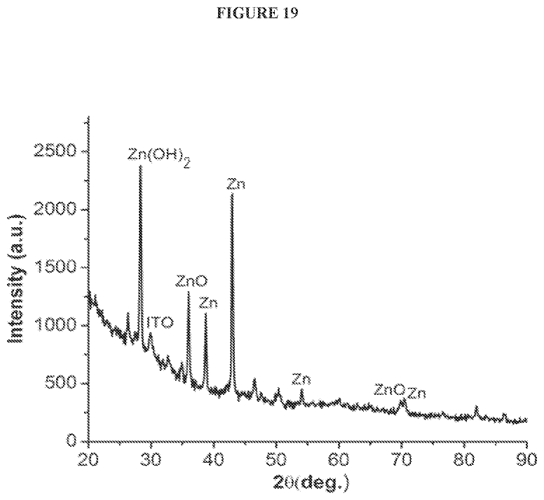

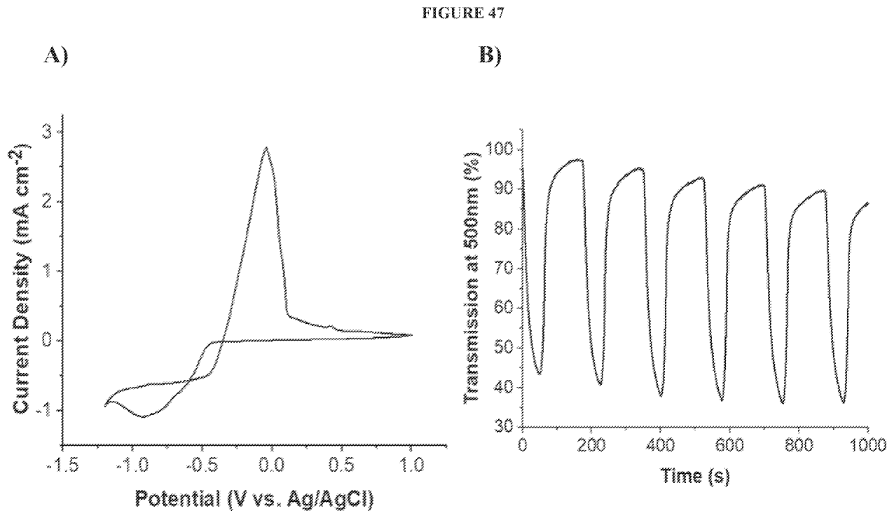

In another attempt to increase reversibility, we used LiBr instead of CuCl₂ for an electrolyte that contained 60 mM BiCl₃, 150 mM EDDA, and 100 M LiBr. This potential was also swept between −1.2V to +1.0V vs Ag/AgCl at a scan rate of 25 mVs¹. The shape of this CV and the one of the FIG. 46A is very similar, with the only differences being FIG. 19A has a slight left shift of −0.06 V during onset potential with more current density and slightly more right shifted peak at +0.02V, instead of −0.03V (FIG. 47A). While the differences look minute in the CV, the differences from the constituents greatly changed the transmission spectra. The deposition starts off at 43% and gets darker each cycle, down to 36%, but also has high reversibility, able to reach 97% in the first cycle, but falls to 89% by the 5^{th} cycle. It has a Coulombic efficiency of 64.7%, showing that there are side reactions happening and hampering reversibility.

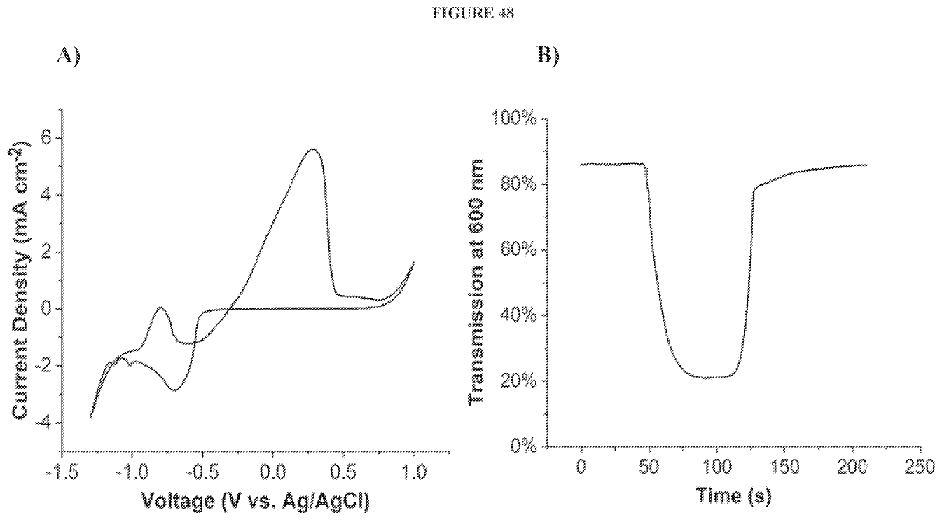

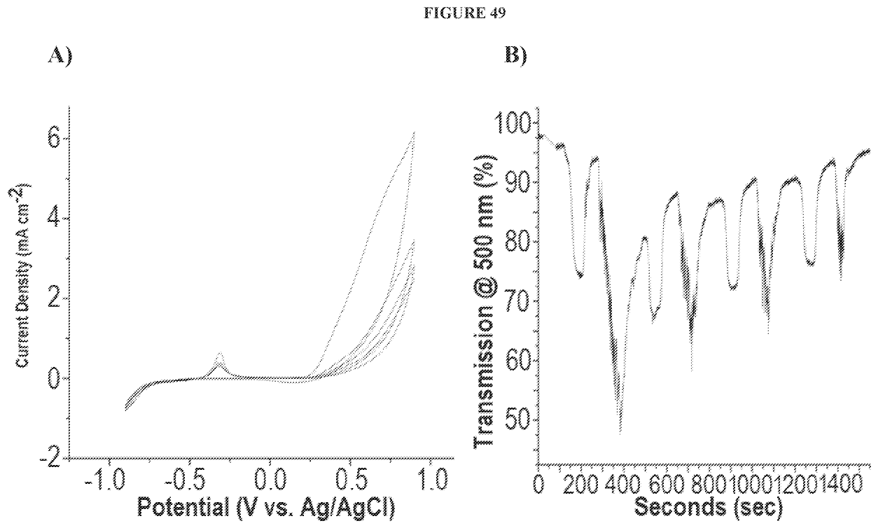

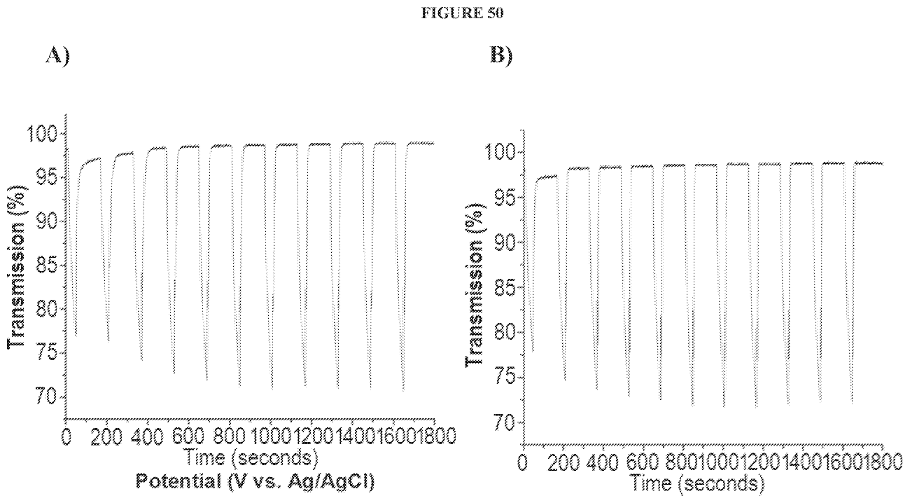

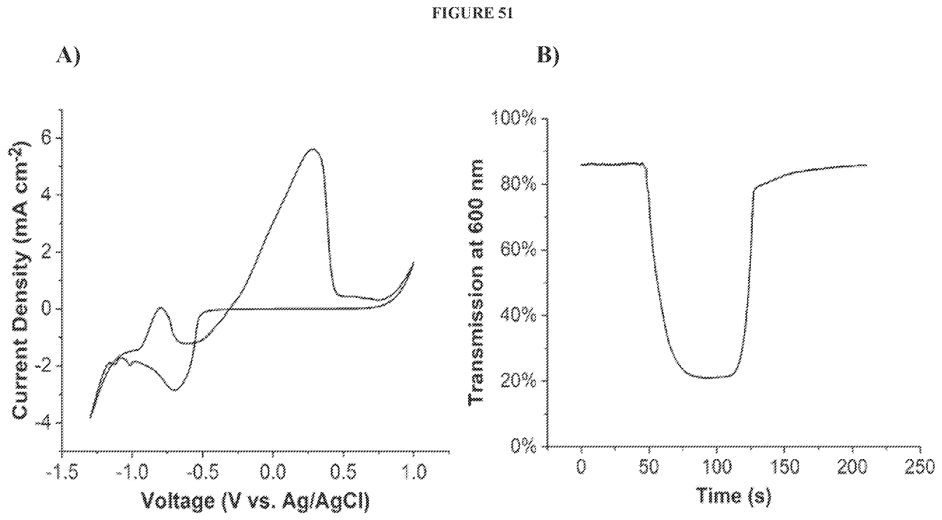

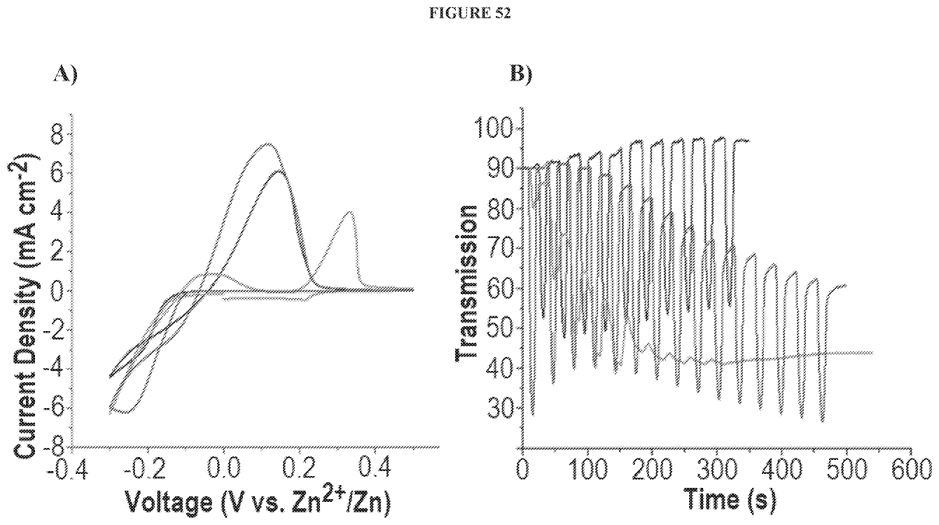

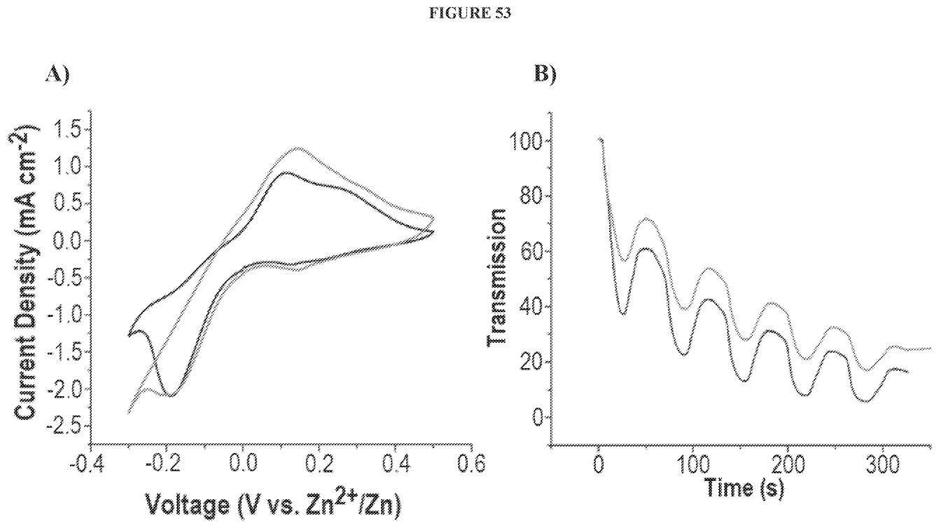

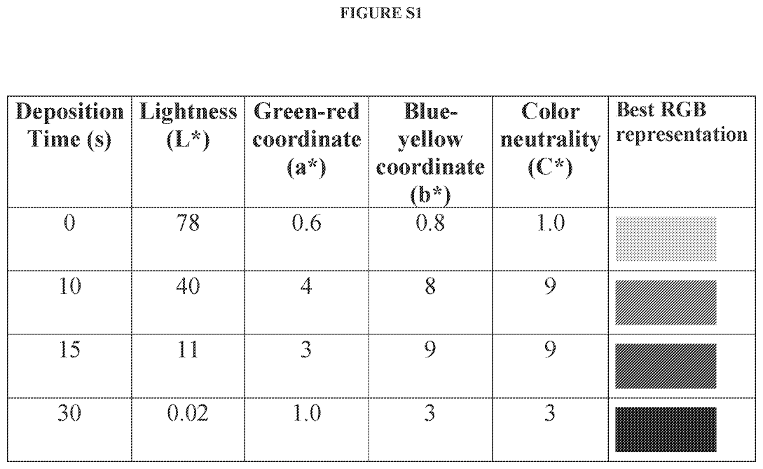

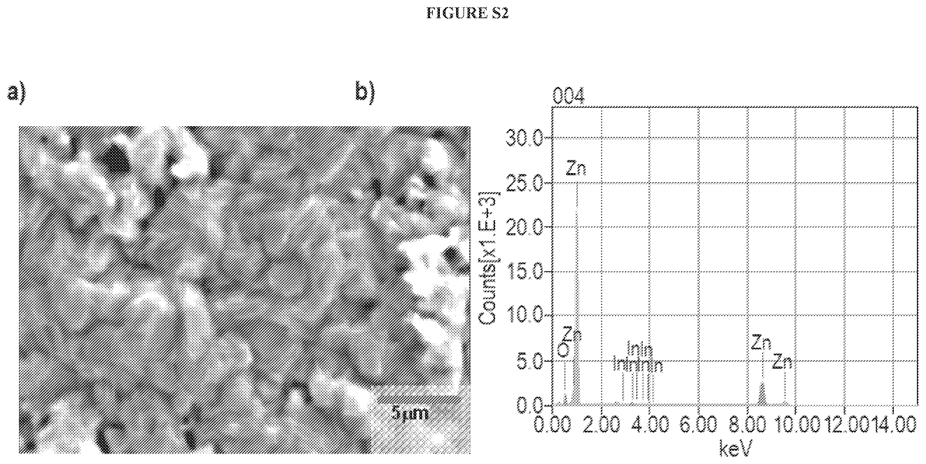

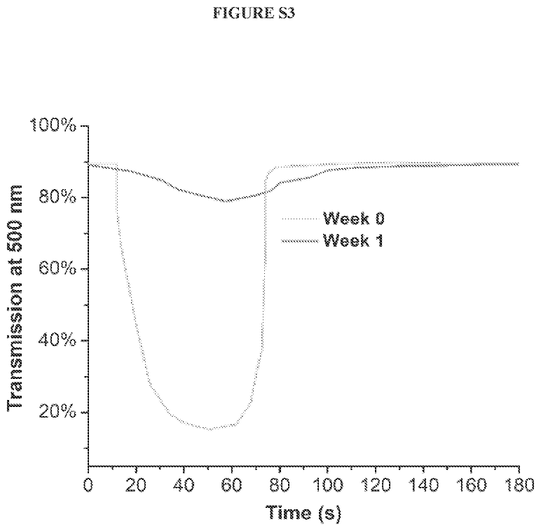

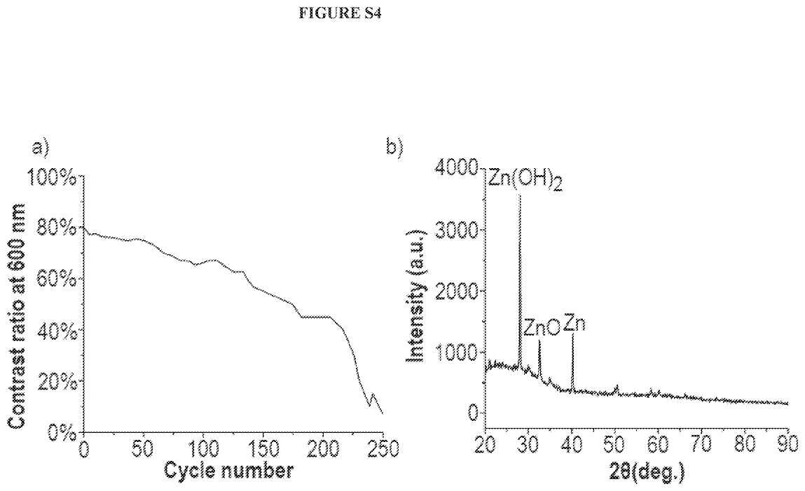

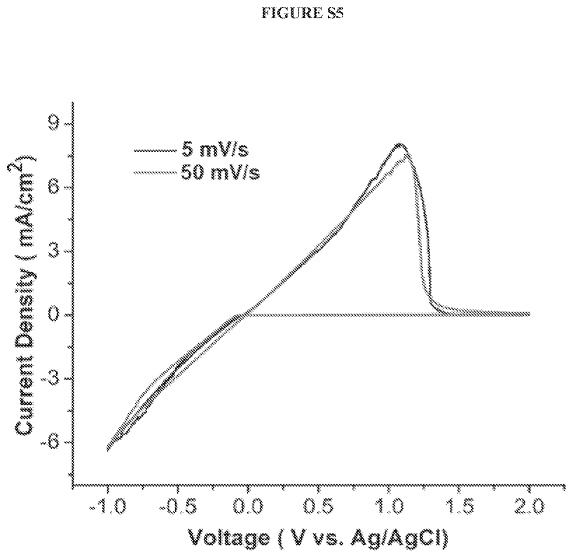

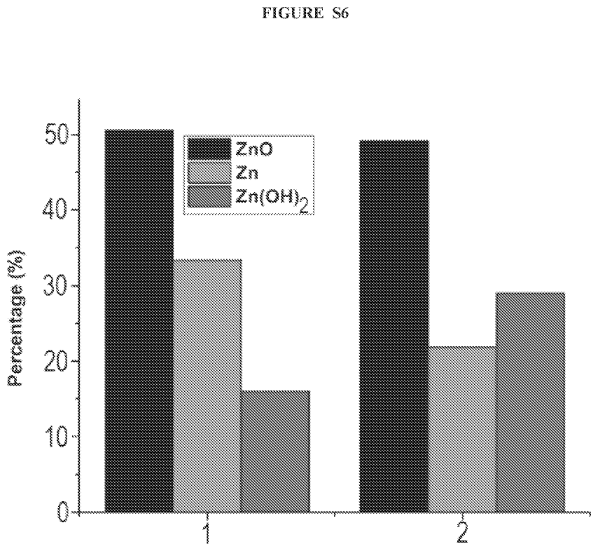

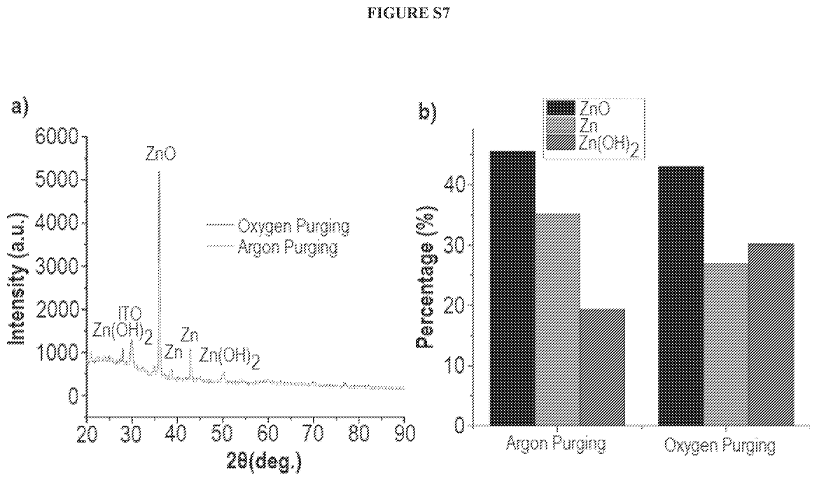

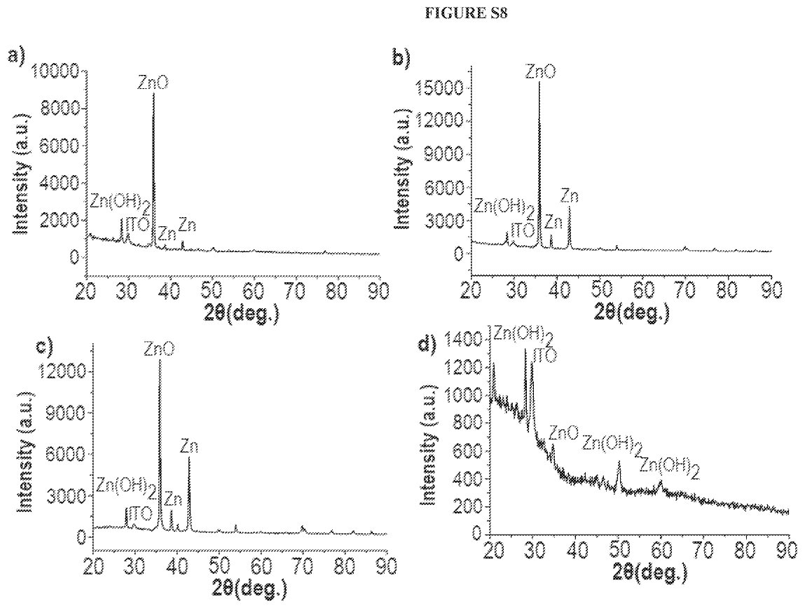

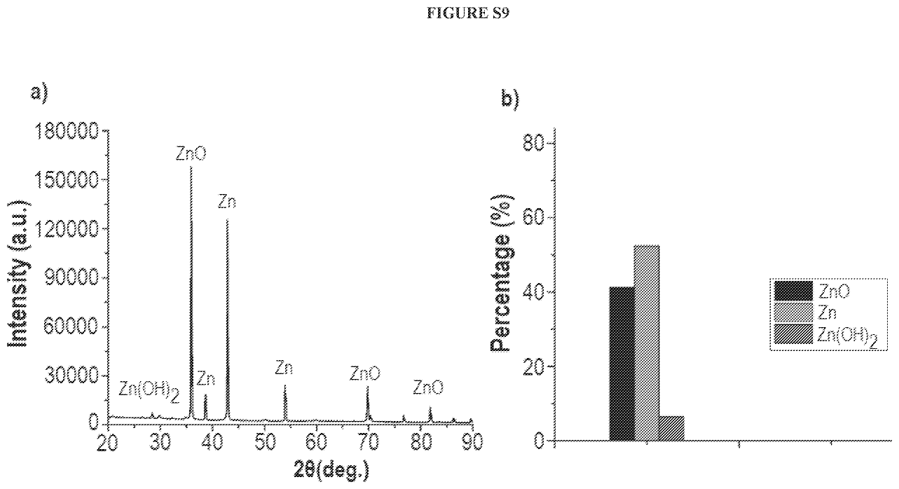

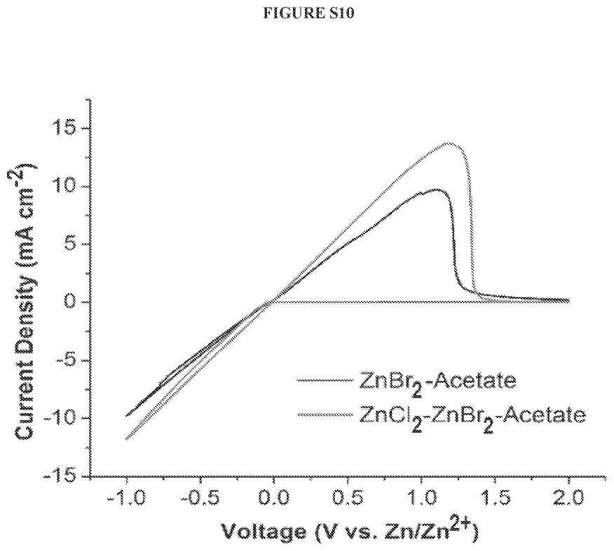

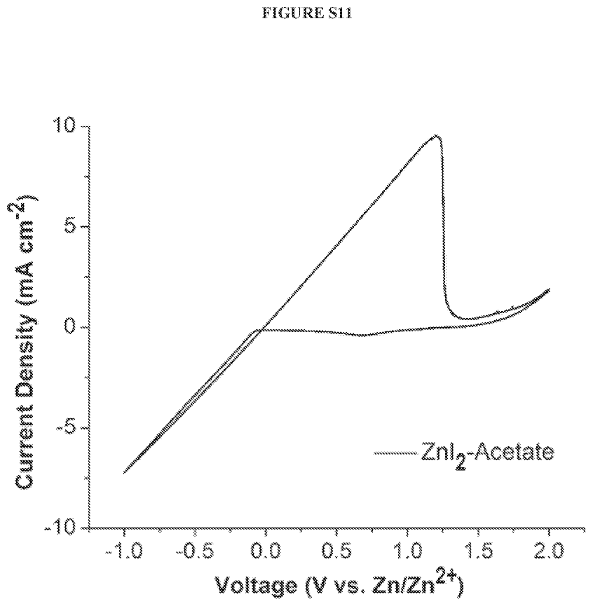

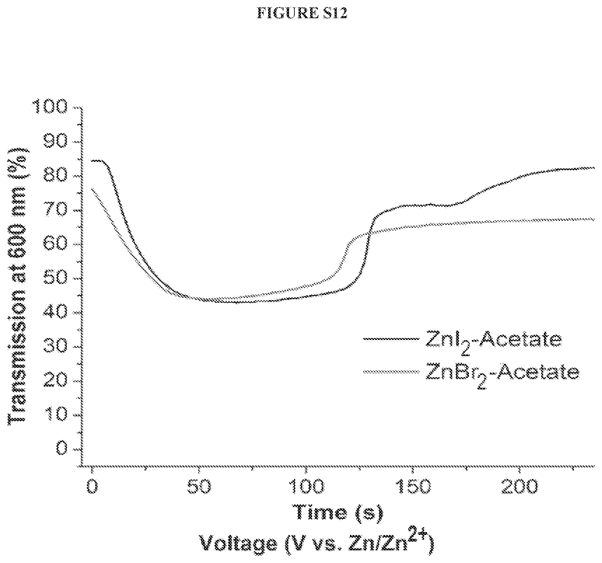

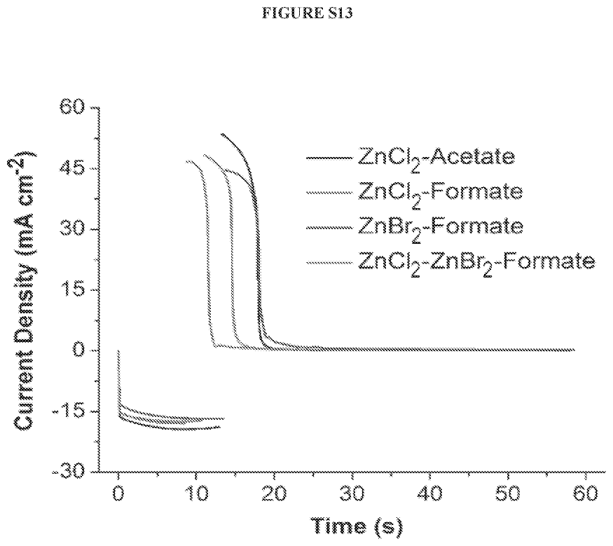

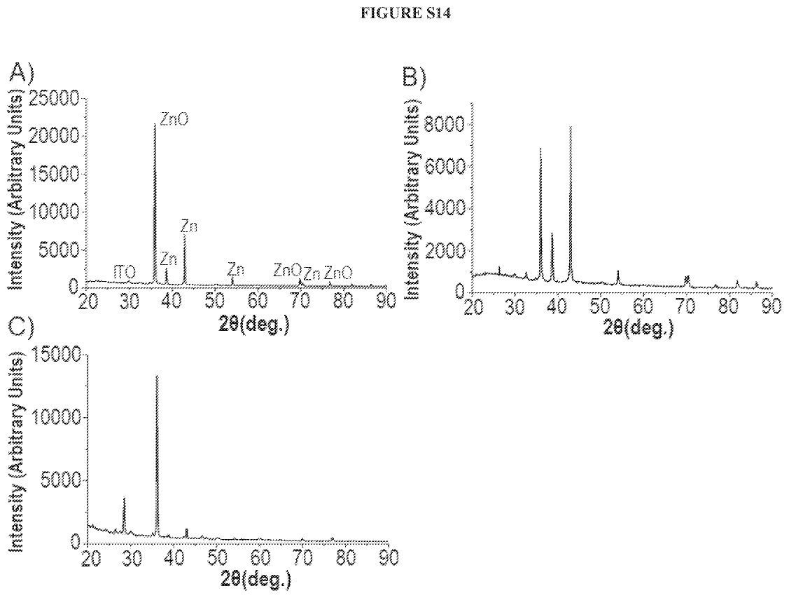

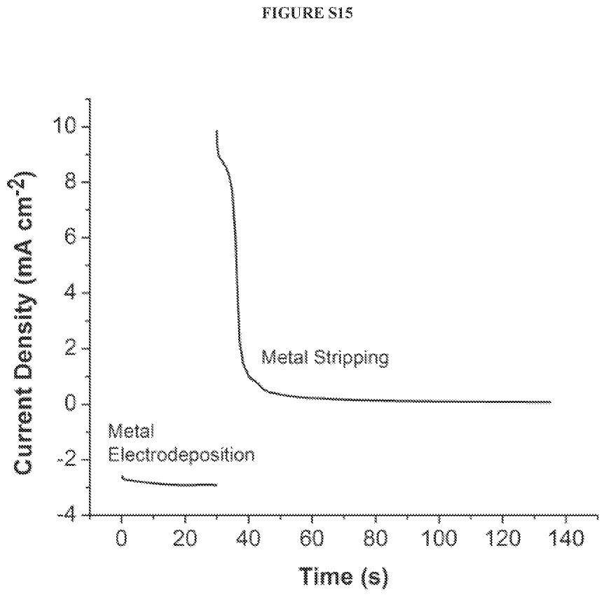

Instead of BiCl₃, we also tried an electrolyte using Bi(NO₃)₃. This electrolyte contained 60 mM Bi(NO₃)₃, 300 mM EDDA, and 5 mM KCl and was swept between −1.2V to +1.0V vs Ag/AgCl at a scan rate of 25 mVs¹. Using Bi(NO₃)₃ shifted the Bi peak slightly left in comparison to BiCl₃, with a peak at −1.05V and a slightly right shifted peak at +0.10V. It also has more current density than any other Bi electrolyte tested with −5 mA cm⁻² during reduction and 8.2 mA cm² during oxidation, two to three times more than other electrolytes (FIG. 48A). The transmission shows a reversible electrolyte that has 53-55% contrast (FIG. 48B).

These are all electrolytes with the potential to become an alkaline electrolyte for dynamic windows after undergoing further testing.

### REFERENCES (FIRST SET)

[1] Monthly Energy Review. July 2020, U.S. Energy Information Administration, https://www.eia.gov/totalenergy/data/monthly/archive/00352007.pdf/(accessed: January, 2021).
[2] Y. Heo, G. Augenbroe, D. Graziano, R. T. Muehleisen, L. Guzowski, Build. Environ. 2015, 87, 342.
[3] E. Lee, M. Yazdanian, S. Selkowitz, The energy-savings potential of electrochromic windows in the US commercial buildings sector, 2019, https://www.osti.gov/servlets/purl/891618/(accessed: January, 2021).
[4] R. R. Lunt, V. Bulovic, Appl. Phys. Lett. 2011, 98, 113305.
[5] Y. Zhao, R. R. Lunt, Adv. Energy Mater. 2013, 3, 1143.
[6] H. Khandelwal, R. C. G. M. Loonen, J. L. M. Hensen, M. G. Debije, A. P. H. J. Schenning, Sci. Rep-UK. 2015, 5, 11773.
[7] N. R. Lynam, Smart Windows for Automobiles, 1990, SAE International. https://saemobilus.sae.org/content/900419/(accessed: January, 2021).
[8] C. J. Barile, D. J. Slotcavage, J. Hou, M. T. Strand, T. S. Hernandez, M. D. McGehee, Joule, 2017, 1, 133.
[9] C. Ma, M. Tay a, C. Xu, Polym. Eng. Sci. 2008, 48, 2224.
[10] S. Araki, K. Nakamura, K. Kobayashi, A. Tsuboi, N. Kobayashi, Adv. Mater. 2012, 24, OP122.
[11] T. J. Richardson, Solid State Ionics 2003, 165, 305.
[12] C. G. Granqvist, Nat. Mater. 2006, 5, 89.
[13] G. W. Kim, R. Lampande, D. C. Choe, I. J. Ko, J. H. Park, R. Pode, J. H. Kwon, Opt. Express 2018, 26, 8493.
[14] H. Li, W. Zhang, A. Y. Elezzabi, Adv. Mater. 2020, 32, 2003574.
[15] B. Wang, M. Cui, Y. Gao, F. Jiang, W. Du, F. Gao, L. Kang, C. Zhi, H. Luo, Sol. RRL. 2020, 4, 1900425.
[16] R. J. Mortimer, Chem. Soc. Rev., 1997, 26, 147.
[17] C. G. Granqvist, Handbook of Inorganic Electrochromic materials, Elsevier, New York, USA 1995.
[18] R. J. Mortimer, A. L. Dyer, J. R. Reynolds, Displays, 2006, 27, 2.
[19] E. L. Runnerstrom, A. Llordes, S. D. Lounis, D. J. Milliron, Chem. Commun. 2014, 50, 10555.
[20] H. Ji, D. Liu, H. Cheng, C. Zhang, J. Mater. Chem. C. 2018, 6, 2424.
[21] V. K. Thakur, G. Ding, J. Ma, P. S. Lee, X. Lu, Adv. Mater. 2012, 24, 4071.
[22] J. P. Ziegler, B. M. Howard, Sol. Energ. Mat. Sol. C. 1995, 39, 317.
[23] J. P. Ziegler, Sol. Energ. Mat. Sol. C. 1999, 56, 477.
[24] O. S. Heavens, Optical properties of thin solid films, Academic Press, New York, USA 1955.
[25] C. J. Barile, D. J. Slotcavage, and M. D. McGehee, Chemistry of Materials, 2016, 28(5), 1439.
[26] G. A. Niklasson, C. G. Granqvist, J. Mater. Chem. 2007, 17, 127.
[27] C. Lemire, D. B. B. Lollman, A. Al Mohammad, E. Gillet, K. Aguir, Sensor Actuat B-Chem. 2002, 84, 43.
[28] T. S. Hemandez, C. J. Barile, M. T. Strand, T. E. Dayrit, D. J. Slotcavage, M. D. McGehee, ACS Energy Lett. 2018, 3, 104.
[29] S. M. Islam, C. N. Fini, C. J. Barile, J Electrochem. Soc. 2019, 166, D333.
[30] S. M. Islam, T. S. Hemandez, M. D. McGehee, C. J. Barile, Nat. Energy 2019, 4, 223.
[31] M. T. Strand, C. J. Barile, T. S. Hernandez, T. E. Dayrit, L. Bertoluzzi, D. J. Slotcavage, M. D. McGehee, ACS Energy Lett. 2018, 3, 2823.
[32] D. D. Miller, J. Y. Li, S. M. Islam, J. F. Jeanetta, C. J. Barile, J Mater. Chem. C. 2020, 8, 1826.
[33] P. Vanfsek, Electrochemical Series, http://www2.chm.ulaval.ca/gecha/chm2903/7_equilibres_electrochimiques/potentiels_red uction_CRC.pdf/(accessed: January, 2021).
[34] Y. Zhang, Y. Wu, W. You, M. Tian, P.-W. Huang, Y. Zhang, Z. Sun, Y. Ma, T. Hao, N. Liu, Nano Lett. 2020, 20, 4700.
[35] P. Quaino, F. Juarez, E. Santos, W. Schmickler, Beilstein J. Nanotech. 2014, 5, 846.
[36] C. Wang, Z. Wang, Y. Ren, X. Hou, F. Yan, ACS Sustain. Chem. Eng. 2020, 8, 5050.
[37] R. A. Huggins, Advanced Batteries, Springer, Boston, MA, USA 2009.
[38] C. W. Lee, K. Sathiyanarayanan, S. W. Eom, H. S. Kim, M. S. Yun, J Power Sources 2006, 159, 1474.
[39] Z. Hou, X. Zhang, X. Li, Y. Zhu, J. Liang, Y. Qian, J Mater. Chem. A 2017, 5, 730.
[40] Z. Liu, S. Z. El Abedin, F. Endres, Electrochem. Commun. 2015, 58, 46.
[41] F. Wang, O. Borodin, T. Gao, X. Fan, W. Sun, F. Han, A. Faraone, J. A. Dura, K. Xu, C. Wang, Nat. Mater. 2018, 17, 543.
[42] Z. M. Wang, Toward Functional Nanomaterials, Springer, New York, NY, USA 2009.
[43] Solubility Product Constants near 25° C., https://saltlakemetals.com/solubilityproducts/(accessed: January, 2021).
[44] Solubility Products of Selected Compounds, https://www.chm.uri.edu/weuler/chml12/refmater/KspTable.html/(accessed: January, 2021).
[45] C. L. DeFoor, J. F. Jeanetta, C. J. Barile, ACS Appl. Electron. Mater. 2020, 2, 290.
[46] S. M. Islam, C. J. Barile, ACS Appl. Mater. Inter. 2019, 11, 40043.
[47] S. M. Islam, A. A. Palma, R. P. Gautam, C. J. Barile, ACS Appl. Mater. Inter. 2020, 12, 44874.
[48] T. S. Hernandez, M. Alshurafa, M. T. Strand, A. L. Yeang, M. G. Danner, C. J. Barile, M. D. McGehee, Joule, 2020, 4, 1501.
[49] F. Mansfeld, S. Gilman, J Electrochem. Soc. 1970, 117, 588.
[50] J. M. Wang, L. Zhang, C. Zhang, J. Q. Zhang, J Power Sources, 2001, 102, 139.
[51] N. Ahmed, A. Majid, M. A. Khan, M. Rashid, Z. A. Umar, M. A. Baig, Mater. Sci-Poland, 2018, 36, 501.
[52] M. Wang, L. Jiang, E. J. Kim, S. H. Hahn, RSC Adv. 2015, 5, 87496.

### REFERENCES (SECOND SET)

1. U.S. Energy Information Administration, Consumption & Effiency, 2018, https://www.eia.gov/consumption/, accessed Feb. 17, 2021.
2. E. S. Lee, M. Yazdanian and S. E. Selkowitz, Lawrence Berkeley National Laboratory, 2004, LBNL-54966.
3. Energy Savings Guide, https://view.com/sites/default/files/documents/product-guide.pdf, (accessed Feb. 17, 2021).
4. C. G. Granqvist, Handbook of Inorganic Electrochromic Materials, Elsevier, Amsterdam, 1995.
5. C. G. Granqvist, Sol. Energ. Mat. Sol. C., 2000, 60, 201-262.
6. G. A. Niklasson and C. G. Granqvist, J. Mat. Chem., 2007, 17, 127-156.
7. P. Shi, C. M. Amb, E. P. Knott, E. J. Thompson, D. Y. Liu, J. Mei, A. L. Dyer and J. R. Reynolds, Adv. Mater., 2010, 22, 4949-4953.
8. V. K. Thakur, G. Ding, J. Ma, P. S. Lee and X. Lu, Adv. Mater., 2012, 24, 4071-4096.
9. X. Li, Z. Wang, K. Chen, D. Y. Zemlyanov, L. You and J. Mei, ACS Appl. Mater. Int., 2021, 13, 5312-5318.
10. R. J. Mortimer, A. L. Dyer and J. R. Reynolds, Displays, 2006, 27, 2-18.
11. G. Garcia, R. Buonsanti, A. Llordes, E. L. Runnerstrom, A. Bergerud and D. J. Milliron, Adv. Opt. Mater., 2013, 1, 215-220.
12. D. Coates, J Mat. Chem., 1995, 5, 2063-2072.
13. J. W. Doane, A. Golemme, J. L. West, J. B. Whitehead and B. G. Wu, Mol. Cryst. Liq. Crys., 1988, 165, 511-532.
14. Y. Cui, Y. Ke, C. Liu, Z. Chen, N. Wang, L. Zhang, Y. Zhou, S. Wang, Y. Gao and Y. Long, Joule, 2018, 2, 1707-1746.
15. M. Aburas, H. Ebendorff-Heidepriem, L. Lei, M. Li, J. Zhao, T. Williamson, Y. Wu and V. Soebarto, Energ. Buildings, 2021, 235, 110717.
16. X. Tao, D. Liu, J. Yu and H. Cheng, Adv. Opt. Mater., 2021, 9, 2001847.
17. O. S. Heavens, Optical Properties of Thin Solid Films, Dover Publications, Inc., New York, 1965.
18. N. N. Greenwood and A. Eamshaw, Chemistry of the Elements, Butterworth-Heinemann, Oxford, U. K., 2nd ed., 1997.
19. G. K. A. Alcaraz, J. S. Juarez-Rolon, N. A. Burpee and C. J. Barile, J Mat. Chem. C, 2018, 6, 2132-2138.
20. S. M. Islam, C. N. Fini and C. J. Barile, J. Electrochem. Soc., 2019, 166, D333-D338.
21. C. J. Barile, J. Appl. Electrochem., 2018, 48, 443-449.
22. J. P. Ziegler, Sol. Energ. Mat. Sol. C., 1999, 56, 477-493.
23. M. T. Strand, C. J. Barile, T. S. Hernandez, T. E. Dayrit, L. Bertoluzzi, D. J. Slotcavage and M. D. McGehee, ACS Energ. Lett., 2018, 3, 2823-2828.
24. T. S. Hernandez, M. Alshurafa, M. T. Strand, A. L. Yeang, M. G. Danner, C. J. Barile and M. D. McGehee, Joule, 2020, 4, 1501-1513.
25. S. M. Islam, T. S. Hernandez, M. D. McGehee and C. J. Barile, Nat. Energ., 2019, 4, 223-229.
26. S. M. Islam and C. J. Barile, ACS Appl. Mater. Inter., 2019, 11, 40043-40049.
27. S. M. Islam, A. A. Palma, R. P. Gautam and C. J. Barile, ACS Appl. Mater. Inter., 2020, 12, 44874-44882.
28. S. Araki, K. Nakamura, K. Kobayashi, A. Tsuboi and N. Kobayashi, Adv. Mater., 2012, 24, OP122-OP126.
29. A. Tsuboi, K. Nakamura and N. Kobayashi, Adv. Mater., 2013, 25, 3197-3201.
30. C. Park, S. Seo, H. Shin, B. D. Sarwade, J. Na and E. Kim, Chem. Sci., 2015, 6, 596-602.
31. C. J. Barile, D. J. Slotcavage, J. Hou, M. T. Strand, T. S. Hemandez and M. D. McGehee, Joule, 2017, 1, 133-145.
32. J. Y. Li, J. S. Juarez-Rolon, S. M. Islam and C. J. Barile, J Electrochem. Soc., 2019, 166, D496-D504.
33. T. S. Hernandez, C. J. Barile, M. T. Strand, T. E. Dayrit, D. J. Slotcavage and M. D. McGehee, ACS Energ. Lett., 2018, 3, 104-111.
34. P. Vanysek, Electrochemical Series, Boca Raton, FL, 83rd edn., 2002.
35. H. Li, W. Zhang and A. Y. Elezzabi, Adv. Mater., 2020, 32, 2003574.
36. Z. Pawelka and M. C. Haulait-Pirson, J. Phys. Chem. C., 1981, 85, 1052-1057.
37. D. Shriver, M. Weller, T. Overton, J. Rourke and F. Armstrong, Inorganic Chemistry, W. H. Freeman and Company, New York, NY, 6th ed., 2014.
38. D. D. Perrin, B. Dempsey and E. P. Serjeant, pKₐ Prediction for Organic Acids and Bases, Springer Publications, New York, NY, 1981.
39. Y. R. Luo, Comprehensive Handbook of Chemical Bond Energies, CRC Press, Taylor & Francis Group, Boca Raton, F L, 2007.
40. K. Kondo, H. Kouta, M. Yokoi, N. Okamoto, T. Saito and T. Hayashi, ECS Trans., 2014, 58, 89-96.
41. M. Schlesinger and M. Paunovic, Modern Electroplating, John Wiley, Hoboken, NJ, 5th ed., 2010.
42. W. S. M. Werner, K. Glantschnig and C. Ambrosch-Draxl, J. Phys. Chem. Ref Data, 2009, 38, 1013-1092.
43. H. Yoshikawa and S. Adachi, Jpn. J. Appl. Phys., 1997, 36, 6237-6243.
44. J. D. Benck, B. A. Pinaud, Y. Gorlin and T. F. Jaramillo, PlOS One, 2014, 9, e107942-e107942.
45. P. Quaino, F. Juarez, E. Santos and W. Schmickler, Bellstein J. Nanotech., 2014, 5, 846-854.

What is claimed is:

1. A dynamic glass element or window (1) comprising a transparent working conductive electrode or cathode (2), a counter electrode or anode (4) and an aqueous electrolyte composition as a solution or gel (3) located between the cathode and the anode, wherein the electrolyte composition comprises an aqueous solution of a salt selected from the group consisting of at least one zinc salt, at least one bismuth salt, at least one copper salt or a mixture of at least one bismuth salt and at least one copper salt at a pH ranging from about 3-11, wherein the zinc salt is included in the electrolyte composition at a concentration of 0.01M to 5.0M, the bismuth salt, the copper salt or the mixture of the bismuth salt and copper salt are each included in said electrolyte composition at a molar concentration ranging from 5 to 25 mM, wherein said electrolyte composition deposits zinc, bismuth, copper or bismuth and copper onto the surface of said cathode upon application of a voltage ranging from −2.0 to −0.1 such that said cathode transitions from transparent (at least 80% light transmission at 600 nm) to highly opaque (<0.1% light transmission at 600 nm).

2. The glass element or window of claim 1 wherein said highly opaque cathode is switched back to transparent upon application of a voltage ranging from +0.1 to +2.0 in less than 5 minutes.

3. The glass element or window of claim 1 wherein said transparent cathode transitions to highly opaque in less than 20 seconds.

4. The glass element or window of claim 1 wherein said electrolyte composition comprises at least one zinc salt.

5. The glass element or window of claim 1 wherein said electrolyte composition comprises a bismuth salt, copper salt or a mixture of a bismuth salt and copper salt and said composition further comprises an effective amount of a chelating agent to solubilize said salt in said composition.

6. The glass element or window of claim 1 wherein said bismuth salt, copper salt or a mixture of a bismuth salt and copper salt are alternatively presented as metal chelates.

7. The glass element or window of claim 1 wherein said electrolyte composition comprises at least one zinc salt selected from the group consisting of zinc chloride, zinc bromide, zinc iodide, zinc acetate, zinc formate, a zinc halocarboxylate, zinc propionate, zinc butyrate, zinc pentanoate, zinc hexanoate, zinc sulfate, zinc perchlorate, zinc tetrafluoroborate, zinc trifluoromethanesulfonate, zinc methanesulfonate, zinc di bis(trifluoromethylsulfonyl)imide (zinc TFSI), zinc hexafluorophosphate, zinc carborane, zinc nitrate, zinc chlorate, zinc perbromate, zinc bromate and zinc phosphate.

8. The glass element or window of claim 7 wherein said zinc salt is zinc bromide, zinc sulfate, zinc perchlorate, zinc chloride or a mixture thereof.

9. The glass element or window of claim 7 wherein said electrolyte composition further includes a chelating agent or wherein said zinc salt is presented as a metal chelate.

10. The glass element or window of claim 1 wherein said bismuth salt is selected from the group consisting of bismuth chloride, bismuth bromide, bismuth iodide, bismuthyl perchlorate, bismuthyl nitrate, bismuthyl sulfate, bismuth sulfate, bismuth acetate, bismuth nitrate, bismuth trifluoroacetate, bismuth trifluoromethanesulfonate, bismuth methanesulfonate, bismuth TFSI, bismuthyl carbonate and mixtures thereof.

11. The glass element or window of claim 1 wherein said bismuth salt is selected from the group consisting of bismuth chloride, bismuth bromide, bismuth sulfate, bismuthyl perchlorate and mixtures thereof.

12. The glass element or window of claim 1 wherein said copper salt is selected from the group consisting of copper(II) chloride, copper(II) bromide, copper(II) iodide, copper(II) perchlorate, copper(II) phosphate, copper(II) sulfate, copper(II) acetate, copper(II) nitrate, copper(II) trifluoroacetate, copper(II) trifluoromethanesulfonate, copper(II) methanesulfonate, copper(II) TFSI and copper (II) carbonate.

13. The glass element or window of claim 1 wherein said copper salt is copper(II) sulfate, copper(II) bromide or a mixture thereof.

14. The glass element or window of claim 1 wherein said copper salt is copper(II) chloride, copper(II) perchlorate or a mixture thereof.

15. The glass element or window of claim 1 wherein said electrolyte composition comprises an effective amount of an ionic conductivity cation in an effective amount to promote or increase ionic conductivity.

16. The glass element or window of claim 15 wherein said ionic conductive cation is selected from the group consisting of Li+, Na+, K+, Rb+, Cs+, Mg2+, Ca2+ and mixture thereof at concentrations ranging from about 0.1 mM to 5.0M or 0.1M to 5.0M.

17. The glass element or window of claim 1 wherein said electrolyte composition comprises an effective amount of a gelling agent to gel said composition.

18. The glass element or window of claim 17 wherein said gelling agent is hydroxyethylcellulose, hydroxypropylcellulose, polyvinylalcohol, a cross-linked polymer or a hydrogel selected from the group consisting of (poly)hydroxyethylmethacrylate, (poly)hydroxypropylmethacrylate and polyacrylamide.

19. The glass element or window of claim 1 wherein said electrolyte composition comprises a zinc salt and Cu(CH₃COO)₂ is added in an effective amount to said composition to inhibit the formation and/or facilitate the release of ZnO and Zn(OH)₂ from the electrodeposited cathode.

20. The glass element or window of claim 1 wherein said electrolyte composition comprises a zinc salt and sulfate anion (SO₄²⁻) at concentrations ranging from about 0.01M to 5M, often 0.5M to 1M supports high current density and good optical contrast and reversibility of Zn electrodeposition.

21. The glass element or window of claim 1 wherein said chelating agent is ethylenediamine-N,N,N′,N′tetracetatic acid (EDTA); ethylenediamine-N,N,N′triacetic acid (ED3A); ethylenediamine-N,N′diacetic acid (EDDA); ethylenediamine-N-acetic acid (ED1A)glycine; ethylenediamine-N,N′-disuccinic acid (EDDS); ethylenediamine-N,N′-bis(2-hydroxyphenylacetic acid) (EDDHA); nicotianamine; 2,2′,2″,2′″-(1,4,7,10-Tetraazacyclododecane-1,4,7,10-tetrayl)tetraacetic acid) (DOTA); 1,4,7-Triazacyclononane-1,4,7-triacetic acid (NOTA); (ethylene glycol-bis(R-aminoethyl ether)-N,N,N′,N′-tetraacetic acid) (EGTA); 1,2-bis(o-aminophenoxy)ethane-N,N,N′,N′-tetraacetic acid (BAPTA); nitrilotriacetic acidIminodiacetic acid; diethylenetriaminepentaacetic acid (pentetic acid); tetraethylenepentamine (TEPA) Tris(2-aminoethyl)amine (tren); Tris(2-pyridylmethyl)aminetris(hydroxymethyl)aminomethane (tris); 2-[Bis(2-hydroxyethyl)amino]-2-(hydroxymethyl)propane-1,3-diol (bis-tris)1,3-bis(tris(hydroxymethyl)methylamino)propane (BTP); {[1,3-Dihydroxy-2-(hydroxymethyl)propan-2-yl]amino}acetic acid (tricine); [Bis(2-hydroxyethyl)amino]acetic acid (bicine); 1,2-Diaminopropane-N,N,N′,N′-tetraacetic acid; 1,3-Diamino-2-hydroxypropane-N,N,N′,N′-tetraacetic acid; Triethylenetetramine;
Diethylenetriamine and mixtures thereof.

22. The glass element or window of claim 1 wherein said chelating agent is ED3A, EDDA or ED3A-OH.

23. The glass element or window of claim 1 wherein said electrolyte composition comprises an effective amount of a level agent.

24. The glass element or window of claim 23 wherein said leveling agent is polyvinylalcohol (PVA), thiourea, cetyltrimethyl ammonium bromide, sodium dodecyl sulfate or chloride anion.

25. The glass element or window of claim 1 wherein said cathode comprises a metal oxide selected from the group consisting of tin-doped indium oxide (ITO), fluorine-doped tin oxide (FTO), indium zinc oxide (IZO), aluminum-doped zinc oxide (AZO), indium tin zirconium oxide (ITZO), indium gallium oxide (IGO), indium gallium zinc oxide (IGZO), tin oxide (SnO), zinc tin oxide (ZTO) or zinc oxide doped with Ga (gallium), B (boron), Y (yttrium), Sc (scandium), Si (silicon) or Ge (germanium).

26. The glass element or window of claim 25 wherein the metal oxide is aluminum-doped zinc oxide (AZO), tin-doped indium oxide (ITO) or fluorine-doped in oxide (FTO).

27. The glass element or window of claim 25 wherein said metal oxide is layered onto glass to form the cathode.

28. The glass element or window of claim 1 wherein said anode is zinc foil, a zinc metal mesh, a woven zinc wire, a zinc grid, a zinc coated substrate or a zinc alloy.

29. The glass element or window of claim 28 wherein said zinc coated substrate is a grid core made of stainless steel, copper (Cu), silver (Ag) or gold (Au)) which is coated with zinc via a lithographic, electrodeposition, continuous galvanizing or a related coating process.

30. The glass element or window of claim 1 wherein said anode is a bismuth, copper or bismuth-copper foil, metal mesh, woven wire or a grid or substrate or alloy.

31. A dynamic glass element or window (1) comprising a transparent working conductive electrode or cathode comprising glass coated with a metal oxide selected from the group consisting of aluminum-doped zinc oxide (AZO), tin-doped indium oxide (ITO) and fluorine-doped tin oxide (FTO) (2), a counter electrode or anode (4) and an aqueous electrolyte composition as a gel (3) located between the cathode and the anode, wherein the electrolyte composition comprises an aqueous solution of a salt selected from the group consisting of at least one zinc salt, at least one bismuth salt, at least one copper salt or a mixture of at least one bismuth salt and at least one copper salt at a pH ranging from about 4-8, wherein the zinc salt is included in the electrolyte composition at a concentration of 0.01M to 5.0M, the bismuth salt, the copper salt or the mixture of the bismuth salt and copper salt are each included in said electrolyte composition at a molar concentration ranging from 5 to 25 mM, wherein said electrolyte composition comprises a gelling agent and said electrolyte composition which comprises said bismuth salt(s), said copper salt(s) or a mixture of bismuth and copper salt(s) further includes an amount of a chelating agent effective to solubilize said salts and wherein said electrolyte solution deposits zinc, bismuth, copper or bismuth and copper onto the surface of said cathode upon application of a voltage ranging from −2.0 to −0.1 such that said cathode transitions from transparent (at least 80% light transmission at 600 nm) to highly opaque (<0.1% light transmission at 600 nm).

32. A method of increasing the opacity of a dynamic glass element or window (1) according to claim 1, said element or window comprising a transparent working conductive electrode or cathode (2), a counter electrode or anode (4) and an aqueous electrolyte composition as a solution or gel (3) located between the cathode and the anode, wherein the electrolyte composition comprises an aqueous solution of a salt selected from the group consisting of at least one zinc salt, at least one bismuth salt, at least one copper salt or a mixture of at least one bismuth salt and at least one copper salt at a pH ranging from about 3-11, wherein the zinc salt is included in the electrolyte composition at a concentration of 0.01M to 5.0M, the bismuth salt, the copper salt or the mixture of the bismuth salt and copper salt are each included in said electrolyte composition at a molar concentration ranging from 5 to 25 mM, said method comprising applying a voltage ranging from −2.0 to −0.1 to said cathode to deposit zinc, bismuth, copper or bismuth and copper such that said cathode transitions from transparent (at least 80% light transmission at 600 nm) to highly opaque (<0.1% light transmission at 600 nm).

33. The method according to claim 32 wherein said highly opaque cathode is switched back to transparent upon application of a voltage ranging from +0.1 to +2.0 in less than 5 minutes.

34. The method of claim 32 wherein said transparent cathode transitions to highly opaque in less than 20 seconds.

35. The method according to claim 32 wherein said electrolyte composition comprises at least one zinc salt.

36. The method according to claim 32 wherein said electrolyte composition comprises a bismuth salt, copper salt or a mixture of a bismuth salt and copper salt and said composition further comprises an effective amount of a chelating agent to solubilize said salt in said composition.

37. The method according to claim 32 wherein said bismuth salt, copper salt or a mixture of a bismuth salt and copper salt are alternatively presented as metal chelates.

38. The method according to wherein said electrolyte composition comprises at least one zinc salt selected from the group consisting of zinc chloride, zinc bromide, zinc iodide, zinc acetate, zinc formate, a zinc halocarboxylate, zinc propionate, zinc butyrate, zinc pentanoate, zinc hexanoate, zinc sulfate, zinc perchlorate, zinc tetrafluoroborate, zinc trifluoromethanesulfonate, zinc methanesulfonate, zinc di bis(trifluoromethylsulfonyl)imide (zinc TFSI), zinc hexafluorophosphate, zinc carborane, zinc nitrate, zinc chlorate, zinc perbromate, zinc bromate and zinc phosphate.

39. (canceled)

40. The method according to claim 38 wherein said electrolyte composition further includes a chelating agent or wherein said zinc salt is presented as a metal chelate.

41. The method according to claim 32 wherein said bismuth salt is selected from the group consisting of bismuth chloride, bismuth bromide, bismuth iodide, bismuthyl perchlorate, bismuthyl nitrate, bismuthyl sulfate, bismuth sulfate, bismuth acetate, bismuth nitrate, bismuth trifluoroacetate, bismuth trifluoromethanesulfonate, bismuth methanesulfonate, bismuth TFSI, bismuthyl carbonate and mixtures thereof.

42. (canceled)

43. The method according to claim 32 wherein said copper salt is selected from the group consisting of copper(II) chloride, copper(II) bromide, copper(II) iodide, copper(II) perchlorate, copper(II) phosphate, copper(II) sulfate, copper(II) acetate, copper(II) nitrate, copper(II) trifluoroacetate, copper(II) trifluoromethanesulfonate, copper(II) methanesulfonate, copper(II) TFSI and copper (II) carbonate.

44. (canceled)

45. (canceled)

46. The method according to claim 32 wherein said electrolyte composition comprises an effective amount of an ionic conductivity cation in an effective amount to promote or increase ionic conductivity.

47. The method according to claim 46 wherein said ionic conductive cation is selected from the group consisting of Li+, Na+, K+, Rb+, Cs+, Mg2+, Ca2+ and mixture thereof at concentrations ranging from about 0.1 mM to 5.0M or 0.1M to 5.0M.

48. The method according to claim 32 wherein said electrolyte composition comprises an effective amount of a gelling agent to gel said composition.

49. (canceled)

50. The method according to claim 32 wherein said electrolyte composition comprises a zinc salt and Cu(CH₃COO)₂ is added in an effective amount to said composition to inhibit the formation and/or facilitate the release of ZnO and Zn(OH)₂ from the electroposited cathode.

51. The method according to claim 32 wherein said electrolyte composition comprises a zinc salt and sulfate anion (SO₄²⁻) at concentrations ranging from about 0.01M to 5M, often 0.5M to 1M which supports high current density and good optical contrast and reversibility of Zn electrodeposition.

52. The method according to claim 32 wherein said electrolyte composition comprises an effective amount of a level agent selected from the group consisting of polyvinylalcohol (PVA), thiourea, cetyltrimethyl ammonium bromide, sodium dodecyl sulfate, chloride anion and mixtures thereof.

53. (canceled)

54. The method according to claim 32 wherein said cathode comprises a metal oxide selected from the group consisting of tin-doped indium oxide (ITO), fluorine-doped tin oxide (FTO), indium zinc oxide (IZO), aluminum-doped zinc oxide (AZO), indium tin zirconium oxide (ITZO), indium gallium oxide (IGO), indium gallium zinc oxide (IGZO), tin oxide (SnO), zinc tin oxide (ZTO) or zinc oxide doped with Ga (gallium), B (boron), Y (yttrium), Sc (scandium), Si (silicon) or Ge (germanium).

55. (canceled)

56. The method according to claim 54 wherein said metal oxide is layered onto glass to form the cathode.

57. The method according to claim 32 wherein said anode is zinc foil, a zinc metal mesh, a woven zinc wire, a zinc grid, a zinc coated substrate or a zinc alloy or a bismuth, copper or bismuth copper foil, metal mesh.

58. The method of claim 57 wherein said zinc coated substrate is a grid core made of stainless steel, copper (Cu), silver (Ag) or gold (Au)) which is coated with zinc via a lithographic, electrodeposition, continuous galvanizing or a related coating process.

59. (canceled)
